(19) United States
(12) Patent Application Publication
(10) Pub. No.: US 2026/0167400 A1
(43) Pub. Date: Jun. 18, 2026

(54) Modification of Polypropylene Resins with Additives to Enhance Mechanical and/or Barrier Properties of Coextruded Sheets

(71) Applicant: Superior Plastics Extrusion Co. Inc. DBA Impact Plastics, Putnam, CT (US)

(72) Inventors: Hari Parvatareddy, Appleton, WI (US); Jimmy A. Shah, Rockingham, NC (US)

(21) Appl. No.: 19/418,042

(22) Filed: Dec. 12, 2025

Related U.S. Application Data
(60) Provisional application No. 63/733,130, filed on Dec. 12, 2024.

(51) Int. Cl. B65D 65/40; B32B 1/00; B32B 27/08; B32B 27/30; B32B 27/32; C08L 23/08; C08L 23/12; C08L 23/26

(52) U.S. Cl. CPC B65D 65/40; B32B 1/00; B32B 27/08; B32B 27/306; B32B 27/32; C08L 23/08; C08L 23/12; C08L 23/26; B32B 2250/05; B32B 2250/24; B32B 2307/54; B32B 2307/546; B32B 2307/558; B32B 2307/7244; B32B 2307/7376; B32B 2439/70; B65D 2565/387; C08L 2203/16

(57) ABSTRACT

In one embodiment, this invention relates to packaging applications. In another embodiment, it relates to polyethylene or ethylene/α-olefin copolymer based co-extruded, multi-layer films or sheets—rigid or flexible—for forming, for example, thermoforming, into shaped containers such as packaging containers. Inter alia, the films have improved barrier properties, toughness, and snapability. Particularly, the films of the present invention comprise one or more stacks of polypropylene layers, wherein at least one stack comprises nucleating agents. In one embodiment, the polypropylene layers in the stack are provided such that any two adjacent layers have different microstructures that provide an interface or interphase between the two layers with likely different microstructures and/or crystallinity. The overall polypropylene stack structure assists in disrupting the transport of oxygen, thereby providing a laminate or structure, for example a rigid film or sheet, with enhanced oxygen-barrier properties. The invention also relates a process for preparing shaped articles such as containers from such films, and to such shaped articles—rigid or flexible—both filled and unfilled. In another embodiment, one of the layers of the co-extruded sheet has a bi-phasic dispersion of one polymeric phase into another polymeric phase. In one embodiment, one or more layers comprise a hydrocarbon polymer modifiers (“HPM”) material A preferred HPM is hydrogenated polycyclopentadiene.

### CROSS REFERENCE TO RELATED APPLICATIONS

This application claims benefit under 35 U.S.C. § 119(e) of Provisional U.S. Patent Application No. 63/733,130, filed Dec. 12, 2024, the contents of which are hereby incorporated by reference in its entirety

### FIELD OF INVENTION

In one embodiment, this invention relates to packaging applications. In another embodiment, it relates to polyethylene or ethylene/α-olefin copolymer based co-extruded, multi-layer films or sheets—rigid or flexible—for forming, for example, thermoforming, into shaped containers such as packaging containers. Inter alia, the films have improved barrier properties, toughness, and snapability. Particularly, the films of the present invention comprise one or more stacks of polypropylene layers, wherein at least one stack comprises nucleating agents. In one embodiment, the polypropylene layers in the stack are provided such that any two adjacent layers have different microstructures that provide an interface or interphase between the two layers with likely different microstructures and/or crystallinity. The overall polypropylene stack structure assists in disrupting the transport of oxygen, thereby providing a laminate or structure, for example a rigid film or sheet, with enhanced oxygen-barrier properties. The invention also relates a process for preparing shaped articles such as containers from such films, and to such shaped articles—rigid or flexible—both filled and unfilled. In another embodiment, one of the layers of the co-extruded sheet has a bi-phasic dispersion of one polymeric phase into another polymeric phase. In one embodiment, one or more layers comprise a hydrocarbon polymer modifiers (“HPM”) material. A preferred HPM is hydrogenated polycyclopentadiene.

In one embodiment, this invention relates to a co-extruded, multi-layer, polymeric film, comprising:
(i) at least one 2-layer stack L1+L2, wherein the first layer of the 2-layer stack is L1 and the second layer of the 2-layer stack is L2, wherein layers L1 and L2 individually comprise, by weight, resin RA1 from 0-100%, resin RB1 from 0-100%, and additive S from 1-15%, wherein the weight content of resin RB1 in layers L1 and L2 is not simultaneously 0%, wherein the two layers L1 and L2 in said 2-layer stack are planarly in contact with each other;

### OR

(ii) at least one 3-layer stack L3+L4+L5, wherein the first layer of the 2-layer stack is L3 the second layer of the 2-layer stack is L4, and the third layer of the 3-layer stack is L5, wherein layers L3, L4, and L5 individually comprise, by weight, resin RA1 from 0-100%, resin RB1 from 0-100%, resin RR1 from 0-100% and additive S from 1-15%, wherein the weight content of resin RB1 and RR1 in layers L3, L4, and L5 is not simultaneously 0%, wherein the three layers L1, L2, and L3 in said 3-layer stack are planarly in contact with each other;

### OR

(iiia) at least one 2-layer stack L1+L2, wherein the first layer of the 2-layer stack is L1 and the second layer of the 2-layer stack is L2, wherein layers L1 and L2 individually comprise, by weight, resin RA1 from 0-100%, resin RB1 from 0-100%, and additive S from 1-15%, wherein the weight content of resin RB1 in layers L1 and L2 is not simultaneously 0%, wherein the two layers L1 and L2 in said 2-layer stack are planarly in contact with each other, and
(iiib) at least one 3-layer stack L3+L4+L5, wherein the first layer of the 2-layer stack is L3 the second layer of the 2-layer stack is L4, and the third layer of the 3-layer stack is L5, wherein layers L3, L4, and L5 individually comprise, by weight, resin RA1 from 0-100%, resin RB1 from 0-100%, resin RR1 from 0-100% and additive S from 1-15%, wherein the weight content of resin RB1 and RR1 in layers L3, L4, and L5 is not simultaneously 0%, wherein the three layers L1, L2, and L3 in said 3-layer stack are planarly in contact with each other;
   wherein:
   Resin RA1 comprises predominately polypropylene,
   Resin RB1 comprises predominately polypropylene and 50 wt. % or less of a hydrocarbon resin; and
   Resin RR1 comprises predominately the APEX material.

### BACKGROUND

Packaging is an important component for the preservation and transport of many items, consumer or industrial. Food and drink products, household chemicals, cosmetics, consumer goods, medical goods, and industrial goods are examples of areas where packaging plays an important role in preserving and transferring products. Historically, ceramic, metal, and glass were utilized for storage and transport. However, mobility associated with modern life has created a demand for more flexibility in container design and reduction in costs associated with packaging and transport. Development of polymeric materials and associated processing techniques fulfilled this demand by introducing opportunities for replacement of historical materials with polymeric solutions. However, many current solutions have limited recycle value which negatively impacts sustainability. The present invention addresses the issue of recyclability and sustainability.

In the rigid polymeric containers space, the containers are made using equipment such as form-fill-seal (FFS), wherein rolls of film are unwound to thermoform into containers. Such rigid containers are used inter alia in the following industries: (1) food; (2) medical; (3) cosmetics; (4) automotives; and (5) electronics. Rigid plastic sheets for preparing such containers are made from polystyrene (PS), high-impact polystyrene (HIPS), polyethylene terephthalate (PET), polylactic acid (PLA), polypropylene (PP), and such.

Polypropylene is the second largest volume commodity thermoplastic in the world after polyethylene. Generally, polyethylene is preferred for packaging applications in various food, medical, commodity, and automotive applications. While polypropylene does exhibit high heat resistance, optical clarity, flexibility, low temperature impact properties, and overall structural rigidity, it is not a preferred material for such applications. Particularly in barrier applications, which is when barrier to oxygen and moisture transport is sought, polystyrene is preferred.

Barrier properties in terms of inhibiting oxygen transfer and moisture transfer are desired in such rigid plastic sheets to avoid spoilage of goods and for extension of shelf-life especially in foods and drinks areas where it is, by definition, limited. Currently available barrier materials include the high-cost and high-density barrier films such as ethylene-vinyl alcohol (EVOH) or polyamide (PA, PA6, PA66) that are then used with traditional substrate materials such as polystyrene and polypropylene, either as a lamination or in a multilayer coextrusion process.

In general, polymeric materials that serve as a barrier to water vapor and certain gases, such as oxygen and/or carbon dioxide, may be utilized to form shaped polymeric articles that serve as packaging materials. For instance, such effectiveness with respect to the barrier properties can allow for the polymeric materials and resulting shaped polymeric articles to extend the shelf-life of the product stored therein.

The barrier properties for water vapor and gases can vary depending on the particular polymeric material utilized. For instance, some polymeric materials have been discovered that efficiently serve as a good barrier material for water vapor and a poor barrier material for gases while other polymeric materials serve as a poor barrier material for water vapor and a good barrier material for gases. In certain instances, techniques or treatments can be employed to provide a polymeric material that may serve as an effective barrier for both water vapor and these gases. However, these treatments may affect the aesthetic properties (e.g., clarity) of the packaging material and may also adversely affect the mechanical properties of such material, in particular when the materials have relatively greater thicknesses.

Aside from the barrier properties, mechanical properties, and optical properties, certain polymeric materials may also not be as effective in forming a shaped polymeric article according to certain forming or molding processes. Finally, recycling of some current polymeric materials can be complicated by certain techniques or treatments used to create barrier performance, resulting in undesirable and inefficient waste streams.

Another desired property is the processability of polymers for making the rigid films. For example, polystyrene is an amorphous thermoplastic polymer that has high mechanical strength, lower shrinkage rate, and a wide processing window. It is considered as the standard material for commodity product and packaging application for its ease of processing, be it with injection molding or extrusion/thermoforming/form-fill-seal processing.

In comparison, polypropylene is a semi-crystalline thermoplastic polymer that has good mechanical properties, high heat and chemical resistance but has much higher shrinkage rate with narrow processing window. Thus, for applications using extrusion, thermoforming, and form-fill-seal processing techniques, polystyrene provides clear advantage over polypropylene. Furthermore, polypropylene requires auxiliary heating and cooling, apart from the higher shrinkage rate.

The rigid films of the present invention comprising stacks of polypropylene layers offer replacement of the above polymeric sheets for container packaging with improved properties, at a lower cost, and without sacrificing the performance criteria for packaging containers in the fields described supra. Despite comprising polypropylene, the rigid films of the present invention have a lower shrinkage rate and process similar to polystyrene.

In fact, the rigid films of the present invention offer high performance in terms of oxygen transmission rate and moisture-vapor transmission rate that are comparable to traditional polypropylene and polystyrene. Thus, it is a low-cost barrier option for extended shelf life, for example in rigid-container applications. These rigid films also demonstrate comparable toughness and snapability. In summary, these films show (i) amenability to processing on existing equipment designed for traditional polypropylene or polystyrene, but with reduced shrinkage, and (ii) compatibility with the existing lamination, printing, thermoforming, and form-fill-seal process. Finally, despite such desirable properties and processability, the rigid films of the present invention provide a lighter material with high recycling capability compared to the traditional high-density thermoplastics, thus improving downstream sustainability.

The worldwide push for sustainability and accountability is driving a shift in the packaging industry, forcing brand owners and converters to find more sustainable alternatives to commonly used barrier food packaging materials such as, HIPS/PVDC, PET/EVOH and even some PP/EVOH/PE structures.

While these structures have historically offered excellent barrier performance and product protection, the complex mix of materials presents a challenge from a recycling perspective. However, specifications for product protection cannot be ignored.

### SUMMARY OF THE INVENTION

The present invention reimagines barrier packaging technology to deliver a simplified sustainable and recyclable solution, all while providing similar OTR barrier properties to EVOH and PVDC in thin-gauge applications including PC condiment cups, PC creamer cups, case-ready and deli meats, and snack packs. This invention provides a drop-in replacement for traditional barrier roll-stock structures using combinations of HIPS/PVDC, PS/EVOH and PP/EVOH/PP structures allowing for replacement of problematic materials using existing thermoforming and form-fill-seal equipment.

In one embodiment, this invention relates to a co-extruded, multi-layer, polymeric film, comprising:
(i) at least one 2-layer stack L1+L2, wherein the first layer of the 2-layer stack is L1 and the second layer of the 2-layer stack is L2, wherein layers L1 and L2 individually comprise, by weight, resin RA1 from 0-100%, resin RB1 from 0-100%, and additive S from 1-15%, wherein the weight content of resin RB1 in layers L1 and L2 is not simultaneously 0%, wherein the two layers L1 and L2 in said 2-layer stack are planarly in contact with each other;

### OR

(ii) at least one 3-layer stack L3+L4+L5, wherein the first layer of the 2-layer stack is L3 the second layer of the 2-layer stack is L4, and the third layer of the 3-layer stack is L5, wherein layers L3, L4, and L5 individually comprise, by weight, resin RA1 from 0-100%, resin RB1 from 0-100%, resin RR1 from 0-100% and additive S from 1-15%, wherein the weight content of resin RB1 and RR1 in layers L3, L4, and L5 is not simultaneously 0%, wherein the three layers L1, L2, and L3 in said 3-layer stack are planarly in contact with each other;

### OR

(iiia) at least one 2-layer stack L1+L2, wherein the first layer of the 2-layer stack is L1 and the second layer of the 2-layer stack is L2, wherein layers L1 and L2 individually comprise, by weight, resin RA1 from 0-100%, resin RB1 from 0-100%, and additive S from 1-15%, wherein the weight content of resin RB1 in layers L1 and L2 is not simultaneously 0%, wherein the two layers L1 and L2 in said 2-layer stack are planarly in contact with each other, and
(iiib) at least one 3-layer stack L3+L4+L5, wherein the first layer of the 2-layer stack is L3 the second layer of the 2-layer stack is L4, and the third layer of the 3-layer stack is L5, wherein layers L3, L4, and L5 individually comprise, by weight, resin RA1 from 0-100%, resin RB1 from 0-100%, resin RR1 from 0-100% and additive S from 1-15%, wherein the weight content of resin RB1 and RR1 in layers L3, L4, and L5 is not simultaneously 0%, wherein the three layers L1, L2, and L3 in said 3-layer stack are planarly in contact with each other;
   wherein:
Resin RA1 comprises predominately polypropylene,
Resin RB1 comprises predominately polypropylene and 50 wt. % or less of a hydrocarbon resin; and
Resin RR1 comprises predominately the APEX material.

In another embodiment, this invention relates to the co-extruded, multi-layer, polymeric film as recited in above, further comprising co-extruded, multi-layer, polymeric at least one layer comprising:
(C) predominately polyolefin;
(D predominately polypropylene;
(E) predominately MODIFIED polypropylene comprising at least one nucleating agent;
(F) predominately polypropylene and 50 wt. % or less of a hydrocarbon resin;
(G) predominately polyethylene polymer or interpolymer;
(H) EVOH;
(I) predominately nylon;
(J) predominately polyester;
(K) resin RB1;
(M) resin RR1;
(N) additive S; or
(O) a combination of the above.

In another embodiment, this invention relates to the co-extruded, multi-layer, polymeric film as recited in above, wherein said layers L1, L2, L3, L4, and L5 form an interface or interphase at their adjacent or planar contact boundaries such that the interphase provides discontinuity in properties between the two layers to provide improvement in barrier properties of the co-extruded, multi-layer, polymeric film.

In another embodiment, this invention relates to the co-extruded, multi-layer, polymeric film as recited in above, wherein the thickness of said co-extruded, multi-layer, polymeric film is a number below, or within a range defined by any two numbers below, including the endpoints of such a range, in the μm units:

5, 10, 20, 30, 50, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1100, 1125, 1150, 1175, 1200, 1225, 1250, 1275, 1300, 1325, 1350, 1375, 1400, 1425, 1450, 1475, 1500, 1525, 1600, 1700, 1800, 1900, 2000, 2500, 3000, 3500, 4000, 4500, 5000, 6000, 7000, 8000, 9000, 10000, 11000, 12000 and 13000.

In another embodiment, this invention relates to the co-extruded, multi-layer, polymeric film as recited in above, comprising a number of layers selected from the range of 2 layers through 100 layers.

In another embodiment, this invention relates to the co-extruded, multi-layer, polymeric film as recited in above, wherein the weight percent of said EVOH copolymer to that of said co-extruded, multi-layer, polymeric film is in the range of from about 0.1% to about 10%.

In another embodiment, this invention relates to the co-extruded, multi-layer, polymeric film as recited in above, wherein the mole percent of ethylene in said EVOH copolymer is in the range of from about 10% to about 55%.

In another embodiment, this invention relates to the co-extruded, multi-layer, polymeric film as recited in above, wherein the coextruded multi-layer polymeric film, the barrier layer, or the polymeric material that makes up the coextruded multi-layer polymeric film is characterized by at least one of the following properties as given below:
(i) the deflection temperature under load (DTUL) is a number below, or within a range formed by any two numbers below, including the endpoints of such a range, in units expressed as ° C.:
   30, 35, 40, 45, 50, 55, 60, 65, 70, 75, 80, 85, 90, 95, 100, 105, 110, 115, 120, 125, and 130;
(ii) the tensile modulus is a number below, or within a range formed by any two numbers below, including the endpoints of such a range, in units expressed as MPa:
   500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 900, 1950, 2000, 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450, 3500, 3550, 3600, 3650, 3700, 3750, 3800, 3850, 3900, 3950, 4000, 4050, 4100, 4150, 4200, 4250, 4300, 4350, 4400, 4450, 4500, 4550, 4600, 4650, 4700, 4750, 4800, 4850, 4900, 4950, and 5000;
(iii) the tensile strength at yield is a number below, or within a range formed by any two numbers below, including the endpoints of such a range, in units expressed as MPa:
   20, 30, 40, 50, 60, 70, 80, 90, 100, 110, 120, 130, 140, 150, 160, 170, 180, 190, and 200;
(iv) the percent elongation at yield is a number below, or within a range formed by any two numbers below, including the endpoints of such a range, in the % units:
   0.01, 0.03, 0.05, 0.07, 0.09, 0.1, 0.3, 0.5, 0.7, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, and 10.0;
(v) The flexural tangent modulus is a number below, or within a range formed by any two numbers below, including the endpoints of such a range, in units expressed as MPa:
   500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 900, 1950, 2000, 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450, 3500, 3550, 3600, 3650, 3700, 3750, 3800, 3850, 3900, 3950, 4000, 4050, 4100, 4150, 4200, 4250, 4300, 4350, 4400, 4450, 4500, 4550, 4600, 4650, 4700, 4750, 4800, 4850, 4900, 4950, and 5000;
(vi) the Notched Izod impact strength at 23° C. is a number below, or within a range formed by any two numbers below, including the endpoints of such a range, in units expressed as J/m:
   0.1, 0.2, 0.5, 0.7, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50;
(vii) the Gardner impact strength at 23° C. is a number below, or within a range formed by any two numbers below, including the endpoints of such a range, in units expressed as J/m:
   0.01, 0.03, 0.05, 0.07, 0.09, 0.1, 0.3, 0.5, 0.7, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, and 10.0;
(viii) the melt flow rate is a number below, or within a range formed by any two numbers below, including the endpoints of such a range, in units expressed as g/10 min:
   1, 1.2, 1.5, 2, 2.2, 2.5, 3, 3.2, 3.5, 4, 4.2, 4.5, 5, 5.5, 6, 6.5, 7, 7.5, 8, 8.5, 9, 9.5, 10, 15, 20, 25, 30, 35, 40, 45, 50, 55, 60, 65, 70, 75, 80, 85, 90, 95, and 100;
(ix) the percent haze is a number below, or within a range formed by any two numbers below, including the endpoints of such a range:
   0, 1, 2, 3, 4, 5, 6, 7, 8, 9, 10, 11, 12, 13, 14, 15, 16, 17, 18, 19, 20, 21, 22, 23 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, and 60;
(x) the percent clarity is a number below, or within a range formed by any two numbers below, including the endpoints of such a range:
   90, 91, 92, 93, 94, 95, 96, 97, 98, 99, and 100;
(xi) the water vapor transmission rate is a number below, or within a range formed by any two numbers below, including the endpoints of such a range in the units cm3/m2/day:
   0, 0.0005, 0.001, 0.005, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, and 5; and
(xii) the oxygen transmission rate is a number below, or within a range formed by any two numbers below, including the endpoints of such a range in the units of cm3/100 in2/day:
   0, 0.1, 0.2, 0.3, 0.4, 0.5, 1, 1.5, 2, 2.5, 3, 3.5, 4, 4.5, 5, 10, 15, 20, 25, 30, 35, 40, 45, 50, 55, and 60.

In another embodiment, this invention relates to the co-extruded, multi-layer, polymeric film as recited in above, comprising:
(I) an outside layer comprising polyethylene;
(II) a core layer comprising EVOH; and
(III) an inside layer comprising polyethylene;
   wherein at least one of the three layers above, comprises the 2-layer stack or the 3-layer stack.

In another embodiment, this invention relates to the co-extruded, multi-layer, polymeric film as recited in above, comprising three layers in the following order:
(I) a first layer comprising predominately polypropylene;
(II) a second layer comprising predominately MODIFIED PP polymer or Resin RB1 optionally comprising at least one nucleating agent; and
(III) a third layer comprising predominately polypropylene.

In another embodiment, this invention relates to the co-extruded, multi-layer, polymeric film as recited in above, wherein the co-extruded, multi-layer, polymeric film exhibits a DTUL of 30° C. or more and a flexural secant modulus of 500 MPa or more.

In another embodiment, this invention relates to the co-extruded, multi-layer, polymeric film as recited in above, wherein the thickness of the film ranges from about 5 μm to about 1600 μm.

In another embodiment, this invention relates to the co-extruded, multi-layer, polymeric film as recited in above, wherein the hydrocarbon resin comprises an aliphatic hydrocarbon resin, an aliphatic/aromatic hydrocarbon resin, an aromatic hydrocarbon resin, a polyterpene resin, a terpene-phenol resin, a rosin ester, a rosin acid, or a mixture thereof.

In another embodiment, this invention relates to the co-extruded, multi-layer, polymeric film as recited in above, wherein the hydrocarbon resin is partially hydrogenated or fully hydrogenated.

In another embodiment, this invention relates to the co-extruded, multi-layer, polymeric film as recited in above, wherein the hydrocarbon resin comprises a polycyclopentadiene.

In another embodiment, this invention relates to the co-extruded, multi-layer, polymeric film as recited in above, wherein the hydrocarbon resin has a weight average molecular weight of from about 400 g/mol to about 5,000 g/mol.

In another embodiment, this invention relates to the co-extruded, multi-layer, polymeric film as recited in above, wherein the hydrocarbon resin comprises an aromatic C₉ hydrogenated resin having a ring and ball softening point of 110° C. or more.

In another embodiment, this invention relates to the co-extruded, multi-layer, polymeric film as recited in above:
wherein at least one of the layers further comprises a nucleating agent selected from sodium benzoate, talc, glycerol alkoxide salts, cyclic carboxylic acid salts, bicyclic carboxylic acid salts, glycerolates, phosphines, phosphates, diols, hexahydrophtalic acid salts, amides, and sugar alcohols, or
wherein co-extruded, multi-layer, polymeric the nucleating agent selected from sodium benzoate, talc, glycerol alkoxide salts, cyclic carboxylic acid salts, bicyclic carboxylic acid salts, glycerolates, phosphines, phosphates, diols, hexahydrophtalic acid salts, amides, sugar alcohols, mannitol or mannitol based compounds; sorbitol or sorbitol based compounds; nonitol or nonitol based compounds, 1,2,3-trideoxy-4,6:5,7-bis-0-((4-propylphenyl) methylene) nonitol;
2,4,8,10-tetra(tert-butyl)-6-hydroxy-12H-dibenzo[d,g][1,3,2]diox-aphosphocin 6-oxide; a salt of 2,4,8,10-tetra(tert-butyl)-6-hydroxy-12H-dibenzo[d,g][1,3,2]diox-aphosphocin 6-oxide; sodium salt of 2,4,8,10-tetra(tert-butyl)-6-hydroxy-12H-dibenzo[d,g][1,3,2]diox-aphosphocin 6-oxide;
hydroxy-bis[2,2′-methylenebis[4,6-di(tert-butyl)phenyl]phosphate; 2,2′-methylenebis(4,6-di-tert-butylphenyl)phosphate; a salt thereof, a sodium salt thereof; an aluminum salt thereof; a lithium salt thereof, (1R)-1-[(4R,4aR,8aS)-2,6-bis(3,4-dimethylphenyl)-4,4a,8,8a-tetrahydro-[1,3]dioxino[5,4-d][1,3]dioxin-4-yl]ethane-1,2-diol; 1-[8-propyl-2,6-bis(4-propylphenyl)-4,4a,8,8a-tetrahydro-[1,3]dioxino[5,4-d][1,3]dioxin-4-yl]ethane-1,2-diol;
N-[3,5-bis(2,2-dimethylpropanoylamino)phenyl]-2,2-dimethylpropanamide); a salt of (1S,2R)-cyclohexane-1,2-dicarboxylate with zinc octadecenoate; a calcium salt of (1S,2R)-cyclohexane-1,2-dicarboxylate with zinc octadecenoate; cis-endo-bicyclo[2,2,1]heptane-2,3-dicarboxylic acid disodium salt with 13-docosenamide; amorphous silicon dioxide;
bicycloheptane dicarboxylic acid; bicyclo[2.2.1]heptane dicarboxylate;
cyclohexanedicarboxylic acid; a calcium salt of cyclohexanedicarboxylic acid; a blend of cyclohexanedicarboxylic acid, the calcium salt of cyclohexanedicarboxylic acid, and zinc stearate; and
a mixture of two or more nucleating agents thereof.

In one embodiment, this invention relates to a co-extruded, multi-layer, polymeric film, comprising:
(I) an outside-layer stack, comprising a set of layers Z1, a set of layers Z2, or a set of layers Z1 and Z2;
(II) a core-layer stack, comprising the set of layers Z1, the set of layers Z2, or the set of layers Z1 and Z2; and
(III) an inside-layer stack, comprising the set of layers Z1, the set of layers Z2, or the combination of the set of layers Z1 and the set of layers Z2;
wherein at least one of the outside-layer stack, the core-layer stack, and the inside-layer stack comprises the set of layers Z2;
wherein the set of layers Z1 comprises at least one layer of said outside layer stack comprises polyethylene polymer or polyethylene interpolymer; and
wherein the set of layers Z2 comprises:
   (i) at least one 2-layer stack L1+L2, wherein the first layer of the 2-layer stack is L1 and the second layer of the 2-layer stack is L2, wherein layers L1 and L2 individually comprise, by weight, resin RA1 from 0-100%, resin RB1 from 0-100%, and additive S from 1-15%, wherein the weight content of resin RB1 in layers L1 and L2 is not simultaneously 0%, wherein the two layers L1 and L2 in said 2-layer stack are planarly in contact with each other;
   OR
   (ii) at least one 3-layer stack L3+L4+L5, wherein the first layer of the 2-layer stack is L3 the second layer of the 2-layer stack is L4, and the third layer of the 3-layer stack is L5, wherein layers L3, L4, and L5 individually comprise, by weight, resin RA1 from 0-100%, resin RB1 from 0-100%, resin RR1 from 0-100% and additive S from 1-15%, wherein the weight content of resin RB1 and RR1 in layers L3, L4, and L5 is not simultaneously 0%, wherein the three layers L1, L2, and L3 in said 3-layer stack are planarly in contact with each other;
   OR
   (iiia) at least one 2-layer stack L1+L2, wherein the first layer of the 2-layer stack is L1 and the second layer of the 2-layer stack is L2, wherein layers L1 and L2 individually comprise, by weight, resin RA1 from 0-100%, resin RB1 from 0-100%, and additive S from 1-15%, wherein the weight content of resin RB1 in layers L1 and L2 is not simultaneously 0%, wherein the two layers L1 and L2 in said 2-layer stack are planarly in contact with each other, and
   (iiib) at least one 3-layer stack L3+L4+L5, wherein the first layer of the 2-layer stack is L3 the second layer of the 2-layer stack is L4, and the third layer of the 3-layer stack is L5, wherein layers L3, L4, and L5 individually comprise, by weight, resin RA1 from 0-100%, resin RB1 from 0-100%, resin RR1 from 0-100% and additive S from 1-15%, wherein the weight content of resin RB1 and RR1 in layers L3, L4, and L5 is not simultaneously 0%, wherein the three layers L1, L2, and L3 in said 3-layer stack are planarly in contact with each other;
   wherein:
   Resin RA1 comprises predominately polypropylene,
   Resin RB1 comprises predominately polypropylene and 50 wt. % or less of a hydrocarbon resin; and
   Resin RR1 comprises predominately the APEX material.

In another embodiment, this invention relates to the co-extruded, multi-layer, polymeric film as recited in above, wherein said co-extruded, multi-layer, polymeric film, further comprises at least one layer comprising:
(C) predominately polyolefin;
(D predominately polypropylene;
(E) predominately MODIFIED polypropylene comprising at least one nucleating agent;
(F) predominately polypropylene and 50 wt. % or less of a hydrocarbon resin;
(G) predominately polyethylene polymer or interpolymer;
(H) EVOH;
(I) predominately nylon;
(J) predominately polyester;
(K) resin RB1;
(M) resin RR1;
(N) additive S; or
(O) a combination of the above;
wherein said polyethylene interpolymer comprises:
   (a) optionally a first ethylene/α-olefin copolymer fraction having a density in the range of 0.894 to 0.908 g/cm³; a melt index in the range of 0.2 to 1 dg/min; and
   (b) optionally a second ethylene/α-olefin copolymer fraction having a density in the range of from about 0.910 to 0.924 g/cm³, a melt index in the range from 0.5 to 2 g/10 min, a zero shear viscosity ratio (ZSVR) in the range of from about 1.15 to 2.5; a molecular weight distribution, expressed as the ratio of the weight average molecular weight to number average molecular weight (Mw/Mn), in the range of 2.0 to 4.0.

In another embodiment, this invention relates to a flexible sheet or a rigid sheet comprising the co-extruded, multi-layer, polymeric film as recited above.

In one embodiment, this invention relates to a shaped polymeric article comprising the co-extruded, multi-layer, polymeric film as recited above or the flexible sheet or the rigid sheet as recited above.

In one embodiment, this invention relates to a shaped polymeric article as recited above, wherein the shaped polymeric article is a thermoformed shaped polymeric article.

In one embodiment, this invention relates to a shaped polymeric article as recited above, wherein said shaped polymeric article is a packaging product for the food, medical, general retail industries, a package, a cup, a tub, a pail, ajar, a box, a container, a lid, a tray for food article, a tray not for food article, a blister, a clamshell, a bottle, a pouch,
In one embodiment, this invention relates to a shaped polymeric article as recited above, which is a container.

In one embodiment, this invention relates to a shaped polymeric article as recited above, for packaging food product.

In one embodiment, this invention relates to a container which is a shaped polymeric article as recited above, wherein said co-extruded, multi-layer, polymeric film comprises:
(I) an outside layer comprising polyethylene;
(II) a core layer comprising EVOH; and
(III) an inside layer comprising polyethylene;
   wherein at least one of the three layers above, comprises said 2-layer stack L1+L2 or said 3-layer stack L3+L4+L5.

In another embodiment, this invention relates to a process for preparing the co-extruded, multi-layer, polymeric film as recited above, comprising the steps of:
(I) providing the layers L1 and L2 or L3, L4, and L5,
   wherein said L1, L2, L3, L4, and L5 form an interface or interphase at their adjacent boundaries such that the interphase provides discontinuity in properties between the two layers to provide improvement in barrier properties of the co-extruded, multi-layer, polymeric film.

In another embodiment, this invention relates to a container for packaging food product prepared from a rigid co-extruded, multi-layer, polymeric film prepared by the process as recited above.

In another embodiment, this invention relates to a laminated structure comprising the co-extruded, multi-layer, polymeric film as recited above or the sheets as recited above.

In another embodiment, this invention relates to a laminated structure as recited above, wherein the laminated structure thickness is in the range of 5 μm to 1600 μm.

In one embodiment, this invention relates to a co-extruded, multi-layer, polymeric film as recited above, wherein the thickness of the layer comprising the APEX material has a thickness in the range of 5 microns to 75 microns.

In one embodiment, this invention relates to a co-extruded, multi-layer, polymeric film as recited above, wherein the thickness is in the range of 5 microns to 15 microns.

In one embodiment, this invention relates to a co-extruded, multi-layer, polymeric film as recited above, wherein the layer comprising the APEX material comprises from 30 to 70% one or more structural polymers, from 30-70% one or more barrier polymers, and optionally from 3-10% of a compatibilizer.

In one embodiment, this invention relates to a co-extruded, multi-layer, polymeric film as recited above, wherein the structural polymer predominately comprises polypropylene and the barrier polymer comprises EVOH and the compatibilizer is a functionalized polyolefin.

In one embodiment, this invention relates to the process as recited above, further comprising the step of providing said co-extruded polymeric film for preparing flexible sheets, rigid sheets, or shaped polymeric articles that are generally prepared using polystyrene.

In one embodiment, this invention relates to a co-extruded, multi-layer, polymeric film as recited above, wherein said polymeric film is at least partially recyclable.

In one embodiment, this invention relates to a container as recited above, wherein the container is provided for preparing refrigerated and shelf-stable yogurt unpacks and multi-packs; medium barrier snack packs; packaging for retort and aseptic baby food; packaging for shelf stable and form-fill-seal beverages; packaging for component meal trays; packaging for condiments and portion-control condiments; packaging for jams, jellies, and sauces and portion-control jams, jellies, and sauces; packaging for shelf-stable dairy product, creamers, butter and margarine; snack packs; applesauce cups; case-ready trays; coffee and tea pods; packaging for deli meats and cheeses; fruit and produce cups; on-the-go cups; packaging for wet and dry pet food; ready-to-heat (RTH) meal trays; salad dressing cups; and soup tubs.

### BRIEF DESCRIPTION OF DRAWINGS

FIG. 1 shows multilayer embodiments of the rigid film of the present invention.

### DESCRIPTION OF THE INVENTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### I. Definitions and Terms

All percentages expressed in the present patent application are by weight of the total weight of the composition unless expressed otherwise.

All ratios expressed in this patent application are on a weight: weight basis unless expressed otherwise.

Ranges are used as shorthand only to avoid listing and describing each and every value within the range. Any appropriate value within the range can be selected as the upper value, the lower value, or the end-point of the range.

The singular form of a word includes its plural, and vice versa, unless the context clearly dictates otherwise. Thus, references “a,” “an,” and “the” generally include the plurals of the respective terms they qualify. For example, reference to “a method” includes its plural-“methods.” Similarly, the terms “comprise,” “comprises,” and “comprising,” whether used as a transitional phrase in the claims or otherwise, should be interpreted inclusively rather than exclusively. Likewise, the terms “include,” “including,” and “or” should be construed to be inclusive, unless such a construction is clearly prohibited from the context. Similarly, the term “examples,” particularly when followed by a listing of terms, is merely exemplary and illustrative and should not be deemed to be exclusive or comprehensive.

The terms “comprising,” “including,” “having,” and their derivatives, are not intended to exclude the presence of any additional component, step, or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step or procedure not specifically delineated or listed.

Methods, compositions, and other advances disclosed in this patent application are not limited to particular methodology, protocols, and reagents described in the application because, as the skilled artisan will appreciate, they may vary. Further, the terminology used in this application describes particular embodiments only and should not be construed as limiting the scope of what is disclosed or claimed.

Unless defined otherwise, all technical and scientific terms, terms of art, and acronyms used in the present application have the meanings commonly understood by one of ordinary skill in the art in the field(s) of the invention, or in the field(s) where the term is used. Although any compositions, methods, articles of manufacture, or other means or materials similar or equivalent to those described in the present patent application can be used in the practice of the present invention, specific compositions, methods, articles of manufacture, or other means or materials are described only for exemplification.

All patents, patent applications, publications, technical and/or scholarly articles, and other references cited or referred to in this patent application are incorporated in their entirety by reference to the extent allowed by law. The discussion of those references is intended merely to summarize the assertions made in these references. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

By predominately is meant 40% by weight or more than 40% by weight.

The term “composition,” as used herein, includes a mixture of materials which comprise the composition, as well as reaction products and decomposition products formed from the materials of the composition.

The term “polymer,” as used herein, refers to a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), copolymer and interpolymer as defined hereinafter.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The term, “ethylene-based polymer,” as used herein, refers to a polymer that comprises, in polymerized form, a majority amount of ethylene monomer (based on the weight of the polymer), and optionally may comprise one or more comonomers.

The term, “ethylene/α-olefin interpolymer,” as used herein, refers to an interpolymer that comprises, in polymerized form, a majority amount of ethylene monomer (based on the weight of the interpolymer), and one or more additional α-olefin monomers. The term “ethylene/α-olefin interpolymer” includes ethylene/α-olefin copolymers, as well as terpolymers and other polymers derived from multiple monomers.

The term, “ethylene/α-olefin copolymer,” as used herein, refers to a copolymer that comprises, in polymerized form, a majority amount of ethylene monomer (based on the weight of the copolymer), and an α-olefin, as the only two monomer types.

The term, the term “ethylene vinyl alcohol” or “EVO” as used herein, refers to a polymer comprising repeating units of ethylene and vinyl alcohol. As is generally known in the art the weight ratio of the ethylene to vinyl alcohol defines the barrier properties. Such polymers and their methods of manufacture are generally known in the art. As used herein, EVOH includes hydrolyzed or saponified ethylene/vinyl acetate copolymers and refers to a vinyl alcohol copolymer having an ethylene comonomer, which may be obtained, for example, by the hydrolysis of an ethylene/vinyl acetate copolymer or by chemical reaction of ethylene monomers with vinyl alcohol.

By “planarly in contact with each other” is meant that two layers are in the planar and are in contact with each other in a planar manner, that is, not at the edge but a substantial planar area of the two layers are in contact or are capable of contact. Generally, “in contact” also means that the two layers are attached to each other, for example, as found in polymeric co-extrusion.

By “attached” is meant, for example in “planarly and contactably attached,” that two layers are securely tied to each other. But in general, “attached” conveys the meaning that between the two planar layers there is a substantial connection and if there is non-connection, it is only nominal. Attachment could be strong or weak attachment.

By “secured” is meant that two layers are in contact with each other and are substantially connected, similar to the meaning of the term “attached.”

By “adjacent” is meant that two layers are planarly in contact with each other and is interchangeably used to mean “planarly in contact.” “Adjacent” may also be used to show that their attachment may or may not be as secure when the term “attached” or “secured” or “adhered” is used. For example, two layers could be simply place on top of each other, as adjacent to each other. The context should be construed to imply meanings for these terms.

By MODIFIED polypropylene” (alternatively referred to as “MODIFIED PP,” “Modified polypropylene,’ or “Modified PP”) is meant a polypropylene described above that comprises one or more nucleating agents.

As used herein “density” is determined by ASTM D 792 and “melt-index” by ASTM D 1238. The “melting point” of a polymer is measured as the peak melting point when performing differential scanning calorimetry (DSC) as described in ASTM Procedure D3417-83 (rev. 88).

Co-extrusion processing technology allows for the development of multi-layered film and sheet structures which in turn incorporate different materials and additives into each of the extruded layers, thereby balancing cost while engineering desired performance attributes and functionality for end application use.
In one embodiment, co-extruded, multi-layer, polymeric film, comprising:
(i) at least one 2-layer stack L1+L2, wherein the first layer of the 2-layer stack is L1 and the second layer of the 2-layer stack is L2, wherein layers L1 and L2 individually comprise, by weight, resin RA1 from 0-100%, resin RB1 from 0-100%, and additive S from 1-15%, wherein the weight content of resin RB1 in layers L1 and L2 is not simultaneously 0%, wherein the two layers L1 and L2 in said 2-layer stack are planarly in contact with each other;
   AND/OR
(ii) at least one 3-layer stack L1+L2+L3, wherein the first layer of the 2-layer stack is L1 the second layer of the 2-layer stack is L2, and the third layer of the 3-layer stack is L3, wherein layers L1, L2, and L3 individually comprise, by weight, resin RA1 from 0-100%, resin B1 from 0-100%, resin RR1 from 0-100% and additive S from 1-15%, wherein the weight content of resin RB1 and RR1 in layers L1, L2, and L3 is not simultaneously 0%, wherein the three layers L1, L2, and L3 in said 3-layer stack are planarly in contact with each other; wherein:
   Resin RA1 comprises predominately polypropylene,
   Resin RB1 comprises predominately polypropylene and 50 wt. % or less of a hydrocarbon resin;
   Resin RR1 comprises predominately the APEX material; and
wherein said co-extruded, multi-layer, polymeric film, optionally, further comprises at least one layer comprising:
(C) predominately polyolefin;
(D predominately polypropylene;
(E) predominately MODIFIED polypropylene comprising at least one nucleating agent;
(F) predominately polypropylene and 50 wt. % or less of a hydrocarbon resin;
(G) predominately polyethylene polymer or interpolymer;
(H) EVOH;
(I) predominately nylon;
(J) predominately polyester;
(K) resin RB1;
(M) resin RR1;
(N) additive S; or
(O) a combination of the above.

The materials listed above are further defined and discussed below.

In another embodiment, the present invention calls out the incorporation and interplay of several materials technologies, namely:
1. Resin RA1, which is predominately polypropylene (PP),
2. Resin RB1 (a medium to high enhanced barrier material with high stiffness PP sheet technology),
3. Additive S polymer additives enable mono-material design and manufacturing with higher levels of recycled polyolefins, which will help film/sheet producers and converters in flexible and rigid packaging to actively contribute to easier processability on top of more sustainable and circular solutions in the packaging value chain, supporting their customers to innovate and reach targets like: better processability and lower temperatures, full recyclability, reduction of virgin plastic usage, longer shelf-life, lower CO2 footprint), and
4. Resin RR1, which is a polypropylene (PP) based high barrier compounded material technology designed to replace EVOH and or Nylon for high oxygen barrier application requirements into co-extruded sheet structures to deliver cost, performance, and sustainability benefits over PS/HIPS, PET, PVC sheet structures in food, consumer goods, industrial, and medical/pharma packaging applications.

More specifically, resin RB1 material and associated structures deliver higher stiffness-higher flexural strength, snap ability, and lower shrinkage versus PP (homopolymer and copolymer), and sustainable footprint versus HIPS/PS, PET, and PVC for form fill and seal (FFS) and thermoforming (TF) applications. The incorporation of Additive S into a PP delivers comparable stiffness and snap ability to resin RB1, but the shrinkage of this resin is comparable to regular PP (resin RA1) in deep draw FFS and TF applications. On the other hand, the incorporation of resin RR1 delivers enhanced/high oxygen barrier properties as required for medium to longer shelf requiring barrier applications for all PP and/or resin RB1 technology.

In order to maintain and balance overall material cost while delivering custom performance properties, namely stiffness, strength, snap ability, lower processing shrinkage in both shallow and deep draw FFS and TF applications, and a favorable sustainability/recyclability footprint versus HIPS/PS based structures, it requires the development of highly engineered co-extruded sheet structures that balance resins RA1, RB1, RR1, and additive S polymer.

Below are 4 general examples of the present invention, that is, co-extruded sheet structures that can be leverage for medium to high oxygen barrier FFS and TF applications. Layered structures below can be both symmetric and asymmetric:

$$\begin{matrix}1. & \\ RESIN RB 1 + ADDITIVE S / ( RESIN RB 1 + ADDITIVE S ) / RESIN RRB 1 + ADDITIVE S & \end{matrix}$$

$$\begin{matrix}2. & \\ RESIN RB 1 / ( RESIN RB 1 + ADDITIVE S ) / RESIN RB 1 & \end{matrix}$$

$$\begin{matrix}3. & \\ RESIN RB 1 / ( RESIN RA 1 + ADDITIVE S ) / RESIN RB 1 & \end{matrix}$$

$$\begin{matrix}4. & \\ RESIN RA 1 / ( RESIN RA 1 + ADDITIVE S ) / RESIN RB 1 / RESIN RA 1 & \end{matrix}$$

$$\begin{matrix}5. & \\ RESIN RA 1 / ( RESIN RA 1 + ADDITIVE S + RESIN RB 1 ) / RESIN RA 1 & \end{matrix}$$

$$\begin{matrix}6. & \\ RESIN RA 1 / ( RESIN RA 1 + ADDITIVE S + RESIN RR 1 ) / RESIN RA 1 / RESIN RA 1 & \end{matrix}$$

$$\begin{matrix}7. & \\ RESIN RA 1 + ADDITIVE S / RESIN RB 1 / RESIN RA 1 + ADDITIVE S & \end{matrix}$$

$$\begin{matrix}8. & \\ RESIN RA 1 + ADDITIVE S / RESIN RB 1 / RESIN RR 1 / RESIN RA 1 + ADDITIVE S & \end{matrix}$$

In each of the above structures:
1. The Resin RA1 or the PP layers could be homopolymer, random copolymer, or impact copolymer and can be 5-95% of the overall structure depending on the end use application,
2. The PP or Resin RA1+Additive S layer can be 5-95% of the overall structure as either of the layer configuration in a multilayer structure with Additive S and or the Resin RB1 material and or layer anywhere from 0-95% blend ratio of the overall structure,
3. The Resin RR1 layer can be 0.5%-95% of the overall structure.
4. The overall sheet thickness could be in the range of 0.010″ to 0.100″.

The Resin RA1 or PP can be purchased from supplier Ineos, Braskem, Exxon, or Invista. Material options include Ineos (H02C-01—mini random homopolymer), Braskem (6025N-HPP), or Exxon (6282NE2-HPP).

In one embodiment, the following materials are used, where Plastvance T is Additive S obtained from Synthomer Co. in Ohio.

| Material Description | Application |
|---|---|
| H02C-01 + 15% PLASTVANCE T | YOGURT FORM FILL SEAL |
| H02C-01 + 10% PLASTVANCE T | PUDDING CUP FILL SEAL- |
| | Downgauging from 1 MM to 0.9 MM |
| H02C-01 + 15% PLASTVANCE T | PUDDING CUP FILL SEAL- |
| | Downgauging from 1 MM to 0.9 MM |
| H02C-01 + 15% PLASTVANCE T | YOGURT CUP FILL SEAL |
| H02C-01 + 15% PLASTVANCE T | FORM FILL SEAL |

In one embodiment, random copolymer PP 22N2A blends with Resin RB1. Similar blends with the 23T2A resin (Resin RA1) as well as Vistamaxx resin (Resin RA1) are also made:
1. 85/15 H02C-01/PLASTVANCE T shows a significant difference in the material crystallinity % and melt temperature. The following combinations are run for preparing yogurt cups.
2. 70%/22%/8%—22N2A or Resin RA1/Resin RB1/Resin RA1 VM 6102
3. 75% 23T2A or Resin RA1/25% MP1175 or Resin RB1
4. PP+10% Additive S Plastvance T

The above allows for reduction in melt temperature by 2 degree C. and an overall downgauge by 0.05 mm.

The following coextruded films and cups are also made as part of the present invention. Yogurt cups are made as below. Resins 23T2A, 22N2A, VM6102, H02C-01 are Resin RA1 or polypropylene. Resin MP1175 is Resin RB1 as described infra. Plastvance T is Additive S as described infra.

| | YOGURT CUPS | | | |
|---|---|---|---|---|
| No. | Gauge | | Blend ratio for ABC layers | Materials grades |
| 1. | 0.9 | mm | 75/25 | 23T2A/MP1175 |
| 2. | 0.9 | mm | 70/22/8 | 22N2A/MP1175/ |
| | | | | VM6102 |
| 3. | 0.81 | mm | 70/22/8 | 22N2A/MP1175/ |
| | | | | Plastvance T |
| 4. | 0.90 | mm | 90/10 | H02C-01/ |
| | | | | PLASTVANCE T |
| 5. | 0.508 | mm | 75/25 | 23T2A/MP1175 |
| 6. | 0.508 | mm | 70/22/8 | 22N2A/MP1175/ |
| | | | | VM6102 |
| 7. | 0.458 | mm | 70/22/8 | 22N2A/MP1175/ |
| | | | | Plastvance T |
| 8. | 0.508 | mm | 90/10 | H02C-01/ |
| | | | | PLASTVANCE T |

Samples 7 and 8 combine Resin RB1 with Additive S that aims to achieve reduced shrinkage. The starting sheet thickness is reduced by 10% for both samples to help reduce forming temperature on FFS process and improve processability and wall distribution around the cups but still maintain or improve top load strength of the material.

For further description of the experiments to run the above coextrusion trials, please see infra, the Experimental section where other trials are discussed.

### Additive S

In one embodiment, the Additive S is a Hydrocarbon Polymer Modifiers (“HPM”) material. A preferred HPM is hydrogenated polycyclopentadiene.

The Additive S is included in the resin layer in the range of from about 2% to about 40% by weight of the extruded layer. That is, the Additive S can be included as defined by any number below or within a range defined by any two numbers below, including the endpoints, in weight percent of such co-extruded layer:

2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40.

The layered compositions as described above further comprises such a hydrocarbon polymer modifier (“HPM”). HPMs useful in this invention include hydrogenated polycyclopentadiene resins and aromatic modified hydrogenated polycyclopentadiene resins, As used herein, reference to monomers in the HPM interpolymer is understood to refer to the as-polymerized units derived from that monomer. The terms polymer and interpolymer are used broadly herein and in the claims to encompass higher oligomers having a number average molecular weight (Mn) equal to or greater than 500, as well as compounds that meet the molecular weight limits for polymers according to classic ASTM definitions.

Cyclic components are generally a distillate cut or synthetic mixture of C₅ and C₆ cyclic olefins, diolefins, and dimers, codimers and trimers, etc. from a distillate cut. Cyclics include, but are not limited to, cyclopentene, cyclopentadiene, dicyclopentadiene, cyclohexene, 1,3-cycylohexadiene, and 1,4-cyclohexadiene.

A preferred cyclic is cyclopentadiene. The dicyclopentadiene may be in either the endo or exo form. The cyclics may or may not be substituted. Preferred substituted cyclics include cyclopentadienes and dicyclopentadienes substituted with a C₁ to C₄₀ linear, branched, or cyclic alkyl group, preferably one or more methyl groups. In one embodiment, the cyclic components are selected from the group consisting of: cyclopentadiene, cyclopentadiene dimer, cyclopentadiene trimer, cyclopentadiene-C₅ codimer, cyclopentadiene-piperylene codimer, cyclopentadiene-C₄ codimer, cyclopentadiene-methyl cyclopentadiene codimer, methyl cyclopentadiene, methyl cyclopentadiene dimer, and mixtures thereof.

In general, the cyclic components increase the softening point. In one embodiment, the HPM may be prepared from a monomer mix that can include up to 60% cyclics or up to 50% cyclics, by weight of the monomers in the mix. Typical lower limits include at least about 0.1% or at least about 0.5% or from about 1.0% cyclics in the monomer mix. In at least one embodiment, the HPM monomer mix may include more than 10% cyclic components up to 20% cyclics or more, or preferably up to 30% cyclics or more, or more preferably up to 40% cyclics or more, or more preferably up to 45% or 50% cyclics or more, by weight of the monomers in the monomer mixture from which the HPM is prepared. In a particularly preferred embodiment, the HPM monomer mixture comprises from about 10 to about 50% cyclics, or from about 20 to about 45% cyclics, or from about 20 to about 40% cyclic components.

Generally, HPMs have a number average molecular weight (Mn) greater than about 600 g/mole, or greater than about 800 g/mole, or greater than about 900, or greater than about 1000 g/mole. In an embodiment, the HPM has a Mn between about 900 g/mol and 3000 g/mole, or between about 1000 and 1500 g/mole. In at least one embodiment, HPMs have a weight average molecular weight (Mw) greater than about 2500 g/mole, or greater than about 5000 g/mole, or from about 2500 to about 25,000 g/mole, or from 3000 to 20,000 g/mole. Preferably, HPMs have a weight average molecular weight of from 3500 to 15,000 g/mole, or more preferably from about 5000 to about 10,000 g/mole. The HPM may have a z-average molecular weight (Mz) greater than about 10,000 g/mole, or greater than about 20,000 g/mole, or greater than about 30,000 g/mole. In embodiments, Mz ranges from 10,000 to 150,000 g/mole, or from 20,000 to 100,000 g/mole, or from 25,000 to 75,000 g/mole, or from 30,000 to 60,000 g/mole. Mw, Mn, and Mz may be determined by gel permeation chromatography (GPC).

In one embodiment, the HPM has a polydispersity index (“PDI”, PDI=Mw/Mn) of 4 or less. In a particularly preferred embodiment, the HPM has a PDI of at least about 2.5, or at least about 3, or at least about 4, or at least about 5. In embodiments, Mz/Mn is greater than 5, greater than 10, greater than 12, greater than 15, greater than 20, greater than 25, or greater than 30. In embodiments, Mz/Mn ranges up to 150 or more, up to 100, up to 80, or up to 60. In other embodiments, Mz/Mn is from 5 to 100, or from 10 to 80, or from 10 to 60, or from 10 to 40, or from 10 to 30, or from 15 to 40, or from 30 to 60 or from 35 to 60.

In an embodiment, the HPM can have a softening point of 80° C. to 160° C., or preferably 100° C. to 160° C., or more preferably from 110° C. to 150° C. Softening point can be determined according to the Ring & Ball Method, as measured by ASTM E-28.

In an embodiment, the HPM can have a glass transition temperature (Tg) of from about 30° C. to about 110° C., or from about 50° C. to about 110° C., or from about 60° C. to about 100° C. Differential scanning calorimetry (DSC) may be used to determine the Tg of the HPM.

A preferred HPM is hydrogenated polycyclopentadiene. It is included in the resin layer in the range of from about 2% to about 30% by weight of the extruded layer comprising the HPM material.

In one embodiment, Additive S is Plastvance™ T, which is a plastic modifier purchased from Synthomer Co. in Ohio. It is an additive for transparent polymers such as polypropylene sheet production utilized in thermoformed articles and other applications. A typical amount utilized in a final sheet composition is 10 wt. % Plastvance™ T. The more material added the stiffer the final thermoformed polypropylene product will get.

Maximum benefits require an adjustment of processing conditions such as extrusion and thermoforming temperatures. PlastvanceT has good compatibility with polypropylene and similar viscosity to polypropylene for thermoforming applications. As a result of the Plastvance T additive, the PP can thermoform as easily as polystyrene.

PP's superior properties notwithstanding, it has found limited use as extruded and thermoformed material owing to its process related problems. For example, PP has low melt strength, which can result in uneven thickness (thinning) and even sagging, as a result. Its temperature window is also smaller, about 15° C., versus 30° C. for PS and PET, which then requires constant monitoring for thermoforming. The time required for polypropylene to fully crystallize, slows down production cycles and reduces overall productivity along with the risk of uneven shrinkage.

Without wishing to be bound by theory, it is speculated that Plastvance™ T does not modify PP's crystallinity level, or reduce the size of spherulitic structures, but it significantly improves thermoforming results by changing the amorphous part of the polypropylene. Adding >10% of Plastvance™ T enhances the E-modulus, increasing the strength and self-supporting properties of the sheet, minimizing sagging during the heating phase of thermoforming, in addition to improving overall strength and dimensional stability of the final part. The presence of Plastvance™ T improves the heat-transfer during processing and mechanical property balance, while improving the processing window and lowering the heat consumption, allowing down-gauging and giving properties to the polypropylene that are similar to those inherent to PS thermoformed cups and trays. The results are light-weight products with desirable mechanical and physical properties and a lower overall carbon footprint.

One of the advantages of using Additive S is it helps in down-gauging PP while keeping the same product properties, for example, in rigid sheet, it will allow, for same top load, a 10% less weight, a more uniform wall, and similar thickness with less content of PP. Additive S also can help reduce WVTR and OTR, for example, from 5% to 25%.

HPMs are described in U.S. Pat. No. 8,653,195B2 and is incorporated by reference herein.

### II. Co-Extruded Films

Generally, this invention relates to polymeric film structures that comprise at least one stack of co-extruded polypropylene (“PP”) layers. The polymeric film structures may comprise one or more other layers as described herein and also in the art.

In one embodiment, generally, this invention relates to a rigid film or rigid sheet that comprises at least one stack of polypropylene (“PP”) layers. Such rigid film is characterized inter alia by enhanced barrier properties, stiffness, toughness, and/or snapability. In another embodiment, generally, this invention relates to a flexible film or a flexible sheet that comprises at least one stack of polypropylene (“PP”) layers. Such flexible film is characterized inter alia by enhanced barrier properties, stiffness, and toughness.

In another embodiment, generally, this invention relates to a rigid film or rigid sheet that comprises at least one stack of polypropylene (“PP”) layers that may be co-extruded or laminated. In another embodiment, generally, this invention relates to a flexible film or a flexible sheet that comprises at least one stack of polypropylene (“PP”) layers that may be co-extruded or laminated.

The polypropylene stack, whether rigid or flexible, can be coextruded with other film structures, or laminated with other film structures. It should be noted that in a laminated structure comprising such a polypropylene stack, the polypropylene stack may be co-extruded or laminated.

Lamination can be thermal lamination, extrusion lamination, adhesion lamination (solvent and solventless), or printing or forming or shaping, for example.

By a “layer comprising predominately a component” is meant that the layer predominately includes the component. To be clear, by “predominately” is meant that the layer comprises more than about 40% by weight of said component. For example, if a layer predominately comprises polypropylene, it means that the weight percent of PP in the layer is more than about 40%.

By a stack of polypropylene layers (“polypropylene stack” or “PP-stack”) is meant at least two layers, each comprising predominately polypropylene, as described herein, and at least one other layer comprises predominately regular polypropylene.

In one embodiment, such a stack of polypropylene layers comprises at least two layers, each comprising predominately polypropylene, in which, at least one layer comprises predominately polypropylene comprising at least one nucleating agent as described herein, and at least one other layer comprises predominately regular polypropylene.

In one embodiment, such a stack of polypropylene layers comprises at least two layers, each comprising predominately polypropylene, in which, at least one layer comprises predominately MODIFIED polypropylene comprising at least one nucleating agent as described herein, and at least one other layer comprises predominately regular polypropylene, wherein said two layers in said 2-layer stack are planarly in contact with each other.

In one embodiment, a polymeric film structure comprising only one 2-layer PP-stack does not include any other non-PP layer interspersed within the stack. So, for example, in an A-B stack, there is no possibility that a third non-PP layer, for example C, is interspersed between A and B. But, in an A1-B-A2 stack, at least one pair, of A1-B and B-A2, does not have an additional layer C placed between them. In other words, in this embodiment, one or more A-B layers would not have an interspersed C layer. Similarly, in a stack of A1-B1-A2-B2-A3-A4, there is a possibility of a layer C not being interspersed between at least one pair of: A1 and B1, B1 and A2, A2 and B2, B2 and A3, or A3 and A4. Stated differently, in this stack, A1 is in planar contact with B1; B1 is in planar contact with A1 and A2; A2 is in a planar contact with B1 and B2, and so on and so forth. In this embodiment, A denotes polypropylene and B denotes MODIFIED polypropylene, where A1, A2, etc. are different grades of polypropylene or blends of two or more grades of polypropylene; and B1, B2, etc. are different grades of MODIFIED polypropylene, or blends of two or more grades of MODIFIED polypropylene.

In one embodiment, the number of layers in a polypropylene stack ranges from 2-100. Stated another way, a PP-stack could have any one of the following number of layers: 2, 3, 4, 5, 6, 7, 8, 9, 10, 11, 12, 13, 14, 15, 16, 17, 18, 19, 20, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100. In one embodiment, the number of layers in the PP-stack is selected by any number within a range defined by any two numbers herein.

This invention also envisages rigid co-extruded film that includes one or more than one polypropylene stack.

In one embodiment, the rigid co-extruded film of the invention including at least one PP-stack further comprises other layers, such that the layers are co-extruded symmetrically or asymmetrically.

In one embodiment, the rigid co-extruded film of the invention including at least one PP-stack further comprises one or more of the following layers:
(1) at least one layer comprising predominately polypropylene;
(2) at least one layer comprising predominately MODIFIED PP;
(3) at least one tie layer;
(4) at least one layer comprising predominately polyethylene polymer or interpolymer;
(5) at least one barrier layer comprising predominately EVOH;
(6) at least one barrier layer comprising predominately nylon;
(7) at least one barrier layer, comprising predominately polyester; and
(8) a combination of the above layers.

### IIA. Deflection Temperature Under Load

In one embodiment, the polymeric film structures and/or barrier layer and/or polymeric material as disclosed herein may demonstrate improved performance at higher temperatures. For instance, as indicated by the deflection temperature under load (DTUL), the temperature at which deformation occurs under a specified load may be relatively high. In this regard, the DTUL may be of 30° C. or more, such as 40° C. or more, such as 45° C. or more, such as 50° C. or more, such as 60° C. or more, such as 70° C. or more, such as 80° C. or more, such as 90° C. or more, such as 100° C. or more, such as 110° C. or more, such as 125° C. or more. The DTUL may be 130° C. or less, such as 120° C. or less, such as 110° C. or less, such as 100° C. or less, such as 90° C. or less, such as 80° C. or less, such as 75° C. or less. The aforementioned property may apply to the polymeric substrate, the barrier layer, and/or the polymeric material as disclosed herein.

The DTUL may be of a number below, or within a range formed by any two numbers below, including the endpoints of such a range, in units expressed as ° C. 30, 35, 40, 45, 50, 55, 60, 65, 70, 75, 80, 85, 90, 95, 100, 105, 110, 115, 120, 125, and 130.

The aforementioned property may apply to the polymeric film structure, the barrier layer, and/or the polymeric material as disclosed herein.

### II.B. Tensile Modulus

In one embodiment, the polymeric film structures and/or barrier layer and/or polymeric material as disclosed herein may also exhibit a relatively high tensile modulus, which is generally an indication of the stiffness. In this regard, the tensile modulus may be 500 MPa or more, such as 600 MPa or more, such as 700 MPa or more, such as 750 MPa or more, such as 800 MPa or more, such as 900 MPa or more, such as 1,000 MPa or more, such as 1,250 MPa or more, such as 1,500 MPa or more, such as 2,000 MPa or more, such as 2,250 MPa or more, such as 2,500 MPa or more, such as 2,750 MPa or more, such as 3,000 MPa or more, such as 3,250 MPa or more, such as 3,500 MPa or more, such as 4,000 MPa or more. The tensile modulus may be 5,000 MPa or less, such as 4,500 MPa or less, such as 4,000 MPa or less, such as 3,750 MPa or less, such as 3,500 MPa or less, such as 3,000 MPa or less, such as 2,500 MPa or less, such as 2,000 MPa or less, such as 1,500 MPa or less, such as 1,000 MPa or less. Furthermore, the tensile modulus may be a number below, or within a range formed by any two numbers below, including the endpoints of such a range, in units expressed as MPa: 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 900, 1950, 2000, 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450, 3500, 3550, 3600, 3650, 3700, 3750, 3800, 3850, 3900, 3950, 4000, 4050, 4100, 4150, 4200, 4250, 4300, 4350, 4400, 4450, 4500, 4550, 4600, 4650, 4700, 4750, 4800, 4850, 4900, 4950, and 5000.

The aforementioned property may apply to the polymeric film structure, the barrier layer, and/or the polymeric material as disclosed herein.

### IIC. Tensile Strength at Yield

In one embodiment, the polymeric film structures and/or barrier layer and/or polymeric material as disclosed herein may exhibit a relatively high tensile strength at yield. For instance, the tensile strength at yield may be 20 MPa or more, such as 25 MPa or more, such as 30 MPa or more, such as 35 MPa or more, such as 40 MPa or more, such as 45 MPa or more. The tensile strength at yield may be 200 MPa or less, such as 150 MPa or less, such as 100 MPa or less, such as 90 MPa or less, such as 80 MPa or less, such as 70 MPa or less, such as 60 MPa or less, such as 50 MPa or less, such as 45 MPa or less. the tensile strength at yield may be a number below, or within a range formed by any two numbers below, including the endpoints of such a range, in units expressed as MPa:

20, 30, 40, 50, 60, 70, 80, 90, 100, 110, 120, 130, 140, 150, 160, 170, 180, 190, and 200.

The aforementioned property may apply to the polymeric film structure, the barrier layer, and/or the polymeric material as disclosed herein.

### II.D. Elongation at Yield

In one embodiment, the polymeric film structures and/or barrier layer and/or polymeric material as disclosed herein may exhibit a certain percent elongation at yield. For instance, the percent elongation at yield may be 10% or less, such as 8% or less, such as 6% or less, such as 5% or less, such as 4% or less, such as 3% or less, such as 2.5% or less, such as 2% or less, such as 1.5% or less. The percent elongation at yield may be 0.01% or more, such as 0.05% or more, such as 0.1% or more, such as 0.3% or more, such as 0.5% or more, such as 0.8% or more, such as 1% or more, such as 1.3% or more, such as 1.5% or more, such as 1.8% or more, such as 2% or more, such as 2.2% or more, such as 2.4% or more. The percent elongation at yield may also be a number below, or within a range formed by any two numbers below, including the endpoints of such a range, in the % units: 0.01, 0.03, 0.05, 0.07, 0.09, 0.1, 0.3. 0.5, 0.7, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, and 10.0.

The aforementioned property may apply to the polymeric film structure, the barrier layer, and/or the polymeric material as disclosed herein.

### II.E. Flexural Properties

In addition to the tensile properties, the polymeric film structures and/or barrier layer and/or polymeric material as disclosed herein may also exhibit desired flexural properties. For instance, the flexural tangent modulus may be 500 MPa or more, such as 800 MPa or more, such as 1,000 MPa or more, such as 1,250 MPa or more, such as 1,500 MPa or more, such as 2,000 MPa or more, such as 2,250 MPa or more, such as 2,500 MPa or more, such as 2,750 MPa or more, such as 3,000 MPa or more, such as 3,250 MPa or more, such as 3,500 MPa or more, such as 4,000 MPa or more. The flexural tangent modulus may be 5,000 MPa or less, such as 4,500 MPa or less, such as 4,000 MPa or less, such as 3,750 MPa or less, such as 3,500 MPa or less, such as 3,000 MPa or less, such as 2,500 MPa or less, such as 2,000 MPa or less, such as 1,500 MPa or less, such as 1,000 MPa or less. The flexural tangent modulus may also be a number below, or within a range formed by any two numbers below, including the endpoints of such a range, in units expressed as MPa:

500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 900, 1950, 2000, 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450, 3500, 3550, 3600, 3650, 3700, 3750, 3800, 3850, 3900, 3950, 4000, 4050, 4100, 4150, 4200, 4250, 4300, 4350, 4400, 4450, 4500, 4550, 4600, 4650, 4700, 4750, 4800, 4850, 4900, 4950, and 5000.

The aforementioned property may apply to the polymeric film structure, the barrier layer, and/or the polymeric material as disclosed herein.

The polymeric film structures and/or barrier layer and/or polymeric material as disclosed herein may have a certain flexural secant modulus. The flexural secant modulus may be 500 MPa or more, such as 800 MPa or more, such as 1,000 MPa or more, such as 1,250 MPa or more, such as 1,500 MPa or more, such as 2,000 MPa or more, such as 2,250 MPa or more, such as 2,500 MPa or more, such as 2,750 MPa or more, such as 3,000 MPa or more, such as 3,250 MPa or more, such as 3,500 MPa or more, such as 4,000 MPa or more. The flexural secant modulus may be 5,000 MPa or less, such as 4,500 MPa or less, such as 4,000 MPa or less, such as 3,750 MPa or less, such as 3,500 MPa or less, such as 3,000 MPa or less, such as 2,500 MPa or less, such as 2,000 MPa or less, such as 1,500 MPa or less, such as 1,000 MPa or less. The flexural secant modulus may also be a number below, or within a range formed by any two numbers below, including the endpoints of such a range, in units expressed as MPa:

500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 900, 1950, 2000, 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450, 3500, 3550, 3600, 3650, 3700, 3750, 3800, 3850, 3900, 3950, 4000, 4050, 4100, 4150, 4200, 4250, 4300, 4350, 4400, 4450, 4500, 4550, 4600, 4650, 4700, 4750, 4800, 4850, 4900, 4950, and 5000.

The aforementioned property may apply to the polymeric film structure, the barrier layer, and/or the polymeric material as disclosed herein.

### IIF. Impact Strength

The polymeric film structures and/or barrier layer and/or polymeric material as disclosed herein may exhibit a certain impact strength. For instance, the Notched Izod For instance, the Notched Izod impact strength may be 0.1 J/m or more, such as 0.5 J/m or more, such as 1 J/m or more, such as 2 J/m or more, such as 5 J/m or more, such as 8 J/m or more, such as 10 J/m or more. The Notched Izod impact strength may also be 50 J/m or less, such as 40 J/m or less, such as 30 J/m or less, such as 25 J/m or less, such as 20 J/m or less, such as 18 J/m or less, such as 15 J/m or less, such as 13 J/m or less, such as 10 J/m or less. The impact strength at 23° C. may also be a number below, or within a range formed by any two numbers below, including the endpoints of such a range, in units expressed as J/m:

0.1, 0.2, 0.5, 0.7, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50.

In addition, the Gardner impact strength may be 0.01 J or more, such as 0.1 J or more, such as 0.2 J or more, such as 0.3 J or more, such as 0.5 J or more, such as 0.7 J or more, such as 0.8 J or more, such as 1 J or more. The Gardner impact strength at 23° C. may also be a number below, or within a range formed by any two numbers below, including the endpoints of such a range, in units expressed as J/m:

0.01, 0.03, 0.05, 0.07, 0.09, 0.1, 0.3. 0.5, 0.7, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, and 10.0.

The aforementioned property may apply to the polymeric film structure, the barrier layer, and/or the polymeric material as disclosed herein.

### IIG. Melt Flow Rate

The polymeric material as disclosed herein may have a certain melt flow rate. For instance, the melt flow rate may be 1 g/10 min or more, such as 2 g/10 min or more, such as 2.2 g/10 min or more, such as 2.5 g/10 min or more, such as 3 g/10 min or more, such as 3.5 g/10 min or more, such as 4 g/10 min or more, such as 4.5 g/10 min or more, such as 5 g/10 min or more, such as 10 g/10 min or more, such as 15 g/10 min or more, such as 20 g/10 min or more, such as 30 g/10 min or more. The melt flow rate may be 100 g/10 min or less, such as 80 g/10 min or less, such as 60 g/10 min or less, such as 50 g/10 min or less, such as 40 g/10 min or less, such as 30 g/10 min or less, such as 20 g/10 min or less, such as 15 g/10 min or less, such as 11 g/10 min or less, such as 10 g/10 min or less, such as 9 g/10 min or less, such as 8 g/10 min or less, such as 7.5 g/10 min or less, such as 7 g/10 min or less, such as 6.5 g/10 min or less, such as 6 g/10 min or less. The melt flow rate may be a number below, or within a range formed by any two numbers below, including the endpoints of such a range, in units expressed as g/10 min:

1, 1.2, 1.5, 2, 2.2, 2.5, 3, 3.2, 3.5, 4, 4.2, 4.5, 5, 5.5, 6, 6.5, 7, 7.5, 8, 8.5, 9, 9.5, 10, 15, 20, 25, 30, 35, 40, 45, 50, 55, 60, 65, 70, 75, 80, 85, 90, 95, and 100.

### II.H. Haze and Clarity

Also important for various applications are the optical properties, in particular the transparency and/or haze, of the polymeric film structure, the barrier layer, and/or the polymeric material. For instance, it may be desired to have a low haze. Even with certain additives and being relatively thicker, the percent haze may be 60 or less, such as 50 or less, such as 40 or less, such as 30 or less, such as 20 or less, such as 18 or less, such as 16 or less, such as 14 or less, such as 12 or less, such as 10 or less, such as 8 or less, such as 6 or less, such as 5 or less, such as 4 or less. The percent haze may be 0 or more, such as 1 or more, such as 2 or more, such as 3 or more, such as 4 or more, such as 5 or more, such as 10 or more, such as 25 or more. In addition, the percent clarity may be 90 or more, such as 95 or more, such as 96 or more, such as 97 or more, such as 98 or more, such as 99 or more.

Even with certain additives and being relatively thicker, the percent haze may be a number below, or within a range formed by any two numbers below, including the endpoints of such a range:

0, 1, 2, 3, 4, 5, 6, 7, 8, 9, 10, 11, 12, 13, 14, 15, 16, 17, 18, 19, 20, 21, 22, 2324, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, and 60.

In addition, the percent clarity may be a number below, or within a range formed by any two numbers below, including the endpoints of such a range:

90, 91, 92, 93, 94, 95, 96, 97, 98, 99, and 100.

The aforementioned properties may apply to the polymeric film structure, the barrier layer, and/or the polymeric material as disclosed herein. In addition, such property may be realized at a single thickness value or within a range of thicknesses as disclosed herein. For instance, the percent haze or clarity may be for the polymeric material when formed at a particular thickness (e.g., 25 mils and/or 50 mils). The percent haze and clarity may be determined in accordance with ASTM D1003.

### II.I. Transmission Properties

In addition to the desirable mechanical properties and optical properties, the polymeric film structures and/or barrier layer and/or polymeric material as disclosed herein may, also exhibit relatively low transmission properties. Such transmission properties may allow for the polymeric film structure and/or barrier layer and/or polymeric material to be utilized for various packaging applications. In this regard, the polymeric film structure and/or barrier layer and/or polymeric material may exhibit a relatively low water vapor transmission rate and/or oxygen transmission rate. For instance, the water vapor transmission rate may be 5 cm³/m²/day or less, such as 4 cm³/m²/day or less, such as 3 cm³/m²/day or less, such as 2 cm³/m²/day or less, such as 1 cm³/m²/day or less, such as 0.5 cm³/m²/day or less, such as 0.1 cm³/m²/day or less, such as 0.08 cm³/m²/day or less, such as 0.06 cm³/m²/day or less, such as 0.05 cm3/m2/day or less, such as 0.03 cm3/m2/day or less, such as 0.01 cm3/m2/day or less, such as 0.005 cm3/m2/day or less, such as 0.001 cm³/m²/day or less. The water vapor transmission rate may be more than 0 cm³/m²/day, such as 0.001 cm³/m²/day or more, such as 0.005 cm³/m²/day or more, such as 0.01 cm³/m²/day or more, such as 0.05 cm³/m²/day or more, such as 0.1 cm³/m²/day or more. The water vapor transmission rate may also be a number below, or within a range formed by any two numbers below, including the endpoints of such a range in the units cm³/m²/day:

0, 0.0005, 0.001, 0.005, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, and 5.

Also, the oxygen transmission rate may be 60 cm³/100 in²/day or less, such as 50 cm³/100 in²/day or less, such as 40 cm³/100 in²/day or less, such as 30 cm³/100 in²/day or less, such as 25 cm³/100 in²/day or less, such as 20 cm³/100 in²/day or less, such as 15 cm³/100 in²/day or less, such as 10 cm³/100 in²/day or less, such as 5 cm³/100 in²/day or less, such as 4 cm³/100 in²/day or less, such as 3 cm³/100 in²/day or less, such as 2.5 cm³/100 in²/day or less. The oxygen transmission rate may be more than 0 cm³/100 in²/day, such as 0.5 cm³/100 in²/day or more, such as 1 cm³/100 in²/day or more, such as 3 cm³/100 in²/day or more, such as 5 cm³/100 in²/day or more, such as 8 cm³/100 in²/day or more, such as 10 cm³/100 in²/day or more. The oxygen transmission rate may be for the polymeric material when formed at a particular thickness (e.g., 8 mils, 10 mils, and/or 18 mils). Also, the oxygen transmission rate may be a number below, or within a range formed by any two numbers below, including the endpoints of such a range in the units of cm³/100 in²/day:

0, 0.1, 0.2, 0.3, 0.4, 0.5, 1, 1.5, 2, 2.5, 3, 3.5, 4, 4.5, 5, 10, 15, 20, 25, 30, 35, 40, 45, 50, 55, and 60.

The oxygen transmission rate may be for the polymeric material when formed at a particular thickness (e.g., 8 mils, 10 mils, and/or 18 mils).

### II.J. Thickness of the Polymeric Film Structure

For instance, the polymeric film structure may have a thickness of more than 200 μm, such as 210 μm or more, such as 220 μm or more, such as 240 μm or more, such as 250 μm or more, such as 300 μm or more, such as 350 μm or more, such as 400 μm or more, such as 500 μm or more, such as 700 μm or more, such as 900 μm or more, such as 1 mm or more, such as 2 mm or more, such as 3 mm or more, such as 5 mm or more. The polymeric film structure may have a thickness of 1.25 cm or less, such as 1 cm or less, such as 8 mm or less, such as 5 mm or less, such as 3 mm or less, such as 2 mm or less, such as 1.5 mm or less, such as 1.3 mm or less, such as 1 mm or less, such as 900 μm or less, such as 800 μm or less, such as 700 μm or less, such as 600 μm or less, such as 500 μm or less, such as 400 μm or less, such as 350 μm or less, such as 300 μm or less, such as 280 μm or less, such as 270 μm or less.

Stated another way, the polymeric film structure thickness may be any number below, or within a range defined by any two numbers below, including the endpoints of such a range, in the μm units:

5, 10, 20, 30, 50, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1100, 1125, 1150, 1175, 1200, 1225, 1250, 1275, 1300, 1325, 1350, 1375, 1400, 1425, 1450, 1475, 1500, 1525, 1600, 1700, 1800, 1900, 2000, 2500, 3000, 3500, 4000, 4500, 5000, 6000, 7000, 8000, 9000, 10000, 11000, 12000 and 13000.

The aforementioned property may apply to the barrier layer. In addition, when the polymeric film structure is a monolayer polymeric film structure that simply includes the barrier layer as defined herein, the aforementioned thicknesses may also apply to the barrier layer.

In one embodiment, this invention also relates to laminated structures that are prepared from the above polymeric film structures. For example, in one embodiment, this invention relates to laminated structures that include the coextruded structures described herein comprising at least one polypropylene stack. Such laminations include extrusion lamination, and/or thermal lamination, and/or adhesion lamination (solvent and solventless). In other words, the polypropylene-stack is co-extruded, but the laminated structure that comprises the PP-stack may have some or all of the other layers (the non-PP-stack layers) co-extruded, and/or some or all of the other layers thermally laminated, and/or some or all of the other layers adhesion laminated (solvent and solventless), and/or all of the other layers prepared in a different manner such as printing, forming/shaping. A thicker laminate structure can be constructed from such lamination. The thickness of the laminated structure may be any number below, or within a range defined by any two numbers below, including the endpoints of such a range, in the μm units:

5, 10, 20, 30, 50, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1100, 1125, 1150, 1175, 1200, 1225, 1250, 1275, 1300, 1325, 1350, 1375, 1400, 1425, 1450, 1475, 1500, 1525, 1600, 1700, 1800, 1900, 2000, 2500, 3000, 3500, 4000, 4500, 5000, 6000, 7000, 8000, 9000, 10000, 11000, 12000 and 13000.

In one embodiment, such a laminated structure is a rigid sheet in the thickness range of 10 μm to 1525 μm (0.5 mil to 60 mil).

This invention also includes making polymeric film structures using other forming techniques, besides lamination, such as printing, forming, and shaping.

This invention also envisions polymeric film structures as disclosed above, wherein the film structure is flexible, semi-rigid, or rigid. As envisioned within the scope of this invention, the rigidity generally is correlated to thickness of the polymeric film structure, but not necessarily.

In one embodiment, in a layer comprising predominately polypropylene, other components in the layer include polyolefins, a hydrocarbon resin, and optionally, additives. The polypropylene, polyolefins, hydrocarbon, and other materials are described herein. The layers outside of the PP stack or stacks of the polymeric film structure herein comprise other materials described herein, and in the art. The other layers are not predominately PP.

### III. Materials for The Polymeric Film Structure

### III.A. Polypropylene

The generic material properties of PP are listed below:
Density
   0.88-0.93 g/cm³
Melt Index 0.30 to
10 g/10 min.
Brittleness Temperature <−20° C.
Maximum Continued Use Temperature 82° C. (180° F.)
Heat Deflection Temperature 115° C. (240° F.)

In this invention, polypropylene (PP), in a co-extruded layer in the PP-stack or otherwise in the film, is homopolymer polypropylene, homogeneous copolymer of polypropylene, heterogeneous copolymer of polypropylene, a blend of polypropylene copolymer and polypropylene homopolymer. The PP content is in the range of from about 40 to about 100 parts by weight of a polypropylene layer in the PP-stack or otherwise, in the rigid film. Stated differently, in a polypropylene layer, the PP content is any one of the following numbers by percent weight of the polypropylene layer: 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

The PP content can also be in a range defined by any two numbers above, including the end-points of the range.

In one embodiment, to prepare a high impact strength version of the film the grade of polypropylene or blend of polypropylene(s) used is such that the Izod impact strength of the PP is greater than 9 ft-lb_{f} per inch of notch according to American Society for Testing and Materials (ASTM) standard D256.

More preferably, a particularly suitable polypropylene may be a blown-film grade, high impact copolymer with an Izod impact strength (ASTM D 257, at 23° C.) of from 8 to 80 ft-lb_{f} per inch of notch, and melt flow index (ASTM D 1238, 2.16 kg, 23° C.) of from about 0.3 to about 5.5 dg/min (or g/10 min). The Izod impact strength range can also be defined by any two numbers from 8, 9, 10, . . . , 78, 79, and 80 ft-lb_{f} per inch of notch. Similarly, the melt-flow index range can also be defined by any two numbers from about 0.3, about 0.35, about 0.4, about 0.45, . . . , about 5.40, about 5.45, and about 5.50 dg/min. In a preferred embodiment, said at least one polypropylene has a melt-index in the range of from about 0.45 to about 0.75 dg/min.

Polypropylene used in the present invention is also polymerized using Zeigler-Natta, or single-site catalysts, or combinations of these catalysts.

Isotactic polypropylene homopolymer (“homo PP”) is a homogeneous polymer normally polymerized in a single stage reaction, with a single clean DSC melting peak in the region 160-165° C.

Homogeneous polypropylene also consists of a single phase, and has a single clean DSC melting peak, which occurs at a lower temperature than that of the homopolymer. The energy of melting of the homogeneous interpolymer is also somewhat lower than that of the homopolymer.

Heterogeneous polypropylene is formed in a two-stage reaction. In the first stage, a crystalline network of isotactic polypropylene homopolymer or homogeneous polypropylene is formed. In the second stage, a largely amorphous rubbery phase is formed within the crystalline network. A portion of the polymer formed in the second stage reaction is normally rich enough in comonomer, to be able to crystallize to form a third phase. When the comonomer is ethylene, the third phase normally has a DSC melting peak in the 120-125° C. region.

### IIIB. Modified PP Polypropylene

By MODIFIED polypropylene” (“Modified PP”) is meant a polypropylene described above that comprises no nucleating agents, or one or more nucleating agents. In one embodiment, the Modified PP with the following properties. It provides higher stiffness, improved barrier (O2 and H2O), and high clarity. Resin RB1 is also included in Modified PP.

TABLE 1
Modified PP-Example 1

| | | | ASTM Test |
|---|---|---|---|
| | Typical Value (SI) | | Method |
| Resin Properties | | | |
| Melt Flow Rate | 5.5 g/10 min | | D 1238 |
| Density | 0.90 | g/cm³ | D1505 |
| Melting Temperature Range | 160-165° | C. | D3418 |
| Mechanical Properties | | | |
| Tensile Yield Strength | 30.3 | MPa | D638 |
| Tensile Yield Elongation | 4.0% | | D638 |
| Flexural Modulus 1% Secant | 2960 | MPa | D790 |
| Flexural Modulus Tangent | 3050 | MPa | D790 |
| Deflection Temperature | 80° | C. | D648 |
| (66 psi (0.455 MPa) | | | |
| Rockwell Hardness | 110R (English units) | | |
| Notched Izod @ 23° C. | 14 | J/m | D256 |

| | | |
|---|---|---|
| ASTM Haze 0.050″ | 40.3% | D1003 |
| ASTM Haze 0.025″ | 19.9% | D1003 |

TABLE 2
Modified PP Example 2

| | | | ASTM Test |
|---|---|---|---|
| | Typical Value (SI) | | Method |
| Resin Properties | | | |
| Melt Flow Rate | 4.5 g/10 min | | D 1238 |
| Density | 0.90 | g/cm³ | D1505 |
| Melting Temperature Range | 145-150° | C. | D3418 |
| Mechanical Properties | | | |
| Tensile Yield Strength | 32.7 | MPa | D638 |
| Tensile Yield Elongation | 3.5% | | D638 |
| Flexural Modulus 1% Secant | 1570 | MPa | D790 |
| Flexural Modulus Tangent | 1690 | MPa | D790 |
| Deflection Temperature (66 | 52° | C. | D648 |
| psi (0.455 MPa) | | | |
| Rockwell Hardness | 110R (English units) | | |
| Notched Izod @ 23° C. | 18 | J/m | D256 |

| | | |
|---|---|---|
| ASTM Haze 0.050″ | 425% | D1003 |
| ASTM Haze 0.025″ | 8% | D1003 |

In another embodiment, Modified PP comprises nucleating agents. Nucleating agents are described below.

There are two types of nucleating agents (beta and alpha—see below) commercially used and available in the industry and designed to manipulate physical, mechanical, thermal, and optical properties. This study identifies a commercial grade nucleating agent which when incorporated into commercially available grades of PP (see below and also described elsewhere in the document) increases the stiffness, reduces the shrinkage rate post processing, and enhances oxygen barrier of the extruded sheet/structure.
Commercial Polypropylene grades—for trial and testing purposes:
Nucleated—Braskem—6025N, 6022N, Exxon—6282NE2, 6272NE1, Ineos—H02C-00, etc.
Non nucleated—Braskem—6025, Total—3270, Exxon—PP4792E1, LBI-HA802H

### IIIC. Beta Nucleation-Increase Stiffness, Cycle Time, and Opacity with Reduced Material Usage

MPM 2000, Mayzo Beta nucleating agent—During extrusion, Alpha nucleating agents generally increase the flexural modulus of the total sheet and the thermoformed container. Whereas Beta nucleating agents increase the total structural rigidity for the thermoformed container, but it does not show up an enhanced flexural modulus in the sheet. During forming, the processing window of polypropylene will also be broadened dramatically, and cycle rates can be increased by 25%. Material distribution in the final part is also improved leading to potential down-weighting of thermoformed food containers by 15%.
Processing/Cold forming—If the Beta nucleated PP sheet is processed below its melting point, then beta spherulites will recrystallize and the final formed parts will be much whiter than the starting sheet. This processing method will not only increase the cycle time from lower heat transfer but will also reduce the amount of white color/TiO₂ pigment and thus will reduce the cost of material and even the total density.
Processing/Hot forming—Processing at or after the Beta nucleating agent is melted will result in a part that is translucent but not white but would not have any micro voiding effects or no voids. The advantage of hot processing is a uniform wall thickness with much faster cycle time—20-25% improvement.

### IIID. Alpha Nucleation-Increase Clarity and Stiffness

Most of the commercial nucleating agents in the market are Alpha nucleating agents such as sorbitol, Nonitols, Phosphate esters, etc. from companies like Milliken (chemical.milliken.com; e.g.: Hyperform® HPN®-909ei), Amfine, BASF, etc. We evaluate some nucleating agents from Amfine like NA-11, NA 27, NA 902, etc., which have a balance of stiffness and impact strength without increasing density, increase the crystallization of polypropylene for improved processing, cycle time reduction, and enhanced productivity and increasing optical properties of polypropylene. For high clarity PP parts using Alpha nucleating/clarifying agents, and increased thermoforming heat increases part haze.

### III.E. Additives to Increase Stiffness, Reduce Shrinkage, and Increase Cycle Time

UC CycleTime Technology—This is an additive designed by Uniform Color/Washington Penn Plastics to increase the dimensional stability and increase the mechanical properties of PP. Initial trials and subsequent tensile test, and orientation test results reveal that 10-15% UCC is a good starting point to replicate the material properties of PS for FFS process applications.
Lyondell-Basell CPS—CPS 696 is a commercial additive masterbatch for PP to improve their stiffness and barrier properties. It also improves processability, shrinkage, gloss, and haze.
Lyondell-Basell APEX resin—The APEX compound creates micro layering that can replace EVOH. It can benefit recyclability and based on the initial data from the Mocon, also enhance barrier protection without the need of an EVOH layer. Also, we use the nucleated resin, alpha and beta, in retort and aseptic applications. We optimize the crystallinity of the PP on both sides of the APEX resin to impact the performance of the barrier that are normally negatively impacted by EVOH's susceptibility to moisture. We can reduce the thickness of the APEX material layer vs traditional EVOH to improve performance and lower cost.

In some embodiments of the invention, the PP described herein comprise Hyperform® HPN®-909ei nucleating agent to form the MODIFIED PP, as described herein.

### IIIF. Polyolefin

The polymeric film structure of the present invention may include one or more layers comprising at least one polyolefin. Even the PP stack layer—that comprises predominately polypropylene—may further comprise at least one other polyolefin.

The polyolefin polymer may be one formed from an olefin monomer, such as an α-olefin monomer. In this regard, the monomer may be ethylene such that the polyolefin polymer includes an ethylene polymer. In addition, the monomer may be propylene such that the polyolefin polymer includes a propylene polymer. In one particular embodiment, the polyolefin polymer comprises a propylene polymer.

In general, the polyolefin polymer may be a homopolymer or a copolymer. In one embodiment, the polyolefin polymer comprises a homopolymer. For example, when the polyolefin polymer comprises a propylene polymer, such polymer may be a propylene homopolymer. In another embodiment, the polyolefin polymer comprises a copolymer. For example, when the polyolefin polymer comprises a propylene polymer, such polymer may be a propylene copolymer. Accordingly, in one embodiment, the propylene polymer may be a propylene homopolymer. In another embodiment, the propylene polymer may be a propylene copolymer. In particular, the propylene copolymer may be a propylene elastomer.

Similarly, when the polyolefin polymer comprises a homopolymer and the polyolefin polymer comprises an ethylene polymer, such polymer may be an ethylene homopolymer. In another embodiment, when the polyolefin polymer comprises a copolymer and the polyolefin polymer comprises an ethylene polymer, such polymer may be an ethylene copolymer. Accordingly, in one embodiment, the ethylene polymer may be an ethylene homopolymer. In another embodiment, the ethylene polymer may be an ethylene copolymer. In particular, the ethylene copolymer may be an ethylene elastomer.

When present as a copolymer, the copolymer may include at least one comonomer including at least one α-olefin (i.e., one other than ethylene if an ethylene copolymer or propylene if a propylene copolymer). In this regard, the comonomer may include ethylene (if a propylene copolymer), propylene (if an ethylene copolymer), a C₄-C₂₀ α-olefin, or a combination thereof. For example, when the comonomer includes a C₄-C₂₀ α-olefin, the comonomer may in a particular embodiment be a C₄-C₁₂ α-olefin, such as a C₄-C₁₀ α-olefin, such as a C₄-C₈ α-olefin. Regardless, specific examples of α-olefins include, but are not limited to, ethylene, butene (e.g., 1-butene, 3-methyl-1-butene, 3,3-dimethyl-1-butene), pentene (e.g., 4-methyl-1-pentene, 3-methyl-1-pentene), hexene (e.g., 1-hexene, 3,5,5-trimethyl-1-hexene), heptene, octene (e.g., 1-octene, 2-octene), nonene (e.g., 5-methyl-1-nonene), decene, dodecene, and styrene.

In a particular embodiment, the comonomer may include at least one of ethylene (if a propylene copolymer), propylene (if an ethylene copolymer), 1-butene, 1-hexene, or 1-octene. For instance, in one embodiment, the comonomer may include at least ethylene (if a propylene copolymer) or propylene (if an ethylene copolymer). In another embodiment, the comonomers may include at least ethylene and at least one of 1-butene, 1-hexene, or 1-octene.

In addition, it should be understood that suitable α-olefins may be linear or branched (e.g., one or more C₁-C₃ alkyl branches or an aryl group). For example, in one embodiment, the α-olefin may be linear.

In another embodiment, the α-olefin may be branched. In this regard, the α-olefin may be substituted, such as with one or more methyl, dimethyl, trimethyl, ethyl or propyl substituents. However, it should be understood that the α-olefin may also be unsubstituted.

In addition to the above mentioned α-olefin comonomers, the copolymer may optionally include other comonomers. For instance, these comonomers may include aromatic group containing comonomers, non-aromatic cyclic group containing comonomers, and/or diolefin comonomers. For example, these comonomers may contain 4 or more, such as 5 or more, such as 8 or more, such as 10 or more, such as 15 or more carbon atoms to 30 or less, such as 25 or less, such as 20 or less, such as 15 or less, such as 10 or less carbon atoms.

In one embodiment, the comonomer may include a diene. The diene may be a straight chain acyclic olefin, a branched chain acyclic olefin, a single ring alicyclic olefin, a multi-ring alicyclic fused or bridged ring olefin, a cycloalkenyl-substituted alkene, or a mixture thereof. The diene, may include, but is not limited to, butadiene, pentadiene, hexadiene (e.g., 1,4-hexadiene, 5-methyl-1,4-hexadiene, 1,4-cyclohexadiene), heptadiene (e.g., 1,6-heptadiene), octadiene (e.g., 1,6-octadiene, 1,7-octadiene, 3,7-dimethyl-1,6-octadiene, 3,7-dimethyl-1,7-octadiene, 1,5-cyclooctadiene), nonadiene (e.g., 1,8-nonadiene), decadiene (e.g., 1,9-decadiene), undecadiene (e.g., 1,10-undecadiene), dodecadiene (e.g., 1,11-dodecadiene, 1,7-cyclododecadiene), tridecadiene (e.g., 1,12-tridecadiene), tetradecadiene (e.g., 1,13-tetradecadiene), pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, tetrahydroindene, norbornadiene, methyl-tetrahydroindene, dicyclopentadiene, bicyclo-(2.2.1)-hepta-2,5-diene, alkenyl norbornenes, alkylidene norbornenes (e.g., ethylidiene norbornene), cycloalkenyl norbornenes, cycloalkylene norbornenes (e.g., 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene), vinyl cyclohexene, allyl cyclohexene, vinyl cyclooctene, 4-vinyl cyclohexene, allyl cyclodecene, vinyl cyclododecene, and tetracyclo (A11,12)-5,8-dodecene.

The diene may also include a polybutadiene, such as a low molecular weight butadiene. For example, the polybutadiene may have a weight average molecular weight of about 2,000 g/mol or less, such as about 1,500 g/mol or less, such as about 1,000 g/mol or less. The diene may include a cyclic diene, such as cyclopentadiene, vinyl norbornene, norbornadiene, ethylidene norbornene, divinylbenzene, dicyclopentadiene or higher ring containing diolefins with or without substituents at various ring positions.

Regardless of the type of comonomer(s) utilized, the primary monomer (i.e., ethylene or propylene) may constitute about 50 mole % or more, such as about 60 mole % or more, such as about 65 mole % or more, such as about 70 mole % or more, such as about 75 mole % or more, such as about 80 mole % or more, such as about 85 mole % or more, such as about 90 mole % or more, such as about 93 mole % or more of the copolymer. The primary monomer (i.e., ethylene or propylene) may constitute less than 100 mole %, such as about 99.5 mole % or less, such as about 99 mole % or less, such as about 98 mole % or less, such as about 97 mole % or less, such as about 95 mole % or less of the copolymer. Accordingly, the primary monomer (i.e., ethylene or propylene) may constitute about 50 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 93 wt. % or more of the copolymer. The primary monomer (i.e., ethylene or propylene) may constitute less than 100 wt. %, such as about 99.5 wt. % or less, such as about 99 wt. % or less, such as about 98 wt. % or less, such as about 97 wt. % or less, such as about 95 wt. % or less of the copolymer.

Likewise, the comonomers, such as the α-olefin, may constitute about 0.1 mole % or more, such as about 0.3 mole % or more, such as about 0.5 mole % or more, such as about 1 mole % or more, such as about 2 mole % or more, such as about 3 mole % or more, such as about 5 mole % or more of the copolymer. The comonomers may constitute less than 50 mole %, such as about 40 mole % or less, such as about 35 mole % or less, such as about 30 mole % or less, such as about 20 mole % or less, such as about 15 mole % or less, such as about 10 mole % or less, such as about 7 mole % or less of the copolymer. Accordingly, the comonomers may constitute about 0.1 wt. % or more, such as about 0.3 wt. % or more, such as about 0.5 wt. % or more, such as about 1 wt. % or more, such as about 2 wt. % or more, such as about 3 wt. % or more, such as about 5 wt. % or more of the copolymer. The comonomers may constitute less than 50 wt. %, such as about 40 wt. % or less, such as about 30 wt. % or less, such as about 25 wt. % or less, such as about 20 wt. % or less, such as about 15 wt. % or less, such as about 10 wt. % or less, such as about 8 wt. % or less, such as about 7 wt. % or less of the copolymer. It should be understood that the aforementioned percentages may apply to all of the comonomers in combination or a single type of comonomer utilized in the copolymer.

In embodiments where a third comonomer (e.g., one not including ethylene) is present, such third comonomer may be present in an amount of about 10 wt. % or less, such as about 5 wt. % or less, such as about 4 wt. % or less, such as about 3 wt. % or less, such as about 2 wt. % or less based on the weight of the copolymer.

In one particular embodiment, the polyolefin polymer may be a polyolefin copolymer elastomer. For instance, the propylene copolymer may be a propylene copolymer elastomer. As generally understood in the art, the elastomer may satisfy the properties of ASTM D1566-19. In one embodiment, the elastomer may include ethylene and at least one comonomer of propylene, butene, hexene, and octene. In another embodiment, the elastomer may include propylene and at least one comonomer of ethylene, butene, hexene, and octene. In one particular embodiment, the elastomer includes propylene and ethylene. For instance, the elastomer may not include any further comonomers. However, in one embodiment, the elastomer may comprise propylene, ethylene, and at least one of butene, hexene, and octene. For instance, the elastomer may include propylene-ethylene-butene, propylene-ethylene-hexene, propylene-ethylene-octene, or a mixture thereof. In this regard, in one embodiment, the elastomer may include propylene-ethylene-butene. In another embodiment, the elastomer may include propylene-ethylene-hexene. In a further embodiment, the elastomer may include propylene-ethylene-octene.

In general, the polyolefin copolymer may have any monomer arrangement. For instance, the polyolefin copolymer may be a random copolymer. Alternatively, in another embodiment, the polyolefin copolymer may be a block copolymer. In a further embodiment, the polyolefin copolymer may be a heterophasic copolymer.

The polyolefin polymer may have a certain molecular structure that may allow for it to be utilized for a specification application. In this regard, the polyolefin polymer may have a certain degree of tacticity. For instance, in one embodiment, the polyolefin polymer may be an isotactic polyolefin polymer. In particular, the polyolefin homopolymer may be an isotactic polyolefin homopolymer. In this regard, the polyolefin polymer may have at least 50%, such as at least 60%, such as at least 70%, such as at least 80%, such as at least 85%, such as at least 90% isotacticity as determined according to analysis by .sup.13C-NMR.

However, it should be understood that the polyolefin polymer may alternatively have an atactic or syndiotactic molecular structure. For instance, in one embodiment, the polyolefin polymer may be an atactic polyolefin polymer. In another embodiment, the polyolefin polymer may be a syndiotactic polyolefin polymer. For example, the polyolefin polymer may have at least 50%, such as at least 60%, such as at least 70%, such as at least 80%, such as at least 85%, such as at least 90% syndiotacticity as determined according to analysis by .sup.13C-NMR.

In general, a polyolefin homopolymer may have a greater isotacticity or syndiotacticity and a generally lower atacticity. For example, a syndiotactic polyolefin homopolymer may have a syndiotacticity of at least 80%, such as at least 85%, such as at least 90%. Similarly, an isotactic polyolefin homopolymer may have an isotacticity of at least 80%, such as at least 85%, such as at least 90%. Accordingly, such polyolefin homopolymer may have an atacticity of less than 20%, such as less than 15%, such as less than 10%, such as less than 5%.

In this regard, the polyolefin polymer may have a certain crystallinity. For instance, the crystallinity may be at least about 1%, such as at least about 2%, such as at least about 5%, such as at least about 10%, such as at least about 15%, such as at least about 20%, such as at least about 25%, such as at least about 30%, such as at least about 40%, such as at least about 50%, such as at least about 60%, such as at least about 70%, such as at least about 80%, such as at least about 90%, such as at least about 95%, such as at least about 98%, such as at least about 99%. The crystallinity is generally less than 100%. For instance, the crystallinity may be less than 100%, such as about 99% or less, such as about 98% or less, such as about 95% or less, such as about 90% or less, such as about 80% or less, such as about 70% or less, such as about 60% or less, such as about 50% or less, such as about 40% or less, such as about 30% or less, such as about 20% or less. For instance, a polyolefin homopolymer may generally have a higher crystallinity than a polyolefin copolymer elastomer.

The crystallinity may be determined based on a xylene soluble content. For example, a higher crystallinity will result in a lower xylene soluble content. In this regard, the xylene soluble weight percentage may be 50% or less, such as 40% or less, such as 30% or less, such as 20% or less, such as 15% or less, such as 10% or less, such as 5% or less, such as 4% or less, such as 3% or less, such as 2% or less, such as 10% or less. Without intending to be limited, the xylene soluble content provides a measure of the amorphous portion of the polyolefin polymer. The xylene soluble content can be determined in accordance with ASTM D5492-17.

In general, the crystallinity of the polyolefin polymer can have an impact on the melting temperature as well as the crystallization temperature of the polymer. In this regard, the melting temperature and the crystallization temperature of the polyolefin polymer may be relatively low. For instance, the melting temperature may be about 70° C. or more, such as about 85° C. or more, such as about 100° C. or more, such as about 110° C. or more, such as about 120° C. or more, such as about 130° C. or more, such as about 140° C. or more, such as about 150° C. or more, such as about 160° C. or more, such as about 165° C. or more. The melting temperature may be about 170° C. or less, such as about 160° C. or less, such as about 150° C. or less, such as about 125° C. or less, such as about 115° C. or less, such as about 100° C. or less. For instance, a polyolefin homopolymer may generally have a higher melting temperature than a polyolefin copolymer elastomer.

The crystallization temperature of the polyolefin polymer may be about 70° C. or more, such as about 80° C. or more, such as about 90° C. or more, such as about 95° C. or more, such as about 100° C. or more, such as about 105° C. or more, such as about 110° C. or more, such as about 115° C. or more, such as about 120° C. or more, such as about 125° C. or more. The crystallization temperature may be about 140° C. or less, such as about 130° C. or less, such as about 120° C. or less, such as about 110° C. or less, such as about 100° C. or less.

The glass transition temperature of the polyolefin polymer may be about 125° C. or less, such as about 115° C. or less, such as about 105° C. or less, such as about 100° C. or less, such as about 90° C. or less, such as about 80° C. or less, such as about 70° C. or less, such as about 50° C. or less, such as about 40° C. or less, such as about 30° C. or less, such as about 20° C. or less, such as about 10° C. or less, such as about 0° C. or less. The glass transition temperature may be about −50° C. or more, such as about −40° C. or more, such as about −30° C. or more, such as about −20° C. or more, such as about −10° C. or more, such as about 0° C. or more, such as about 20° C. or more, such as about 40° C. or more, such as about 50° C. or more.

The polyolefin polymer may also have certain properties that may allow for it to be utilized for a specific application. In this regard, the polyolefin polymer may have a particular weight average molecular weight (Mw). For instance, the Mw may be about 2,500 g/mol or more, such as about 5,000 g/mol or more, such as about 8,000 g/mol or more, such as about 10,000 g/mol or more, such as about 12,000 g/mol or more, such as about 20,000 g/mol or more, such as about 25,000 g/mol or more, such as about 50,000 g/mol or more, such as about 80,000 g/mol or more, such as about 90,000 g/mol or more, such as about 100,000 g/mol or more, such as about 200,000 g/mol or more, such as about 300,000 g/mol or more. The Mw may be about 1,000,000 g/mol or less, such as about 800,000 g/mol or less, such as about 600,000 g/mol or less, such as about 500,000 g/mol or less, such as about 400,000 g/mol or less, such as about 300,000 g/mol or less, such as about 250,000 g/mol or less, such as about 200,000 g/mol or less, such as about 150,000 g/mol or less, such as about 100,000 g/mol or less, such as about 50,000 g/mol or less. The Mw may be determined using techniques known in the art, such as gel permeation chromatography.

Similarly, the polyolefin polymer may also have a particular number average molecular weight (Mn). For instance, the Mn may be about 2,500 g/mol or more, such as about 5,000 g/mol or more, such as about 8,000 g/mol or more, such as about 10,000 g/mol or more, such as about 12,000 g/mol or more, such as about 20,000 g/mol or more, such as about 25,000 g/mol or more, such as about 50,000 g/mol or more, such as about 80,000 g/mol or more, such as about 90,000 g/mol or more, such as about 100,000 g/mol or more, such as about 200,000 g/mol or more, such as about 300,000 g/mol or more. The Mn may be about 1,000,000 g/mol or less, such as about 800,000 g/mol or less, such as about 600,000 g/mol or less, such as about 500,000 g/mol or less, such as about 400,000 g/mol or less, such as about 300,000 g/mol or less, such as about 250,000 g/mol or less, such as about 200,000 g/mol or less, such as about 150,000 g/mol or less, such as about 100,000 g/mol or less, such as about 50,000 g/mol or less. The Mn may be determined using techniques known in the art, such as gel permeation chromatography.

In this regard, the polyolefin polymer may have a particular polydispersity index (Mw/Mn). For instance, the polydispersity index may be more than 1, such as about 2 or more, such as about 2.3 or more, such as about 2.5 or more, such as about 3 or more, such as about 3.5 or more, such as about 4 or more. The polydispersity index may be about 9 or less, such as about 8 or less, such as about 7 or less, such as about 5 or less, such as about 4.5 or less, such as about 4 or less, such as about 3.5 or less, such as about 3 or less, such as about 2.5 or less.

The polyolefin polymer may have a particular specific gravity. For instance, the specific gravity may be about 0.8 g/cm³ or more, such as about 0.83 g/cm³ or more, such as about 0.85 g/cm³ or more, such as about 0.86 g/cm³ or more, such as about 0.87 g/cm³ or more, such as about 0.88 g/cm³ or more, such as about 0.9 g/cm³ or more. The specific gravity may be less than 1 g/cm³, such as about 0.95 g/cm³ or less, such as about 0.93 g/cm³ or less, such as about 0.92 g/cm³ or less, such as about 0.91 g/cm³ or less, such as about 0.9 g/cm³ or less, such as about 0.89 g/cm³ or less, such as about 0.88 g/cm³ or less. The specific gravity may be determined according to ASTM D792-20.

The polyolefin polymer may have a particular melt flow rate. For instance, the melt flow rate may be about 0.1 g/10 min or more, such as about 0.2 g/10 min or more, such as about 0.3 g/10 min or more, such as about 0.4 g/10 or more, such as about 0.5 g/10 min or more, such as about 1 g/10 min or more, such as about 1.5 g/10 min or more, such as about 2 g/10 min or more, such as about 5 g/10 min or more, such as about 10 g/10 min or more, such as about 20 g/10 min or more, such as about 25 g/10 min or more. The melt flow rate may be about 500 g/10 min or less, such as about 200 g/10 min or less, such as about 100 g/10 min or less, such as about 50 g/10 min or less, such as about 40 g/10 min or less, such as about 20 g/10 min or less, such as about 10 g/10 min or less, such as about 5 g/10 min or less, such as about 4 g/10 min or less, such as about 3 g/10 min or less, such as about 2 g/10 min or less, such as about 1.5 g/10 min or less, such as about 1 g/10 min or less, such as about 0.8 g/10 min or less, such as about 0.6 g/10 min or less, such as about 0.5 g/10 min or less, such as about 0.45 g/10 min or less, such as about 0.4 g/10 min or less, such as about 0.35 g/10 min or less, such as about 0.3 g/10 min or less. The melt flow rate may be determined according to ASTM D1238-13 when subjected to a load of 2.16 kg in 10 minutes at a temperature of 230° C.

The polyolefin polymer may also have a particular heat of fusion. For instance, the heat of fusion may be about 40 J/g or more, such as about 50 J/g or more, such as about 60 J/g or more, such as about 70 J/g or more, such as about 75 J/g or more, such as about 80 J/g or more, such as about 90 J/g or more, such as about 100 J/g or more, such as about 125 J/g or more, such as about 150 J/g or more, such as about 200 J/g or more. The heat of fusion may be about 300 J/g or less, such as about 250 J/g or less, such as about 200 J/g or less, such as about 150 J/g or less, such as about 125 J/g or less, such as about 100 J/g or less, such as about 80 J/g or less, such as about 75 J/g or less, such as about 70 J/g or less, such as about 65 J/g or less, such as about 60 J/g or less, such as about 50 J/g or less. For instance, a polyolefin homopolymer may have a relatively higher heat of fusion while a polyolefin copolymer elastomer may have a relatively lower heat of fusion.

The polyolefin polymer may also have a particular crystallinity. For instance, the crystallinity may be 50% or more, such as 60% or more, such as 70% or more, such as 80% or more, such as 90% or more. In general, the percentage is used to define the weight of crystallized area per polymer total weight and can be determined using means in the art, such as a differential scanning calorimeter, an x-ray diffractometer (XRD), etc. In addition, the polyolefin polymer may have an isotacticity of 95% or more, such as 96% or more, such as 97% or more. Further, the polyolefin polymer may have an atactic fraction of 5% or less, such as 4% or less, such as 3% or less.

The polyolefin polymer may also have a particular flexural modulus. For instance, the flexural modulus in the machine direction may be about 50 MPa or more, such as about 100 MPa or more, such as about 200 MPa or more, such as about 300 MPa or more, such as about 400 MPa or more, such as about 500 MPa or more, such as about 1,000 MPa or more, such as about 1,300 MPa or more, such as about 1,500 MPa or more, such as about 2,000 MPa or more. The flexural modulus in the machine direction may be about 4,000 MPa or less, such as about 3,000 MPa or less, such as about 2,500 MPa or less, such as about 2,300 MPa or less, such as about 2,100 MPa or less, such as about 2,000 MPa or less, such as about 1,900 MPa or less, such as about 1,800 MPa or less, such as about 1,500 MPa or less, such as about 1,300 MPa or less, such as about 1,000 MPa or less, such as about 800 MPa or less. The flexural modulus may be determined according to ASTM D790-17 and 1.3 mm/min.

The polyolefin polymer may also have a particular deflection temperature under load (DTUL). For instance, the DTUL may be about 40° C. or more, such as about 45° C. or more, such as about 50° C. or more, such as about 60° C. or more, such as about 70° C. or more, such as about 80° C. or more. The DTUL may be about 130° C. or less, such as about 120° C. or less, such as about 110° C. or less, such as about 100° C. or less, such as about 90° C. or less, such as about 80° C. or less, such as about 75° C. or less. The DTUL may be determined according to ASTM D648-18 at 66 psi.

The polyolefin polymer may also have a particular elongation at break. For instance, the elongation at break may be about 1,000% or less, such as about 800% or less, such as about 600% or less, such as about 500% or less, such as about 400% or less, such as about 300% or less, such as about 250% or less, such as about 200% or less, such as about 150% or less, such as about 100% or less, such as about 50% or less. The elongation at break may be about 0.5% or more, such as about 1% or more, such as about 2% or more, such as about 5% or more, such as about 10% or more, such as about 25% or more, such as about 50% or more, such as about 100% or more, such as about 250% or more, such as about 500% or more, such as about 750% or more. For instance, the elongation at break may be relatively higher for a polyolefin copolymer, such as a polyolefin copolymer elastomer, than a polyolefin homopolymer. The elongation at break may be determined according to ASTM D638-14.

Furthermore, it should be understood that polyolefin polymers as disclosed herein can be synthesized using any technique generally known in the art. For instance, the polymer can be synthesized using any known process utilizing catalysts, activators, reagents as generally known in the art. In this regard, the method for making or polymerizing the polyolefin polymer is not limited by the present invention.

### III.G. Polyethylene

The rigid co-extruded polymeric film of the present invention may include one or more layers comprising polyethylene (PE) or an interpolymer of polyethylene. Any polyethylene or its interpolymer suitable for the rigid co-extrusion film may be used. For example, the PE polymeric material can be MDPE, HDPE, LLDPE, LDPE or blends thereof.

In one embodiment, the polyethylene comprising layer can comprise about 10-100% by weight of the preferred ethylene/α-olefin interpolymer and can contain up to 90% by weight of a polymer of ultralow density polyethylene (ULDPE), which is an ethylene/octene-1 copolymer having a density in the range of about 0.910 to 0.914 g/cm³ and a melt index of about 0.7 to 1.0 dg/min, or a linear low density polyethylene (LLDPE), which is ethylene/octene-1 copolymer, having a density in the range of about 0.917 to 0.925 g/cm³ and a melt index of about 0.7 to 1.0 dg/min.

In one embodiment, the polyethylene layer comprises about 75-90% by weight of an ultra-low-density polyethylene (ULDPE), having a density in the range of about 0.911 to 0.913 g/cm³ and a melt index of about 0.8 to 0.9 dg/min; and 10-25% by weight of a linear, low-density polyethylene (LLDPE), which is an ethylene/octene-1 copolymer, having a density in the range of about 0.918 to 0.922 g/cm³ and a melt index of about 0.8 to 0.9 dg/min.

In another embodiment, the PE layer comprises an ethylene-α-olefin copolymer. The ethylene-α-olefin copolymer is in the range of from about 0 to about 15 parts by weight of said PE layer. The copolymer is an ultra-low-density copolymer of ethylene and an at least one C4-C10 α-olefin manufactured in a polymerization process using a single-site polymerization catalyst, with a density in the range of from about 0.859 to about 0.905 g/cm3 and a melt-index in the range of from about 0.4 to about 1.1 dg/min. The density can be defined by any number below, or as a range defined by any two numbers including the endpoints of the range from about 0.859, about 0.860, about 0.861, . . . , about 0.903, about 0.904, and about 0.905 g/cm3. Similarly, the melt-index can be defined by any number below, or as a range defined by any two numbers including the endpoints of the range from about 0.4, about 0.45, about 0.5, . . . , about 0.95, about to, about 1.05 and about 1.1 dg/min.

In another embodiment, the ethylene—α-olefin copolymer is in the range of from about 0 parts to 15 parts by weight, and can be manufactured in a polymerization process using either a single-site or Zeigler-Natta polymerization catalyst, wherein said copolymer has a density in the range of from about 0.909 to about 0.935 g/cm3 and a melt-index in the range of from about 0.5 to about 1.5 dg/min. In other embodiments, the weight percent of the ethylene—α-olefin copolymer can be defined by any number below, or as a range defined by any two numbers including the endpoints of the range from about 0.0, 0.5, about 1.0, about 1.5, about 2.0, about 2.5, about 3.0, about 3.5, about 4.0. about 4.5, about 5.0, about 5.5, about 6.0, about 6.5, about 7.0, about 7.5, about 8.0, about 8.5, about 9.0, about 9.5, about 10.0, about 10.5, about 11.0, about 11.5, about 12.0, about 12.5, about 13.0, about 13.5, about 14.0, about 14.5 and about 15.0 parts by weight. The density can be defined by any number below, or as a range defined by any two numbers including the endpoints of the range from about 0.909, about 0.910, about 0.911, . . . , about 0.933, about 0.934, and about 0.935 g/cm3. Similarly, the melt-index range can be defined by any two numbers from about 0.5, about 0.55, about 0.60, . . . , about 1.40, about 1.45, and about 1.50-dg/min.

In another embodiment, the foregoing low-density copolymer of ethylene and at least one C4-C10 α-olefin, or said at least one ultra-low-density copolymer of ethylene and at least one C₄-C₁₀ α-olefin is selected from ethylene/butene-1 copolymers, ethylene/hexene-1 copolymers, ethylene/octene-1 copolymers, ethylene/octene-1/butene-1 terpolymers and ethylene/hexene-1/butene-1 terpolymers.

In one embodiment, the polyethylene is a polymer or a polymer blend comprising from 0-100% by weight or preferably about 30-70%, or more preferably 30-50% by weight of a linear, low-density polyethylene (LLDPE) of ethylene/octene-1 copolymer having a density of about 0.910 to 0.920 g/cm³ and melt index of about 0.8 to 1.2 dg/min; and from 0-100% by weight of a linear, low density polyethylene (LLDPE) such as ethylene/butene-1 copolymer, or low density ethylene/hexene-1 copolymer, having a density of about 0.918 to 0.930 g/cm³, and a melt index of about 0.8 to 1.2 dg/min, or preferably of 70-30% by weight of, or more preferably 50-70% by weight said copolymers.

The C₄-C₁₀ α-olefin also includes the cyclic counterparts.

### III.H. Hydrocarbon Resin

The polymeric film structure as disclosed herein comprises a 2-layer PP stack or a 3-layer stack, of which one of the layers, which is not predominately polypropylene, but is a barrier layer that comprises predominately polypropylene and a hydrocarbon resin.

In general, these hydrocarbon resins include those resins made from petroleum-based feedstocks. For example, these resins may be synthesized from fractionation by-products of petroleum cracking. In particular, these hydrocarbon resins may generally include those resins produced by the hydrogenation of the resinous polymerization products obtained by the polymerization of mixed unsaturated monomers derived from the deep cracking of petroleum, as well as higher polymers obtained by polymerization and/or copolymerization of terpene hydrocarbons, which may be followed by hydrogenation under pressure.

The hydrocarbon resins may include, but are not limited to, aliphatic hydrocarbon resins, aromatic hydrocarbon resins, aliphatic/aromatic hydrocarbon resins, or a mixture thereof. For example, an aliphatic/aromatic hydrocarbon resin may be a partially hydrogenated aromatic hydrocarbon resin. Further, regarding the aliphatic hydrocarbon resins, they may be cycloaliphatic hydrocarbon resins. The hydrocarbon resin may in addition to the above or alternatively polyterpene resins, terpene-phenol resins, rosin esters, rosin acids, grafted resins, and mixtures thereof.

In one embodiment, the hydrocarbon resin may include an aliphatic, such as an at least partially hydrogenated aliphatic hydrocarbon resin. In another embodiment, the hydrocarbon resin may include an aliphatic/aromatic hydrocarbon resin, such as an at least partially hydrogenated aliphatic aromatic hydrocarbon resin. In a further embodiment, the hydrocarbon resin may include an aromatic resin, such as an at least partially hydrogenated aromatic hydrocarbon resin. In another further embodiment, the hydrocarbon resin may include a cycloaliphatic hydrocarbon resin, such as an at least partially hydrogenated cycloaliphatic resin. In another embodiment, the hydrocarbon resin may include a cycloaliphatic/aromatic hydrocarbon resin, such as an at least partially hydrogenated cycloaliphatic/aromatic hydrocarbon resin. In another further embodiment, the hydrocarbon resin may include a polyterpene resin, a terpene-phenol resin, a rosin ester, a rosin acid, a grafted resin, or a mixture thereof.

In one embodiment, the hydrocarbon resin may be an aromatic resin or a non-aromatic resin. In one embodiment, the hydrocarbon resin may be an aromatic resin. In another embodiment, the hydrocarbon resin may be a non-aromatic resin. For example, the hydrocarbon resin may be an aliphatic resin or an aliphatic/aromatic resin. Regardless, the hydrocarbon resin may have an aromatic content of 0 wt. % or more, such as about 1 wt. % or more, such as about 2 wt. % or more, such as about 5 wt. % or more, 10 wt. % or more, such as about 15 wt. % or more. The aromatic content may be less than 100 wt. %, such as about 90 wt. % or less, such as about 70 wt. % or less, such as about 60 wt. % or less, such as about 50 wt. % or less, such as about 40 wt. % or less, such as about 20 wt. % or less, such as about 15 wt. % or less, such as about 10 wt. % or less, such as about 5 wt. % or less, such as about 2 wt. % or less, such as about 1 wt. % or less, such as about 0.5 wt. % or less. In one embodiment, the hydrocarbon resin may have an aromatic content of 0 wt. %.

In general, the hydrocarbon resin may comprise a hydrocarbon resin produced by the polymerization of various monomers. For example, these may include dienes (e.g., linear dienes), aromatic monomers, and natural monomers. In general, some of these monomers may be derived from naphtha. The diene monomers may include a piperylene, such as 1,3-pentadiene, 2-methyl-2-butene, etc. The diene monomers may also include cyclopentadiene and dicyclopentadiene. In addition, the aromatic monomers may include but are not limited to, styrene (including derivatives thereof), indene (including derivatives thereof), and others from a C9-aromatic naptha stream. As an example, the styrene aromatics may include styrene, derivatives of styrene, and substituted styrenes. Particular examples of aromatics may include styrene, alpha-methylstyrene, beta-methylstyrene, indene, methylindene, and vinyl toluene. The natural monomers may also include natural monomers such as terpenes such as alpha-pinene or beta-carene. Furthermore, it should be understood that these monomers may be used alone or in combination. In particular, one or more of the aromatic monomers and/or one or more of the natural monomers may be used in combination with the diene.

The hydrocarbon resins may be polymerized using any technique as generally known in the art. For instance, in the polymerization, a catalyst may generally be employed. The catalyst may include, but is not limited to, AlCl3 and BF3. The polymerization may also utilize other modifiers or reagents. For example, the polymerization may utilize weight control modifiers to control the molecular weight distribution of the hydrocarbon resin. These may include, but are not limited to, mono-olefin modifiers such as 2-methyl, 2-butene, and the like. They may also be used to control the MWD of the final resin.

Specific examples of commercially available hydrocarbon resins include rosins and rosin esters, phenol modified styrene and methyl styrene resins, styrenated terpene resins, terpene-aromatic resins, terpene phenolic resins, aliphatic aromatic resins, cycloaliphatic/aromatic resins, C₅ aliphatic resins, C₉ aliphatic resins, C₉ aromatic resins, C₉ aliphatic/aromatic resins, acid modified C₅ resins, C₅/C₉ resins, and acid modified C₅/C₉ resins, mixed aromatic/cycloaliphatic resins, hydrogenated terpene aromatic resins, and mixtures thereof. In one particular embodiment, the hydrocarbon resin may include a C₉ resin, such as an aromatic C₉ resin.

In addition, it should be understood that some of these resins may be polymerized. For example, a C₅ monomer-based resin may be a polymerization product of at least a C₅ monomer. Similar, a C₉ monomer-based resin may be a polymerization product of at least a C₉ monomer. The C₅ monomers may include, for example, 1-pentene, isoprene, cyclopentadiene, 1,3-pentadiene, or a mixture thereof. The C₉ monomers may include, for example, indene, vinyl-toluene, .alpha.-methylstyrene, .beta.-methylstyrene, or a mixture thereof.

Also, the hydrocarbon resin may be hydrogenated. For instance, the hydrocarbon resin may be partially, substantially, or fully hydrogenated. For instance, in one embodiment, the hydrocarbon resin may be at least partially hydrogenated. In another embodiment, the hydrocarbon resin may be substantially hydrogenated. In a further embodiment, the hydrocarbon may be fully hydrogenated. In this regard, as used herein, “at least partially hydrogenated” means that the resin may contain less than 90% olefinic protons, such as less than 80% olefinic protons, such as less than 70% olefinic protons, such as less than 60% olefinic protons, such as less than 50% olefinic protons, such as less than 40% olefinic protons, such as less than 30% olefinic protons, such as less than 25% olefinic protons and may contain 5% or more olefinic protons, such as 10% or more olefinic protons, such as 15% or more olefinic protons, such as 20% or more olefinic protons, such as 25% or more olefinic protons, such as 30% or more olefinic protons. In addition, as used herein, “substantially hydrogenated” means that the resin may contain less than 5% olefinic protons, such as less than 4% olefinic protons, such as less than 3% olefinic protons, such as less than 2% olefinic protons and may contain 0.1% or more olefinic protons, such as 0.5% or more olefinic protons, such as 0.8% or more olefinic protons, such as 1% or more olefinic protons, such as 1.5% or more olefinic protons, such as 2% or more olefinic protons.

Regarding hydrogenation, the degree of hydrogenation may be 50% or more, such as 60% or more, such as 70% or more, such as 80% or more, such as 85% or more, such as 90% or more, such as 95% or more, such as 96% or more, such as 97% or more, such as 98% or more, such as 99% or more, such as 100%. The degree of hydrogenation may be 100% or less, such as 99% or less, such as 98% or less, such as 95% or less, such as 90% or less, such as 85% or less, such as 80% or less, such as 75% or less. Without intending to be limited by theory, the degree of hydrogenation may impact the barrier properties. For instance, a higher degree of hydrogenation may improve the barrier properties of the material and resulting layer/film.

In one embodiment, the hydrocarbon resin may comprise one or more oligomers. For instance, such oligomers may include a dimer, a trimer, a tetramer, a pentamer, and/or a hexamer. The oligomers may be derived from a petroleum distillate boiling in the range of 30° to 210° C. and/or may be a byproduct of resin polymerization. The oligomer may have a number average molecular weight of about 100 g/mol or more, such as about 115 g/mol or more, such as about 130 g/mol or more, such as about 150 g/mol or more, such as about 175 g/mol or more, such as about 200 g/mol or more to about 500 g/mol or less, such as about 450 g/mol or less, such as about 400 g/mol or less, such as about 350 g/mol or less, such as about 300 g/mol or less, such as about 270 g/mol or less, such as about 250 g/mol or less, such as about 225 g/mol or less. The molecular weight may be determined using techniques known in the art, such as gel permeation chromatography.

These oligomers may include, but are not limited to, oligomers of cyclopentadiene, oligomers of substituted cyclopentadiene, oligomers of cyclopentadiene and substituted cyclopentadiene, oligomers of C₄-C₆ conjugated diolefins, oligomers of C₅-C₁₀ aromatic olefins, and combinations thereof. Furthermore, other monomers may also be present and may include C₄-C₆ mono-olefins, terpenes, and/or aromatic monomers. Furthermore, as indicated above, it should be understood that such oligomers may be at least partially hydrogenated or substantially hydrogenated.

In one particular embodiment, the hydrocarbon resin may be one derived from a cyclopentadiene. In this regard, the hydrocarbon resin may be a polycyclopentadiene. For instance, the hydrocarbon resin may be one produced by the polymerization (e.g., thermal polymerization) of a cyclopentadiene. For instance, the polymerization may be of cyclopentadiene (e.g., unsubstituted cyclopentadiene), a substituted cyclopentadiene, dicyclopentadiene, methylcyclopentadiene, or a mixture thereof. Such resin may also further include aliphatic or aromatic monomers as described herein. Such cyclopentadienes may be present in the hydrocarbon resin in an amount of 50 wt. % or more, such as about 60 wt. % or more, such as about 70 wt. % or more, such as about 80 wt. % or more, such as about 85 wt. % or more, such as about 90 wt. % or more, such as about 93 wt. % or more of the hydrocarbon resin. The cyclopentadienes may constitute less than 100 wt. %, such as about 99.5 wt. % or less, such as about 99 wt. % or less, such as about 98 wt. % or less, such as about 97 wt. % or less, such as about 95 wt. % or less, such as about 90 wt. % or less of the hydrocarbon resin.

In one particular embodiment, dicyclopentadiene may constitute a majority of the cyclopentadienes utilized in forming the hydrocarbon resin. In this regard, the dicyclopentadiene may constitute at least 50 wt. %, such as at least 60 wt. %, such as at least 70 wt. %, such as at least 80 wt. %, such as at least 85 wt. %, such as at least 90 wt. % to 100 wt. % or less, such as about 99 wt. % or less, such as about 97 wt. % or less, such as about 95 wt. % or less, such as about 90 wt. % or less of the cyclopentadienes utilized in the hydrocarbon resin. Furthermore, the aforementioned weight percentages may also apply to the total amount of dicyclopentadiene present in the hydrocarbon resin.

As indicated herein, the hydrocarbon resin may include a styrene. In this regard, the styrenic monomer may be utilized in an amount of at least 1 wt. %, such as at least 5 wt. %, such as at least 10 wt. % to 30 wt. % or less, such as 20 wt. % or less, such as 15 wt. % or less, such as 10 wt. % or less, such as 5 wt. % or less in the hydrocarbon resin. In one embodiment, the hydrocarbon resin may be substantially free of a styrenic monomer. For instance, it may be present in an amount of less than 1 wt. %, such as less than 0.5 wt. %, such as less than 0.1 wt. %, such as 0 wt. %.

As also indicated herein, the hydrocarbon resin may include an indene. In this regard, the indenic monomer may be utilized in an amount of at least 1 wt. %, such as at least 5 wt. %, such as at least 10 wt. % to 30 wt. % or less, such as 20 wt. % or less, such as 15 wt. % or less, such as 10 wt. % or less, such as 5 wt. % or less in the hydrocarbon resin. In one embodiment, the hydrocarbon resin may be substantially free of an indenic monomer. For instance, it may be present in an amount of less than 1 wt. %, such as less than 0.5 wt. %, such as less than 0.1 wt. %, such as 0 wt. %.

The hydrocarbon resin may have a certain viscosity as determined in accordance with ASTM D3236-15 at a temperature of 160° C. using a Brookfield viscometer and a size 21 spindle. The viscosity may be about 500 centipoise or more, such as about 700 centipoise or more, such as about 1,000 centipoise or more, such as about 1,500 centipoise or more, such as about 2,000 centipoise or more, such as about 3,000 centipoise or more, such as about 5,000 centipoise or more, such as about 8,000 centipoise or more, such as about 10,000 centipoise or more, such as about 13,000 centipoise or more, such as about 15,000 centipoise or more, such as about 18,000 centipoise or more, such as about 20,000 centipoise or more. The viscosity may be about 100,000 centipoise or less, such as about 80,000 centipoise or less, such as about 60,000 centipoise or less, such as about 50,000 centipoise or less, such as about 30,000 centipoise or less, such as about 25,000 centipoise or less, such as about 20,000 centipoise or less, such as about 17,000 centipoise or less, such as about 15,000 centipoise or less, such as about 12,000 centipoise or less, such as about 10,000 centipoise or less, such as about 7,000 centipoise or less, such as about 5,000 centipoise or less, such as about 4,000 centipoise or less, such as about 3,000 centipoise or less, such as about 2,000 centipoise or less, such as about 1,500 centipoise or less, such as about 1,000 centipoise or less, such as about 900 centipoise or less, such as about 800 centipoise or less, such as about 750 centipoise or less, such as about 700 centipoise or less, such as about 650 centipoise or less, such as about 625 centipoise or less, such as about 600 centipoise or less, such as about 550 centipoise or less.

The hydrocarbon resin may also have a certain molecular weight. For instance, the hydrocarbon resin may have a weight average molecular weight of about 200 g/mol or more, such as about 300 g/mol or more, such as about 400 g/mol or more, such as about 500 g/mol or more, such as about 600 g/mol or more, such as about 700 g/mol or more, such as about 800 g/mol or more, such as about 1,000 g/mol or more, such as about 1,200 g/mol or more, such as about 1,300 g/mol or more, such as about 1,500 g/mol or more, such as about 1,700 g/mol or more. The weight average molecular weight may be about 5,000 g/mol or less, such as about 4,000 g/mol or less, such as about 3,000 g/mol or less, such as about 2,500 g/mol or less, such as about 2,300 g/mol or less, such as about 2,000 g/mol or less, such as about 1,800 g/mol or less, such as about 1,600 g/mol or less, such as about 1,500 g/mol or less, such as about 1,400 g/mol or less, such as about 1,200 g/mol or less, such as about 1,000 g/mol or less, such as about 800 g/mol or less, such as about 700 g/mol or less, such as about 600 g/mol or less. The molecular weight may be determined using techniques known in the art, such as gel permeation chromatography.

Similarly, the hydrocarbon resin may have a number average molecular weight of about 200 g/mol or more, such as about 300 g/mol or more, such as about 400 g/mol or more, such as about 500 g/mol or more, such as about 600 g/mol or more, such as about 700 g/mol or more, such as about 800 g/mol or more, such as about 1,000 g/mol or more, such as about 1,200 g/mol or more, such as about 1,300 g/mol or more, such as about 1,500 g/mol or more, such as about 1,700 g/mol or more. The number average molecular weight may be about 5,000 g/mol or less, such as about 4,000 g/mol or less, such as about 3,000 g/mol or less, such as about 2,500 g/mol or less, such as about 2,300 g/mol or less, such as about 2,000 g/mol or less, such as about 1,800 g/mol or less, such as about 1,600 g/mol or less, such as about 1,500 g/mol or less, such as about 1,400 g/mol or less, such as about 1,200 g/mol or less, such as about 1,000 g/mol or less, such as about 800 g/mol or less, such as about 700 g/mol or less, such as about 600 g/mol or less. In this regard, the hydrocarbon resin may have a polydispersity index of about 1 or more, such as about 1.2 or more, such as about 1.5 or more, such as about 1.6 or more, such as about 1.7 or more, such as about 1.8 or more, such as about 1.9 or more, such as about 2 or more, such as about 2.3 or more, such as about 2.5 or more to about 20 or less, such as about 10 or less, such as about 8 or less, such as about 5 or less, such as about 4.5 or less, such as about 4 or less, such as about 3.5 or less, such as about 3 or less. The molecular weight may be determined using techniques known in the art, such as gel permeation chromatography.

In this regard, in one embodiment, the hydrocarbon resin may be considered a low molecular weight hydrocarbon resin. In one particular embodiment, the hydrocarbon resin may be considered a high molecular weight hydrocarbon resin.

In addition, the hydrocarbon resin may have a particular glass transition temperature. For instance, the glass transition temperature may be about 0° C. or more, such as about 20° C. or more, such as about 30° C. or more, such as about 40° C. or more, such as about 50° C. or more, such as about 60° C. or more, such as about 70° C. or more, such as about 80° C. or more, such as about 100° C. or more. The glass transition temperature may be about 250° C. or less, such as about 200° C. or less, such as about 180° C. or less, such as about 160° C. or less, such as about 150° C. or less, such as about 130° C. or less, such as about 100° C. or less, such as about 90° C. or less, such as about 80° C. or less, such as about 60° C. or less. The glass transition temperature may be determined using techniques known in the art, such as differential scanning calorimetry.

Further, the hydrocarbon resin may have a particular flash point. For instance, the flash point temperature may be about 100° C. or more, such as about 125° C. or more, such as about 150° C. or more, such as about 175° C. or more, such as about 190° C. or more, such as about 200° C. or more, such as about 210° C. or more, such as about 215° C. or more, such as about 220° C. or more, such as about 230° C. or more. The flash point temperature may be about 400° C. or less, such as about 350° C. or less, such as about 300° C. or less, such as about 280° C. or less, such as about 260° C. or less, such as about 250° C. or less, such as about 240° C. or less, such as about 230° C. or less. The flash point temperature may be determined using techniques known in the art, such as in accordance with ASTMD92-90.

Also, the hydrocarbon resin may have a particular ring and ball softening point, as determined according to ASTM E-28 (Revision 1996) at a heating and cooling rate of 10° C./min. For example, the softening point may be about 0° C. or more, such as about 20° C. or more, such as about 40° C. or more, such as about 50° C. or more, such as about 60° C. or more, such as about 80° C. or more, such as about 100° C. or more, such as about 110° C. or more, such as about 115° C. or more, such as about 120° C. or more, such as about 125° C. or more. The softening point may be about 250° C. or less, such as about 225° C. or less, such as about 200° C. or less, such as about 180° C. or less, such as about 160° C. or less, such as about 150° C. or less, such as about 140° C. or less, such as about 130° C. or less, such as about 125° C. or less, such as about 120° C. or less.

In addition, the hydrocarbon resin may also have a particular aniline point, which is generally the minimum temperature at which equal volumes of aniline and the resin are miscible. Without intending to be limited by theory, the aniline point may provide an indication of the aromatic hydrocarbon content of the resin. For example, the aniline point may be about 0° C. or more, such as about 20° C. or more, such as about 40° C. or more, such as about 50° C. or more, such as about 60° C. or more, such as about 80° C. or more, such as about 100° C. or more, such as about 107° C. or more, such as about 110° C. or more, such as about 115° C. or more, such as about 120° C. or more, such as about 125° C. or more. The aniline point may be about 250° C. or less, such as about 225° C. or less, such as about 200° C. or less, such as about 180° C. or less, such as about 160° C. or less, such as about 150° C. or less, such as about 140° C. or less, such as about 130° C. or less, such as about 125° C. or less, such as about 120° C. or less. In general, equal volumes of aniline and the resin are stirred continuously and heated until the two merge to provide a homogeneous solution; then, the heating is stopped and the temperature at which both phases separate is recorded as the aniline point. The aniline point can be determined in accordance with ASTM D611-12.

### III.I. Ethylene-Vinyl Alcohol Copolymer Barrier Layer

The rigid co-extruded polymeric film of the present invention may include one or more layers comprising EVOH, which also function as barrier layers.

The ethylene molar percent in the ethylene-vinyl alcohol copolymer or the EVOH copolymer is in the range of from about 20 to about 55%. Lower ethylene content in the EVOH polymers corresponds to improved barrier properties. Stated another way, the ethylene molar percent in the EVOH copolymer is a number selected from the following set of numbers:

20, 21, 22, 23, 24, 25, 26, 27, 28, 29, 30, 31, 31, 32, 33, 34, 35, 36, 37, 38, 39, 40, 41, 42, 43, 44, 45, 46, 47, 48, 49, 50, 51, 52, 53, 54, and 55.

In one embodiment, the ethylene molar percent in the EVOH layers is a number within a range defined by any two of the above numbers, including end-points.

EVOH may include saponified or hydrolyzed ethylene-vinyl acetate copolymers, such as those having a degree of hydrolysis of at least 50%. Stated another way, the degree of hydrolysis, in percent, is any one of the following numbers:

50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

It is also contemplated that two or more different EVOH copolymer as described herein may be used for the EVOH layer.

Preferably, the EVOH layer has a thickness in the range of from 0.8 to 50 microns.

### III.J. Polyamide and Polyester Barrier Layers

The additional layers may also advantageously comprise a polymeric material selected from the group of polymers with the general name of polyamide or nylon. Polyamides include for example PA6 and PA66. These polymeric films also include biaxially oriented polyamides.

A polyester barrier layer may also be included in the rigid films of the present invention. Polyesters for example, include PET, PBT, 3GT, etc. These polymeric films also include biaxially oriented polyesters.

The polyamides and the polyesters can be uniaxially or biaxially-oriented polymers.

### IIIK. Optional Additives

The PP-stack layer or the barrier layer or the other layers in the polymeric film structure may include any additional additives as generally utilized in the art. Furthermore, the additional layers as defined herein may also include such additives.

These additives may include, but are not limited to, nucleating agents, clarifiers, slip additives, anti-blocking additives (e.g., silica), colored pigments, UV stabilizers, antioxidants, light stabilizers, flame retardants, antistatic agents, biocides, viscosity-breaking agents, impact modifiers, plasticizers, fillers, reinforcing agents, lubricants, mold release agents, blowing agents, pearlizers, etc.

In one embodiment, a nucleating agent may be utilized. In general, the nucleating agent may have a molecular weight of about 1,000 g/mol or less, such as about 800 g/mol or less, such as about 500 g/mol or less, such as about 300 g/mol or less, such as about 200 g/mol or less. In general, the nucleating agent may be utilized to decrease the crystallization time of a thermoplastic material.

The nucleating agents may include, but are not limited to, sodium benzoate, talc, glycerol alkoxide salts, cyclic carboxylic acid salts, bicyclic carboxylic acid salts, glycerolates, phosphines, phosphates, hexahydrophtalic acid salts, sugar alcohols, etc.

For instance, the sugar alcohols may include mannitol or mannitol-based compounds, sorbitol, or sorbitol-based compounds, nonitol or nonitol based compounds such as 1,2,3-trideoxy-4,6:5,7-bis-0-((4-propylphenyl) methylene) nonitol, etc.

For instance, the phosphines may include a salt, such as a sodium salt, of 2,4,8,10-tetra(tert-butyl)-6-hydroxy-12H-dibenzo[d,g][1,3,2]diox-aphosphocin 6-oxide.

The phosphates may include hydroxy-bis[2,2′-methylenebis[4,6-di(tert-butyl)phenyl]phosphate, 2,2′-methylenebis(4,6-di-tert-butylphenyl)phosphate, a salt thereof, or a mixture thereof. For instance, the salt may be an aluminum salt, a lithium salt, a sodium salt, or a mixture thereof.

Other nucleating agents may include, but are not limited to diols (e.g., (1R)-1-[(4R,4aR,8aS)-2,6-bis(3,4-dimethylphenyl)-4,4a,8,8a-tetrahydro-[1,3]dioxino[5,4-d][1,3]dioxin-4-yl]ethane-1,2-diol, 1-[8-propyl-2,6-bis(4-propylphenyl)-4,4a,8,8a-tetrahydro-[1,3]dioxino[5,4-d][1,3]dioxin-4-yl]ethane-1,2-diol, etc.).

Other nucleating agents include amides (e.g., N-[3,5-bis(2,2-dimethylpropanoylamino)phenyl]-2,2-dimethylpropanamide), a salt, such as a calcium salt, of (1S,2R)-cyclohexane-1,2-dicarboxylate with zinc octadecenoate, and/or cis-endo-bicyclo[2,2,1]heptane-2,3-dicarboxylic acid disodium salt with 13-docosenamide, (Z)- and amorphous silicon dioxide.

In one particular embodiment, the nucleating agent may include at least one bicyclic carboxylic acid salt, such as a bicycloheptane dicarboxylic acid, disodium salt such as bicyclo[2.2.1]heptane dicarboxylate. For instance, the nucleating agent may include a blend of bicyclo[2.2.1]heptane dicarboxylate, disodium salt, 13-docosenamide, and amorphous silicon dioxide.

In another embodiment, the nucleating agent may include a cyclohexanedicarboxylic acid, calcium salt, or a blend of cyclohexanedicarboxylic acid, calcium salt, and zinc stearate.

In one embodiment, one of the layers may include a nucleating agent, a slip additive, an anti-blocking additive, or a mixture thereof. For instance, in one embodiment, the additive may include at least a nucleating agent. In another embodiment, the additive may include at least a slip additive. In a further embodiment, the additive may include at least an anti-blocking additive. In another further embodiment, the additive may include a mixture of at least two of a nucleating agent, a slip additive, and an anti-blocking additive. In another embodiment, the additive may include a mixture of a nucleating agent, a slip additive, and an anti-blocking additive.

The individual layers and/or polymeric film substrate may include such additives in an amount of about 20 wt. % or less, such as about 15 wt. % or less, such as about 10 wt. % or less, such as about 8 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.3 wt. % or less, such as about 0.1 wt. % or less, such as 0 wt. %. The additive may be provided in an amount of about 0.001 wt. % or more, such as about 0.005 wt. % or more, such as about 0.01 wt. % or more, such as about 0.05 wt. % or more, such as about 0.1 wt. % or more, such as about 0.5 wt. % or more. In this regard, it should be understood that such additives may not be present within a layer in one embodiment.

Advantageously, the following additives are preferred.

The range of the slip agents that can be used is from about 200 to 2000 ppm or 0.5-2.5% by weight of a layer. A preferred slip agent is erucamide or other fatty acid amide, such as, oleamide. The slip agent lowers the coefficient friction of the film and allows it to slide readily over various surfaces.

Any film anti-blocking agent well known to skilled worker may be added to the film layers in the range of about 1000-5000 ppm or 0.5-2.5% by weight of a layer. Typical anti-blocking agents, such as, diatomaceous earth, synthetic silica or talc can be added to the inner and outer sealant layers of the film. The anti-blocking material is particularly useful in reducing the coefficient of friction between the film and the metallic surfaces over which the film is drawn during the bag making process.

Any processing aid well known to skilled worker, preferably and not limited to fluoro-elastomer based polymer may be added to outer and inner sealing layers of a polymeric film substrate.

The present invention also is directed to a flexible-container containing packaged material, said container can be made from the previously described multi-layer film in FFS processing. The FFS processes and its modifications are described in U.S. Pat. Nos. 5,538,590, 9,327,856 and 9,440,757 and are incorporated by reference herein in their entirety.

Although melt-index ranges are specified herein, it is understood that the polymers have melt indices typical of film-grade polymers can be used. The multi-layer films of the present invention have the ability to form a lap seal as well as a fin seal. They also substantially reduce the curl in the laminate.

### IV. Polymeric Film Structure—Barrier Film Embodiments

Exemplary embodiments of the invention are provided below. In each of the embodiment layers, an Additive S can be included, such as HPM, from 2-40%.

### IV.A.1. Embodiment 1

This embodiment includes a co-extruded, two-layered rigid film in the A-B construction. The first layer A predominately comprises regular polypropylene. The second layer B predominately comprises the Modified PP polymer. In one embodiment, the rigid film of the present invention has a thickness ranging from 5 μm to 1600 μm. The rigid film of this embodiment provides improved barrier properties and improved stiffness.

The A-B weight content ranges independently from 10/90 to 90/10. In other words, the A content ranges from about 10% to about 90% by weight of the rigid film and the B content ranges from about 10% to about 90% by weight of the rigid film. Stated differently, the A and the B content by weight in the rigid film are selected from the following numbers, in percent weight of the rigid film of this embodiment of the present invention:

10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, and 90.

The A and the B content are also within a range defined by any two numbers from the above list, including the endpoints of such range.

### IV.A.2. Embodiment 2

This embodiment includes a co-extruded, three-layered rigid film in the A1-B-A2 construction. The first layer A1 predominately comprises regular polypropylene. The second layer B comprises the Modified PP polymer. The third layer A2 predominately comprises regular PP which is the same grade as or different grade from the regular PP in first layer A1.

In one embodiment, the rigid film of the present invention has a thickness ranging from 5 μm to 1600 μm. The rigid film of this embodiment provides improved barrier properties and improved stiffness.

The A1-B-A2 weight content ranges independently from 43/14/43 to 10/80/10. In one embodiment, the A1 content independently ranges from about 10% to about 76% by weight of the rigid film. Similarly, the A2 content independently ranges from about 10% to about 76% by weight of the rigid film. The B content independently ranges from about 14% to about 80% by weight of the rigid film. Stated differently, the A1 and the A2 content by weight in the rigid film are selected from the following numbers, in percent weight of the rigid film of this embodiment of the present invention:

10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, and 76.

The A1 and the A2 content are also within a range defined by any two numbers from the above list, including the endpoints of such range.

Similarly, the B content by weight in the rigid film is selected from the following numbers, in percent weight of the rigid film of this embodiment of the present invention:

14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, and 80.

The B content is also within a range defined by any two numbers from the above list, including the endpoints of such range.

### IV.A.3. Embodiment 3

This embodiment includes a co-extruded, 6-layered rigid film in the A1-B-T1-C-T2-A2 construction that includes one 2-layered PP stack. The first layer A1 predominately comprises regular polypropylene. The second layer B comprises the Modified PP polymer. The third layer T1 is a tie layer. The fourth layer C predominately comprises EVOH. The fifth layer T2 is a tie layer. The sixth layer A2 predominately comprises regular polypropylene, which is the same grade as or different grade from the regular PP in first layer A1.

In one embodiment, the rigid film of the present invention has a thickness ranging from 5 μm to 1600 μm. The rigid film of this embodiment provides improved barrier properties and improved stiffness.

The A1-B weight content ranges independently from 10/90 to 90/10. In other words, the A1 content ranges from about 10% to about 90% by combined weight of the two layers A1+B and the B content ranges from about 10% to about 90% by combined weight of the two layers A1+B. Stated differently, the A1 content and the B content as percent of their combined weight are selected from the following numbers, in percent weight of their combined weight:

10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, and 90.

The A1 and the B content are also within a range defined by any two numbers from the above list, including the endpoints of such range.

### IV.A.4. Embodiment 4

This embodiment includes a co-extruded, two-layered rigid film in the A-B construction. The first layer A predominately comprises regular polypropylene. The second layer B predominately comprises the Modified PP polymer.

In one embodiment, the rigid film of the present invention has a thickness ranging from 5 μm to 1600 μm. The rigid film of this embodiment provides improved barrier properties and improved stiffness.

The A-B weight content ranges independently from 10/90 to 90/10. In other words, the A content ranges from about 10% to about 90% by weight of the rigid film and the B content ranges from about 10% to about 90% by weight of the rigid film. Stated differently, the A and the B content by weight in the rigid film are selected from the following numbers, in percent weight of the rigid film of this embodiment of the present invention:

10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, and 90.

The A and the B content are also within a range defined by any two numbers from the above list, including the endpoints of such range.

### IV.A.5. Embodiment 5

This embodiment includes a co-extruded, three-layered rigid film in the A1-B-A2 construction. The first layer A1 predominately comprises regular polypropylene. The second layer B comprises the Modified PP polymer. The third layer A2 predominately comprises regular PP which is the same grade as or different grade from the regular PP in first layer A1.

In one embodiment, the rigid film of the present invention has a thickness ranging from 5 μm to 1600 μm. The rigid film of this embodiment provides improved barrier properties and improved stiffness.

The A1-B-A2 weight content ranges independently from 43/14/43 to 10/80/10. In one embodiment, the A1 content independently ranges from about 10% to about 76% by weight of the rigid film. Similarly, the A2 content independently ranges from about 10% to about 76% by weight of the rigid film. The B content independently ranges from about 14% to about 80% by weight of the rigid film. Stated differently, the A1 and the A2 content by weight in the rigid film are selected from the following numbers, in percent weight of the rigid film of this embodiment of the present invention:

10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, and 76.

The A1 and the A2 content are also within a range defined by any two numbers from the above list, including the endpoints of such range.

Similarly, the B content by weight in the rigid film is selected from the following numbers, in percent weight of the rigid film of this embodiment of the present invention:

14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, and 80.

The B content is also within a range defined by any two numbers from the above list, including the endpoints of such range.

### IV.A.6. Embodiment 6

This embodiment includes a co-extruded, 6-layered rigid film in the A1-B-T1-C-T2-A2 construction that includes one 2-layered PP stack. The first layer A1 predominately comprises regular polypropylene. The second layer B comprises the Modified PP polymer. The third layer T1 is a tie layer. The fourth layer C predominately comprises EVOH. The fifth layer T2 is a tie layer. The sixth layer A2 predominately comprises regular polypropylene, which is the same grade as or different grade from the regular PP in first layer A1.

In one embodiment, the rigid film of the present invention has a thickness ranging from 5 μm to 1600 μm. The rigid film of this embodiment provides improved barrier properties and improved stiffness.

The A1-B weight content ranges independently from 10/90 to 90/10. In other words, the A1 content ranges from about 10% to about 90% by combined weight of the two layers A1+B and the B content ranges from about 10% to about 90% by combined weight of the two layers A1+B. Stated differently, the A1 content and the B content as percent of their combined weight are selected from the following numbers, in percent weight of their combined weight:

10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, and 90.

The A1 and the B content are also within a range defined by any two numbers from the above list, including the endpoints of such range.

### IV.A.7. Embodiment 7

This embodiment includes a co-extruded, 8-layered rigid film in the A1-B1-T1-C-T2-B2-T3-D construction that includes one 2-layered PP stack. The first layer A1 predominately comprises regular polypropylene. The second layer B1 comprises the Modified PP polymer. The third layer T1 is a tie layer. The fourth layer C predominately comprises EVOH. The fifth layer T2 is a tie layer. The sixth layer B2 predominately comprises Modified PP, which is the same grade as or different grade from the Modified PP in second layer B1. The seventh layer is a tie layer. The 8^{th} layer is a sealant layer.

In one embodiment, the rigid film of the present invention has a thickness ranging from 5 μm to 1600 μm. The rigid film of this embodiment provides improved barrier properties and improved stiffness.

The A1-B1 weight content ranges independently from 10/90 to 90/10. In other words, the A1 content ranges from about 10% to about 90% by combined weight of the two layers A1+B1 and the B1 content ranges from about 10% to about 90% by combined weight of the two layers A1+B1. Stated differently, the A1 content and the B1 content as percent of their combined weight are selected from the following numbers, in percent weight of their combined weight:

10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, and 90.

The A1 and the B1 content are also within a range defined by any two numbers from the above list, including the endpoints of such range.

### IV.A.8. Embodiment 8

This embodiment includes a co-extruded, 4-layered rigid film in the A1-B1-B2-A2 construction that includes two 2-layered PP stack. The first layer A1 predominately comprises regular polypropylene. The second layer B1 comprises the Modified PP polymer. The third layer B2 comprises the Modified PP polymer. The fourth layer A2 predominately comprises regular PP.

In one embodiment, the rigid film of the present invention has a thickness ranging from 5 μm to 1600 μm. The rigid film of this embodiment provides improved barrier properties and improved stiffness.

The A-B weight content ranges independently from 10/90 to 90/10. In other words, the (A1+A2) content ranges from about 10% to about 90% by weight of the rigid film and the (B1+B2) content ranges from about 10% to about 90% by weight of the rigid film. Stated differently, the (A1+A2) and the (B1+B2) content by weight in the rigid film are selected from the following numbers, in percent weight of the rigid film of this embodiment of the present invention:

10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, and 90.

The (A1+A2) and the (B1+B2) content are also within a range defined by any two numbers from the above list, including the endpoints of such range.

### IV.A.9. Embodiment 9

This embodiment includes a co-extruded, 7-layered rigid film in the A1-B1-A2-T1-A3-B2-A4 construction that includes two 3-layered PP stacks. The first layer A1 predominately comprises regular polypropylene. The second layer B1 comprises the Modified PP polymer. The third layer B2 predominately comprises the regular PP polymer. The fourth layer is a tie layer. The fifth layer A3 predominately comprises regular PP. The sixth layer B1 comprises the Modified PP polymer. The seventh layer B2 predominately comprises the regular PP polymer.

In one embodiment, the rigid film of the present invention has a thickness ranging from 5 μm to 1600 μm. The rigid film of this embodiment provides improved barrier properties and improved stiffness.

The A-B weight content ranges independently from 10/90 to 90/10. In other words, the (A1+A2+A3+A4) content ranges from about 10% to about 90% by weight of the combined A and B polymers and the (B1+B2) content ranges from about 10% to about 90% by weight of the combined A and B polymers. Stated differently, the (A1+A2+A3+A4) and the (B1+B2) content by weight in the combined weight of the A and B polymers are selected from the following numbers, in percent weight of the combined weight of the A and B polymers:

10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, and 90.

The (A1+A2+A3+A4) and the (B1+B2) content are also within a range defined by any two numbers from the above list, including the endpoints of such range.

### IV.A.10. Additional Embodiment

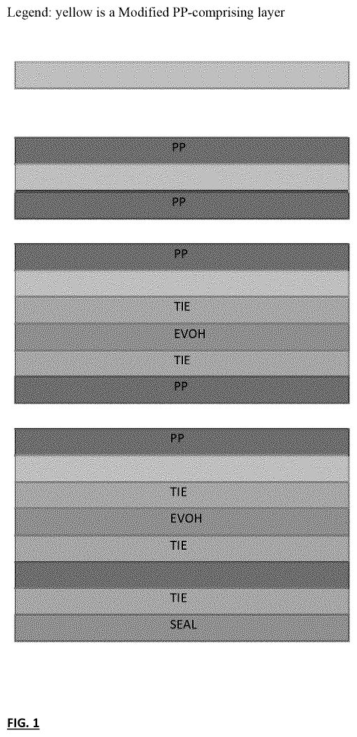

Additional embodiments include the coextruded rigid films described exemplarily in Table 3 below, and some of them are pictorially represented in FIG. 1. The nomenclature of the coextruded films included in Table 3 are provided in Table 2.

TABLE 3
Nomenclature of the Film Structures for High Barrier Rigid Films

| Nomenclature | Description |
|---|---|
| A, for example, A1, | Regular polypropylene; A1, A2, A3 . . . and can be same or different |
| A2, A3, . . . | grades; maybe blends of two or more grades. |
| B, for example, B1, | Modified PP polypropylene; B1, B2, B3 . . . and can be same or |
| B2, B3, . . . | different grades; maybe blends of two or more grades. High |
| | crystallinity material. |
| C, for example, C1, | EVOH; C1, C2, C3, . . . can be same or different grades of EVOH; |
| C2, C3, . . . | they can be blends of two grades; and they can be blends of same or |
| | different grades with same or different polyvinyl acetate content. |
| D, for example D1, | Polyethylene interpolymer, usually as outside sealant layer or inside |
| D2, D3, . . . | sealant layer. D1, D2, D3, . . . can me same or different grades, or |
| | blends of two or more grades. |
| T, for example, T1, | Tie layer, or an adhesive layer. T1, T2, T3, . . . can be the same or |
| T2, T3, . . . | different grades of tie layers. |
| E, for example, E1, | Barrier layer such as polyamide; E1, E2, E3, can be the same or |
| E2, E3, . . . | different grades of polyamide or blends of two or more polyamides. |
| | This includes uniaxially or biaxially oriented polyamides. |
| F, for example, F1, | Barrier layer such as polyester; F1, E2, F3, can be the same or |
| F2, F3, . . . | different grades of polyesters or blends of two or more polyesters. |
| | This includes uniaxially or biaxially oriented polyesters. |

TABLE 4
Exemplary Co-Extruded Structures with High Barrier Properties

| No. of | |
|---|---|
| Layers | Structure |
| 4 | A1-B1-B2-A2 |
| 5 | A1-B1-A2-B2-A3 |
| 5 | A1-B1-B2-B3-A2 |
| 6 | A1-B1-A2-B2-B3-A3 |
| 6 | A1-B1-B2-A2-B3-A3 |
| 5 | A1-B1-T1-B2-A2 |
| 7 | A1-B1-A2-T1-A3-B2-A3 |
| 7 | A1-B1-T1-C1-T2-B2-A2 |
| 9 | A1-B1-A2-T1-C1-T2-A3-B2-A4 |
| 4 | D1-A1-B1-D2 |
| 6 | D1-T1-A1-B1-T2-D2 |
| 10 | D1-T1-A1-B1-A2-T2-A3-B2-T2-D2 |
| 10 | D1-T1-A1-B1-T2-C1-T3-B2-A2-D2 |
| 16 | D1-T1-E1-A1-B1-A2-T2-C1-T3-A3-B2-A4-T4-F1-T5-D2 |

One preferred method of manufacturing film is the so-called blown film process. The film, after manufacture, is slit longitudinally into appropriate widths. The preferred method of manufacture of a multi-layer film is by using a blown film co-extrusion process, although other methods of manufacture of the film may be used.

### V. Other Additives

It will be understood by those skilled in the art that additives such as antioxidants, stabilizers, anti-block agents, and slip additives, may be added to the polymers from which bags of the present invention are made. Optionally, the inner sealant layer, the outer sealant, the interposed layer may further comprise one or several additives useful to make easier the processing of a film in a bag making process, such as, for example, polymer processing aid concentrate, and/or slip/anti-block concentrates. Any of such additives well known to person skilled in the art can be used. Advantageously, the following additives are preferred.

### V.1. Slip Agents

The range of the slip agents that can be used is from about 200 to 2000 ppm or 0.5-2.5% by weight of the sealing layer. A preferred slip agent is erucamide or other fatty acid amide, such as, oleamide. The slip agent lowers the coefficient friction of the film and allows it to slide readily over various surfaces.

### V.2. Anti-Blocking Agents

Any film anti-blocking agent well known to skilled worker may be added to the film layers in the range of about 1000-5000 ppm or 0.5-2.5% by weight of the sealant layer. Typical anti-blocking agents, such as, diatomaceous earth, synthetic silica or talc can be added to the inner and outer sealant layers of the film. The anti-blocking material is particularly useful in reducing the coefficient of friction between the film and the metallic surfaces over which the film is drawn during the bag making process.

### V.3. Processing Aid

Any processing aid well known to skilled worker, preferably and not limited to fluoro-elastomer based polymer may be added to outer and inner sealing layers of the film.

The present invention also is directed to a flexible-container containing packaged material, said container can be made from the previously described multi-layer film in FFS processing. The FFS processes and its modifications are described in U.S. Pat. Nos. 5,538,590, 9,327,856 and 9,440,757 and are incorporated by reference herein in their entirety.

Although melt-index ranges are specified herein, it is understood that the polymers have melt indices typical of film-grade polymers can be used. The multi-layer films of the present invention have the ability to form a lap seal as well as a fin seal. They also substantially reduce the curl in the laminate.

One preferred method of manufacturing film is the so-called blown film process. The film, after manufacture, is slit longitudinally into appropriate widths. The preferred method of manufacture of a multi-layer film is by using a blown film co-extrusion process, although other methods of manufacture of the film may be used.

### VI. Shaped Articles from the Polymeric Film Structures

The polymeric film structure of the present invention may form at least part of a shaped polymeric article. The polymeric film structure and resulting shaped polymeric article may be formed using various techniques known in the art. These techniques may include, but are not limited to, thermoforming, blow molding, injection molding, compression molding, roto-molding, etc. For example, in one embodiment, the polymeric film structure and resulting shaped polymeric article may be formed via thermoforming to create a thermoformed shaped polymeric article. In another embodiment, the polymeric film structure and resulting shaped polymeric article may be formed via blow molding to create a blow molded shaped polymeric article. In a further embodiment, the polymeric film structure and resulting shaped polymeric article may be formed via injection molding to create an injection molded shaped polymeric article. In another further embodiment, the polymeric film structure and resulting shaped polymeric article may be formed via compression molding to create a compression molded shaped polymeric article. It should be understood, however, that other processing techniques may also be utilized according to the present invention.

In one embodiment, the polymeric film structure and shaped polymeric article as disclosed herein may be formed by exposing the barrier layer, for example the PP-stack layer, and any additional layers as defined herein to a thermoforming process. Thermoforming generally involves heating the layer(s) to a certain temperature, shaping the layer(s) within a mold, and then optionally trimming the shaped polymeric article to create the desired article.

The particular forming technique is not critical, and any of a variety of conventional processes may be employed in the present invention. Suitable techniques may include, for instance, vacuum forming, plug assist forming, drape forming, press forming, etc. For example, the layer(s) may be fed to a heating device (e.g., convection oven, resistance heater, infrared heater, etc.) that heats it to a temperature sufficient to cause the polymer(s) to deform or stretch. This temperature may generally be above the glass transition temperature, yet at or below the melting temperature. For example, the thermoforming temperature may be about 10° C. or more, such as about 20° C. or more, such as about 30° C. or more, such as about 40° C. or more, such as about 45° C. or more to about 100° C. or less, such as about 80° C. or less, such as about 60° C. or less below the melting temperature. For example, the layer(s) may be heated to a temperature of from about 30° C. or more, such as about 40° C. or more, such as about 50° C. or more, such as about 60° C. or more to about 200° C. or less, such as about 150° C. or less, such as about 130° C. or less, such as about 120° C. or less, such as about 110° C. or less. Once heated, the layer(s) may then be fed to a mold where a force (e.g., suctional force) is placed against the layer(s) to cause it to conform to the contours of the mold. The mold cavity imparts the shape of the article to the layer(s) and can also cool the material to a temperature significantly below the melting point so that it solidifies adequately to retain its shape upon removal from the mold.

In one embodiment, thermoforming process may be utilized. The film layers are fed to a heating device that heats the layers to a temperature sufficient to cause the layers to deform. As indicated above, any of a variety of heating devices may be employed in the thermoforming process. Once heated, the layers are fed to a molding device where they are molded into an article. As indicated above, any of a variety of molding devices may be employed in the thermoforming process. The layers may then conform to the contours of the mold resulting in the polymeric film structure and shaped polymeric article. Multiple layers or a single layer comprising that is a PP-stack as a just the barrier layer as disclosed herein can be used. In addition, thermoforming applications may also encompass form, fill, and seal applications as generally known in the art.

In another embodiment, the shaped polymeric article may be a blow molded shaped polymeric article. Blow molded articles may be formed using extrusion blow molding, injection blow molding, or injection stretch blow molding techniques. Regardless of the method, blow molding generally involves providing a polymeric material into a hollow mold cavity, shaping the material within the mold by blowing air, and then optionally trimming the shaped polymeric article to create the desired article. For instance, a polymeric material including the aforementioned components of the barrier layer (i.e., polyolefin polymer, hydrocarbon resin, and optional additives) may be provided directly into a hollow mold cavity. Once inserted, the mold closes, and the parison is gripped into place. Then, a nozzle or pin may be inserted into an open end of the parison to introduce air which inflates the parison into the shape of the mold. The mold temperature may be about 0° C. or more, such as about 5° C. or more, such as about 10° C. or more, such as about 20° C. or more, such as about 30° C. or more, such as about 40° C. or more, such as about 45° C. or more than the melting temperature of the material. The mold temperature may be about 90° C. or less, such as about 85° C. or less, such as about 80° C. or less than the melting temperature of the material. In one embodiment, the mold temperature may be greater than 0° C. up to the crystalline temperature of the material. In certain embodiments, for example, the layer(s) may be heated to a temperature of from about 30° C. to about 150° C., in some embodiments from about 50° C. to about 130° C., and in some embodiments, from about 60° C. to about 120° C. within the mold until the layer(s) have taken shape. The mold cavity imparts the shape of the article to the layer(s) and can also cool the material to a temperature significantly below the melting point so that it solidifies adequately to retain its shape upon removal from the mold. In addition, cool air may be introduced into the mold to solidify the polymers. Once the layer(s) have taken shape, the mold is opened, and the shaped polymeric article is allowed to be removed. Then, optionally, the shaped polymeric article is trimmed as necessary to create the desired article. One example of a blow molding process, in particular an injection stretch blow molding process is for forming a bottle.

Another processing technique that may be utilized according to the present invention is injection molding. In general, forming injection molded articles involves plasticization or heating of a polymeric material, injection of the material into a mold, packing the mold with the polymeric material, cooling the article, and demolding/ejection of the article.

Depending on the processing technique utilized, the polymeric film structure and shaped polymeric article may be monolayer or multilayer. In one embodiment, the polymeric film structure and shaped polymeric article may be monolayer. In another embodiment, the polymeric film structure and shaped polymeric article may be multilayer. For example, multilayer films and articles may be formed using thermoforming. Alternatively, monolayer films and articles may be formed using thermoforming, blow molding, or injection molding. Furthermore, with the above processing techniques, in some embodiments, the polymeric films and article disclosed herein may be non-oriented.

Furthermore, by utilizing the polyolefin polymer and the hydrocarbon resin as disclosed herein, the resulting substrate and barrier layer and/or polymeric material may undergo minimal mold shrinkage. For instance, the mold shrinkage may be 10% or less, such as 8% or less, such as 6% or less, such as 5% or less, such as 4% or less, such as 3% or less, such as 2.5% or less, such as 2% or less, such as 1.8% or less, such as 1.6% or less, such as 1.5% or less, such as 1.4% or less, such as 1.3% or less, such as 1.2% or less, such as 1.1% or less, such as 1% or less. The mold shrinkage may be 0.01% or more, such as 0.05% or more, such as 0.1% or more, such as 0.3% or more, such as 0.5% or more, such as 0.8% or more, such as 10% or more, such as 1.1% or more, such as 1.30% or more, such as 1.50% or more. Such mold shrinkage may be in the flow direction in one embodiment. In another embodiment, such mold shrinkage may be in the cross-flow direction. In a further embodiment, such mold shrinkage may be in the flow direction and the cross-flow direction.

With the mold shrinkage and mechanical properties as disclosed herein, the polymeric film structure and barrier layer may mimic other polymers, such as polystyrene, with its performance and attributes thereby allowing for these materials to be used in a wide variety of applications, some of which are provided herein. In particular, the material as disclosed herein may generally exhibit a flexural modulus, as well as other mechanical properties, that mimic other polymers in particular polystyrene.

As indicated above, the shaped polymeric article may have an average final wall thickness of more than 200 μm, such as 210 μm or more, such as 220 μm or more, such as 240 μm or more, such as 250 μm or more, such as 300 μm or more, such as 500 μm or more, such as 700 μm or more, such as 900 μm or more, such as 1 mm or more, such as 3 mm or more, such as 5 mm or more. The shaped polymeric article may have an average final wall thickness of 1.25 cm or less, such as 1 cm or less, such as 8 mm or less, such as 5 mm or less, such as 3 mm or less, such as 2 mm or less, such as 1 mm or less, such as 800 μm or less, such as 500 μm or less, such as 400 μm or less, such as 350 μm or less, such as 300 μm or less, such as 280 μm or less, such as 270 μm or less. Such average thickness may be obtained by obtaining an average of each wall thickness of the shaped polymeric article.

Regardless of the technique utilized, the polymeric film structure including the barrier layer may be shaped or utilized for a wide variety of different three-dimensional articles. For example, the resulting article may be a packaging product for the food, medical, or general retail industries, such as a package, cup, tub, pail, jar, box, container, lid, tray (e.g., for a food article), blister, clamshell, bottle, pouch, appliance part (e.g., refrigerator liner), pallet, etc.; automotive or aircraft part, such as a dash panel, door panel, utility vehicle bed, etc.; and so forth. In one particular embodiment, the shaped polymeric article may be a packaging article, such as a food packaging article. In particular, because of the materials utilized within the polymeric film structure and barrier layer, the film structure and layer may also pass U.S. Food and Drug Administration guidelines and compliance, in particular for use as a food packaging article.

Furthermore, even with the materials utilized with the polyolefin polymer as disclosed herein, the barrier layer and resulting polymeric film structure may also be recyclable. For instance, when the polyolefin polymer is a polypropylene, utilization of the specific materials as disclosed herein can still allow for the barrier layer and resulting polymeric film structure to be coded as a Class 5 material for recycling purposes.

While embodiments of the present disclosure have been generally discussed, the present disclosure may be further understood by the following, non-limiting examples.

### EXPERIMENTAL

### I. Test Methods

### I.A. Melt Viscosity

Melt viscosity is measured in accordance with ASTM D 3236 (350° F.), using a Brookfield Digital Viscometer (Model DY-III, version 3), and disposable aluminum sample chambers. The spindle used, in general, is a SC-31 hot-melt spindle, suitable for measuring viscosities in the range from 10 to 100,000 centipoise. The sample is poured into the chamber, which is, in turn, inserted into a Brookfield Thermosel, and locked into place. The sample chamber has a notch on the bottom that fits the bottom of the Brookfield Thermosel, to ensure that the chamber is not allowed to turn when the spindle is inserted and spinning. The sample (approximately 8-10 grams of resin) is heated to the required temperature, until the melted sample is about one inch below the top of the sample chamber. The viscometer apparatus is lowered, and the spindle submerged into the sample chamber. Lowering is continued, until the brackets on the viscometer align on the Thermosel. The viscometer is turned on and set to operate at a shear rate which leads to a torque reading in the range of 40 to 60 percent of the total torque capacity, based on the rpm output of the viscometer. Readings are taken every minute for about 15 minutes, or until the values stabilize, at which point, a final reading is recorded.

### I.B. Melt Index

Melt index (I₂, or MI) of an ethylene-based polymer is measured in accordance with ASTM D1238, condition 190° C./2.16 kg. For high I₂ polymers, that is, I₂ is greater than, or equal to, 200 g/mole, melt index is preferably calculated from Brookfield viscosity as described in U.S. Pat. Nos. 6,335,410; 6,054,544; 6,723,810:

I_{2(190° C./216 kg)}=3.6126[10(log(η)−6.6928)/−1.1363]−9.31851, where η=melt viscosity, in cP, at 350° F.

### I.C. Oxygen Transmission Rate

The Oxygen Transmission Rate (OTR) test determines the reduction in oxygen transmission in the rigid films that are used for preparing rigid containers of the present invention.

The OTR is determined at 23° C. and 80% relative humidity according to ASTM D 3985 standard. A suitably sized sample of rigid film is cut on the cutting mat using the MOCON template for the Mocon Oxtran machine. The cut sample is then positioned into the Mocon Oxtran and clamped into position according to the specific machine requirements. The parameter settings are based on industry standard tests. The sample is evaluated until the graph shows a plateau. The test times vary from 8 hours to 70 hours depending on the graph curve. All results are captured in units of cm³/100 in²-day. In one embodiment, the ABA coex shows 10%, 20%, 30%, 40%, 50%, 60%, 70%, 80%, 90%, 100%, and more than 100% improvement in OTR.

TABLE 5
Oxygen Transmission Rate

| | | % OTR Improvement |
|---|---|---|
| Polymeric Sheet | OTR | over Polymer A |
| Polymer A | 146.50 cc-mil/100 | — |
| Random copolymer PP | in²-day | |
| Polymer B | 28 cc-mil/100 in²-day | 80% |
| Modified PP | | |
| 0.020″ A-B-A Coex | 3 cc/100 in²-day | 98% |
| 25/50/25 | (64 cc-mil/100 in²-day) | |
| 0.040″- A-B-A Coex | 1.75 cc/100 in²-day | 99% |
| 33/34/33 | (70 cc-mil/100 in²-day) | |

Data for OTR and Water Vapor Transmission Rate (WVTR or MVTR) for control samples and experimental samples that are extruded, thermoformed, or prepared in an FFS machine, are provided below in Table 6.

TABLE 6
Rigid Packaging Materials Comparison Data

| Calculating OTR and MVTR based | | | |
|---|---|---|---|
| on 0.035″ Starting Gauge | | | |
| | | WVTR or | |
| | OTR; | MVTR | |
| | cc · mil/ | g · mil/ | |
| Materials and Properties | 100 in2/day | 100 in2/day | Structure |

Control Samples

| | | | |
|---|---|---|---|
| HIPS (LOW) | 10 | 0.17 | Monolayer |
| HIPS/EVOH/PE | 0.05 | 0.17 | Monolayer HIPS |
| LAMINATE (HIGH) | | | with EVOH |
| | | | Film Lamination |
| GENERIC PP (LOW) | 6.85 | 0.012 | Monolayer |
| PET (MEDIUM) | 0.29 | 0.17 | Monolayer |

Experimental Samples

| | | | |
|---|---|---|---|
| Modified PP-comprising | 1.0 | 0.0022 | Monolayer |
| layer 1- PP (MEDIUM) | | | |
| Barrier | | | |
| Modified PP-comprising | 0.8 | 0.0022 | Monolayer |
| layer 2 FFS grade | | | |
| Modified PP comprising | 1.0 | 0.0022 | Monolayer |
| layer 3- PP (MEDIUM) | | | |
| Barrier | | | |
| Modified PP-comprising | 12 | 0.007 | Monolayer |
| layer 4 - Barrier and PS | | | |
| replacement | | | |
| Modified PP-comprising | .0.5 | 0.0022 | Monolayer HIPS |
| layer 5/EVOH/PE | | | with EVOH |
| LAMINATE (HIGH) | | | Film Lamination |
| Modified PP-comprising | 0.0025 | 0.0022 | 6 or 8-layer |
| layer 6/EVOH/Modified | | | co-extrusion |
| PP-comprising layer | | | |
| 6COEX (HIGH) | | | |

The barrier enhancement compared to polystyrene and generic polypropylene is improved by more than 10-100%. In the above table, the modified PP-comprising layer 1-6 include one or more nucleating agents described elsewhere.

### I.D. Differential Scanning Calorimetry

Differential Scanning Calorimetry (DSC) measures the heat flow into or out of material as a function of time or temperature. It determines polymer crystallinity, glass transition temperature of an amorphous polymer, and melting temperature for a crystalline polymer, based on the heat required to melt the polymer. DSC is used to measure crystallinity in polyethylene (PE) and polypropylene (PP) based samples, for example.

### I.E. Score and Snap Testing

The score and snap testing are performed on three samples:
1. a 0.040-inch-thick PP/Modified PP-comprising layer/PP rigid sheet;
2. a 0.020-inch-thick PP/Modified PP-comprising layer/Tie/EVOH/Tie/PP plastic sheet; and
3. a 0.040-inch-thick PP/Modified PP-comprising layer/Tie/EVOH/Tie/PP plastic sheet.

Plastic sheets 10 inches in length are used for testing. A narrow and shallow incision up to 0.0045 inch is cut using a disposable plastic scoring knife. The plastic sheet is placed on a work-bench with the incision facing upward and beyond the edge of the work-bench. The overhang is snapped with a quick but consistent moving impact. The incision acts as a guide for fracture propagation throughout the thickness of the sheet, separating it into two pieces with straight and relatively clean edges. The final result is a smooth and clean edged cut in the sheet across its width.

In the table below, the following designation is used:

| | |
|---|---|
| PP 6025N | PP homopolymer |
| PP R01C-00 | PP random copolymer |
| Modified PP | Barrier Polypropylene |
| PX 3838 | Tie layer resin based on Linear, Low-Density |
| | Polyethylene (LLDPE) |
| BX6804B | Ethylene-Vinyl Alcohol Copolymer (EVOH) |

TABLE 8
Score and Snap Tests

| | Material | | Film | | | |
|---|---|---|---|---|---|---|
| No. | Formulation | Film Type | Thickness | Color | Score | Snap |
| 1. | PP 6025N | Monolayer | 0.02 inch | Clear | Shallow | Good |
| | | 100% | | | | |
| 2. | PP R01C-00 | Monolayer | 0.015 inch | Natural | Shallow | Moderate |
| | | 100% | | | | |
| 3. | PP 6025N/Modified | Coextrusion | 0.04 inch | Clear | Shallow | Good |
| | PP 1/PP 6025N | A/B/A:40/20/40 | | | | |
| 4. | PP 6025N/Modified | Coextrusion | 0.04 inch | White | Shallow | Good |
| | PP 2/PP 6025N | A/B/A:40/20/40 | | | | |
| 5. | PP 6025N/Modified | 6-Layer Coextrusion | 0.02 inch | Clear | Shallow | Good |
| | PP 3/PX | 25/42.5/2.5/2.5/2.5/25 | | | | |
| | 3838/BX6804B/PX | | | | | |
| | 3838/6025N | | | | | |

Modified PP 1-3 are different grades of Modified PP described in this disclosure, having one or more different nucleating agents.

### I.F. Polypropylene Single-Serve Cups-Form-Fill-Seal Trials

Three samples are run on a Gabler M60 thermoforming machine to thermoform a container such as a cup or a capsule. to replace PS in current single serve coffee pods. Any barrier film that provides an OTR under 1 cc-mil/100 in²-day is considered as a high to medium barrier material. This example relates to a thermoforming trial on PP/Modified PP-comprising layer/PP at 0.040″ for single serve coffee pods.
(1) Modified PP-comprising layer 3 polypropylene is the experimental barrier PP sample. It comprises an ABA structure, where the A is a PP random copolymer, and the B is MODIFIED PP polypropylene;
(2) Modified PP-comprising layer 2 polypropylene is also an experimental barrier sample. It comprises an ABA structure, where A is PP homopolymer, and the B is MODIFIED PP polypropylene; and
(3) XPTPC polypropylene is an experimental barrier sample. It is talc filled homopolymer of PP with CPS 606 barrier additive in the core layer in four different gauges designed around creamer cup and pudding cup.

Overall, the trial is successful with regards to processing and output. When compared to all the variables, Modified PP-comprising layer 2 shows advantage in terms of FFS process including properties such as shrinkage, ease of forming, and trimming of parts. Note, the Modified PP-comprising layer 2 is made in 0.040″ but not in 0.020″ or 0.045″ thin and thick gauge FFS application as the other samples.

As it relates to the Modified PP-comprising layer 3 sample, the cups look good with clean trim. Punctures are attempted with hot cups but without success, although typically PP single-serve capsules require a minimum of a 24-hour cooling/curing period. As it relates to the Modified PP-comprising layer 2 sample, the cups do not shrink in the mold. As it relates to the XPTPC sample, the cups look good, cloudy from the mineral filler, and the trim is clean. Punctures are attempted with hot cups but without success, although typically PP single-serve capsules require a minimum of a 24-hour cooling/curing period.

In one experiment, the Modified PP-comprising layer 2 is tested in the thin and thick gauge on a fully functional FFS line for a 10 min test under real conditions that includes hydrogen peroxide sterilization, forming, filling, lidding, and trimming of parts. Machine and transverse direction shrinkage is evaluated to determine how the material and machine will react.

### I.G. Extrusion Trial

An ABA coextrusion trial is run at various gauge and width to evaluate the performance of barner-enhanced PP material for conversion into containers on current production thermoforming and form fill seal equipment. Four grades are used for the trial:
(1) Modified PP-comprising layer 1—random copolymer based. This grade is used to evaluate its performance in sheet extrusion as a polystyrene (PS) replacement for running on an FFS to determine scoring and snap-ability utilizing a standard pudding cup.
(2) Modified PP-comprising layer 2—homopolymer based. This grade is used to evaluate its performance in of in sheet extrusion as a target barrier enhancement and as PS material replacement to evaluate performance utilizing the array tray tool.
(3) Modified PP-comprising layer 3—modified random copolymer based. This grade is used to evaluate its performance in sheet extrusion and to form K-Cups on a PS tool to evaluate formability. Barrier performance testing is also conducted on the Modified PP-comprising layer 3 formed sheets.
(4) PP 23H2A—random copolymer.

The trial wis performed on a production scale co extruder for films having a construction of a 25/50/25 or 33/33/33. Standard extrusion parameters are used, but with accommodation for PP.

A finished sheet's gauge or thickness and width are measured using calibrated micrometer and measuring tape with online gauge measurement using Mahlo gauging unit. The following constructions are used.

In the discussions below, XPP polypropylene relates to a resin that includes polypropylene and 50 wt. % or less of a hydrocarbon resin as described in Section IIIH.

TABLE 9

| Trial | Test Material and | Gauge | |
|---|---|---|---|
| No. | Layer Construction | (inches) | Purpose and End Use |
| 1. | Symmetrical A/B/A | 0.040 | Form K-Cups on a PS tool to evaluate formability. |
| | 23H2A//Modified PP- | | Conduct barrier performance testing of the Modified |
| | comprising layer | | PP-comprising layer 3 on the formed cups. |
| | 5/23H2A | | Coffee Pods |
| 2. | Symmetrical A/B/A | 0.045 | Evaluation of Modified PP-comprising layer 1 PP |
| | 23H2A/XPP801/23H2A | | performance as a PS replacement for running on |
| | | | FFS for scoring and snap-ability utilizing a standard |
| | | | pudding cup. |
| | | | Pudding Cup |
| 3. | Symmetrical A/B/A | 0.038 | Evaluation of Modified PP-comprising layer1 |
| | 23H2A/XPP801/23H2A | | performance as a PS replacement for running on FFS |
| | | | for scoring and snap-ability utilizing a standard |
| | | | pudding cup. |
| | | | Pudding Cup |
| 4. | Symmetrical A/B/A | 0.02 | Evaluation of Modified PP-comprising layer |
| | 23H2A/Modified PP- | | 1performance as a PS replacement for running on FFS |
| | comprising layer1/ | | for scoring and snap-ability utilizing a standard |
| | 23H2A | | pudding cup |
| | | | Creamer cups |
| 5. | Symmetrical A/B/A | 0.020 | Produce 2 sample rolls of Modified PP-comprising |
| | 23H2A/Modified PP- | | layer 1as a target PS material replacement to |
| | comprising layer1/ | | evaluate performance utilizing the array tray tool. |
| | 23H2A | | Array Condiment Tray |
| 6. | Symmetrical A/B/A | 0.0175 | Produce 2 sample rolls of Modified PP-comprising |
| | 23H2A/Modified PP- | | layer1 as a target PS material replacement to |
| | comprising layer1/ | | evaluate performance utilizing the array tray tool. |
| | 23H2A | | Array Condiment Tray |
| 7. | Symmetrical A/B/A | 0.0175 | Produce 2 sample rolls of Modified PP-comprising |
| | 23H2A/Modified PP- | | layer2 as a target PS material replacement to |
| | comprising layer2/ | | evaluate performance utilizing the array tray tool. |
| | 23H2A | | Array Condiment Tray |
| 8. | Symmetrical A/B/A | 0.020 | Produce 2 sample rolls of Modified PP-comprising |
| | 23H2A/Modified PP- | | layer2 as a target PS material replacement to |
| | comprising layer2/ | | evaluate performance utilizing the array tray tool. |
| | 23H2A | | Array Condiment Tray |
| 9. | Symmetrical A/B/A | 0.040 | Form K-Cups on a PS tool to evaluate formability. |
| | 23H2A/Modified PP- | | Conduct barrier performance testing of the Modified |
| | comprising layer2/ | | PP-comprising layer 2 on the formed cups to develop |
| | 23H2A | | additional data. |
| | | | Coffee Pods |
| 10. | Symmetrical A/B/A | 0.040 | Produce 2 sample rolls of Modified PP-comprising |
| | 23H2A/Modified PP- | | layer 2 as a target PS material replacement to |
| | comprising layer2/ | | evaluate performance utilizing the array tray tool. |
| | 23H2A | | Pudding Cup |
| 11. | XPTPC.20.001 | 0.038 | Evaluation of proposed filled ABA PP structure as a |
| | A/B/A Symmetrical | | PS replacement for running on FFS for scoring and |
| | Exxon 6282NE2 30% Talc | | snap-ability utilizing a standard pudding cup |
| | “ABA”, 10% Prisma 6810 | | Pudding Cup |
| | “ABA”, 25% CPS 606 “B” | | |
| | layer only | | |
| 12. | XPTPC.20.001 | 0.040 | Evaluation of proposed talc filled ABA PP structure |
| | A/B/A Symmetrical | | to be run on the K-Cup tooling to evaluate shrink |
| | Exxon 6282NE2 30% Talc | | and conduct barrier testing using alternate |
| | “ABA”, 10% Prisma 6810 | | structure components. |
| | “ABA”, 25% CPS 606 “B” | | Coffee Pods |
| | layer only | | |
| 13. | XPTPC.20.001 | 0.020 | Evaluation of proposed filled ABA PP structure as a |
| | A/B/A Symmetrical | | PS replacement to evaluate performance utilizing |
| | Exxon 6282NE2 30% Talc | | the array tray tool. |
| | “ABA”, 10% Prisma 6810 | | Array Condiment Tray |
| | “ABA”, 25% CPS 606 “B” | | |
| | layer only | | |

### II. Additional Examples

### IIA. Examples

In one example, cups are made from roll-stock or rigid sheets of the present invention described in this disclosure. This roll-stock provides barrier and stiffness enhancements over traditional PS and PP for thermoformed and form-fill-seal food and medical packaging. This roll-stock is compatible with processes including: Aseptic, Hot-Fill, Retort, Modified Atmosphere Packaging (MAP), HPP, FFS and FS for a variety of end-use applications. It offers controlled shrinkage and enhanced stiffness for drop-in replacement of PS in thermoformed and FFS food packaging. In one embodiment, it also offers barrier improvements up to 90%/90% OTR/MVTR versus traditional PP and 100%/150% OTR/MVTR versus traditional PS without use of a specialty barrier material or coating. Because of the enhanced stiffness, this material offers down-gauging potential.

In one embodiment, this roll-stock comprises homopolymer PP, which includes at least one layer that comprises at least one grade of the Modified PP resin. In one embodiment, the roll-stock is extruded in thickness range from 0.010″-0.20″ based on customer application. In one embodiment, the roll-stock is white in color. In another embodiment, the roll-stock is natural colored.

### IIB. Example

In another example, cups are made from roll-stock or rigid sheets of the present invention described in this disclosure. This roll-stock provides barrier and stiffness enhancements over traditional PS and PP for thermoformed and form-fill-seal food and medical packaging. This roll-stock is compatible with processes including: Aseptic, Hot-Fill, Retort, Modified Atmosphere Packaging (MAP), HPP, FFS and FS for a variety of end-use applications. In one embodiment, it offers controlled shrinkage and enhanced stiffness for drop-in replacement of PS in thermoformed and FFS food packaging. In one embodiment, it also offers barrier improvements up to 90%/90% OTR/MVTR vs traditional PP and 100%/150% OTR/MVTR vs traditional PS and EVOH layer provides added OTR barrier protection for shelf-stable food packaging.

In one embodiment, this roll-stock comprises homopolymer PP, which includes at least one layer that comprises at least one grade of the Modified PP resin. In one embodiment, the roll-stock is extruded in thickness range from 0.010″-0.20″ based on customer application. In one embodiment, the PP layer comprises the Modified PP layer (the total weight % of PP is 92.5%), with 5% LDPE layer, and 2.5% EVOH layer. In one embodiment, the roll-stock is white in color. In another embodiment, the roll-stock is natural colored. In one embodiment, the PP layer is white. In another embodiment, the PP layer is natural colored. In another embodiment, the roll-stock is made from XPP 803 material grades.

### IIC. Examples—Barrier Polypropylene for Thermoformed and Form-Fill-Seal Food Packaging

### II.C.1. Design

In one aspect, the sheet is a mono-material polypropylene roll-stock that offers enhanced OTR (oxygen transmission rate) and MVTR (moisture vapor transmission rate) barrier without the use of specialty barrier materials or coatings for thermoformed and form-fill-seal food packaging applications.

In one embodiment, the extruded rigid plastic roll-stock of this invention is used in thermoforming and FFS processes for various food packaging applications. However, the barrier Polypropylene roll-stock offers improvements to key performance criteria to achieve key performance requirements, including:
Replacement of PS in food packaging according to Proposition 65 guidelines;
Improved barrier performance;
Improved sustainability and recyclability;
Compatibility with existing equipment and processes; and
Drop-in replacement of polystyrene in form-fill-seal processes.

In one aspect, the package made from the roll-stock of the present invention successfully protects the biological, chemical, and/or physical integrity of the product. Polyolefins naturally possess excellent Moisture Vapor Transmission Rates (MVTR) but require use of barrier materials such as EVOH to achieve the oxygen barrier protection needed for shelf-stable and extended shelf-life food packaging. On the other hand, the polymeric film structures of the present invention deliver a dramatic improvement to both the Oxygen Transmission Rate (OTR) and the MVTR in comparison to other commodity thermoplastic materials—and in some embodiments, even without the use of specialty barrier materials or coatings—offering:
90%/90% improvement to OTR/MVTR vs traditional polypropylene; and
100%/150% improvement to OTR/MVTR vs polystyrene

This improvement to barrier properties allows for the use of polymeric film structures in packaging applications where traditionally functional barrier material such as EVOH or Nylon were the only solution. As a result, material solutions are simplified and thus more easily recyclable. In addition, polypropylene materials offer higher thermal stability than polystyrene and polyethylene terephthalate and allow for use in freezer and microwave applications without compromising the integrity of the product or the packaging.

Packing/Processing Efficiencies: The polymeric film structures of the present invention are produced from polypropylene and therefore offer a 12% density reduction in comparison to PS and a 30% density reduction in comparison to PET. This density reduction results in a higher yield (more parts) during thermoforming processes, lighter-weight parts, less solid waste by weight, and reduced material usage in comparison to PS and PET.

The polymeric film structures of the present invention are advantageous to a package's life cycle, as demonstrated by the following:

### II.C.2. Recyclability

In one aspect, in comparison to other barrier material structures produced from a complex mix of materials, the polymeric film structures of the present invention are produced from polypropylene materials, and can therefore be recycled using the polypropylene Resin ID Code #5. Comparative barrier materials such as HIPS/PVDC must use the Resin ID Code #7, which limits opportunities for recycling and re-use in other applications. In addition, the polymeric film structures of the present invention can be processed like other thermoplastics (without crosslinking) and can thus be recycled easily. The polymeric film structures of the present invention can be recycled multiple times either in a closed loop system or as part of the circular economy without losing its structural integrity. They can therefore be recycled back into various utility applications maintaining its mechanical properties after multiple heat histories.

### II.C.3. Material Reduction

In one aspect, the increased rigidity and stiffness of the polymeric film structures of the present invention not only allow for drop-in processing for polystyrene replacement initiatives, but also present opportunities to down-gauge material structures, resulting in reduced material usage, increased yield, and lighter-weight parts. For example, in one embodiment, the polymeric film structures of the present invention allow for thermoforming using a 0.0175″ roll-stock with comparative barrier results and similar functional and processing characteristics in formed parts as a result of the increased stiffness attributes of the polymeric film structures of the present invention. In comparison, commercial structures used for similar parts are typically produced using 0.020″ high-impact polystyrene (HIPS) roll-stock. This example represents a 12.5% reduction in gauge, which would amount to a potential reduction in use of plastic materials annually, to the tune of hundreds of thousands of pounds. This reduction would be over and above the materials savings that can be potentially realized through material replacement as a result of polypropylene's light weight and low density.

### II.C.4. Performance—Running on Existing Packaging Machinery

In one aspect, the polymeric film structures of the present invention offer enhanced stiffness and controlled shrinkage, allowing for processing on existing thermoforming and FFS platforms, without the need for modifications or additional capital expenditure.

### II.C.5. Controlled Shrinkage

In one aspect, the polymeric film structures of the present invention offer controlled shrinkage allowing for drop-in processing on existing thermoforming and form-fill-seal systems and platforms. This is an inherent characteristic of the material and is accomplished without the use of mineral fillers such as talc or calcium carbonate, thus maintaining the polypropylene density and its ability to sort for subsequent recycling.

### II.C.6. Increased Stiffness

Traditional polystyrene (PS) materials offer flex modulus/stiffness numbers of about 300 KPsi. In comparison, the materials of the present offer over 30% improved stiffness, resulting in a stronger and more rigid film compared to traditional PP and PS. This increase in rigidity and stiffness maintains the “snap-ability” and “scorability” of PS required in certain Form-Fill-Seal multi-pack applications. This key functionality allows for application versatility and the ability to replace traditionally non-recyclable materials such as high-impact polystyrene (HIPS) and polyvinylidene chloride (PVDC) with a fully-recyclable solution without sacrificing functional attributes and processing characteristics.

The polymeric film structures of the present invention that are thin-gauge roll-stock serve as a drop-in material replacement solution for PS in rigid thermoformed and form-fill-seal packaging. They can be successfully prepared on equipment designed for the processing of PS for food packaging applications without significant modifications to existing equipment and platforms.

### II.C.7. Environmental Impact

The global demand for plastic waste reduction and more sustainable packaging solutions, coupled with health and safety concerns as a result of Proposition 65, have resulted in widespread initiatives to replace polystyrene (PS)—the favored material for Form-Fill-Seal processing—in food packaging applications. In one embodiment, the present invention's roll-stock allows for successful transition of food packaging out of PS, replacing it with a sustainable, recyclable and Proposition 65 compliant polymeric film structures of the present invention.

In addition, the low density and lightweight nature of polypropylene allow for a more sustainable packaging, resulting in less solid waste by weight, less CO₂ equivalents by weight, lower fuel consumption, and fewer emissions. Also, enhanced stiffness attribute of the polymeric film structures of the present invention allows for the down-gauging of existing structures, which reduces overall material usage significantly. In addition, the inherent barrier properties of the polymeric film structures of the present invention allow for structure simplification and easier recycling.

In one aspect, the polymeric film structures of the present invention offer inherent barrier improvements in comparison to other commercial packaging materials without the use of mineral fillers or additives. These improvements to barrier properties presents the opportunity to optimize structures and, in some cases, reduce or eliminate the use of additional materials typically found in barrier packaging structures depending on the application.

The polymeric film structures of the present invention comprise polypropylene and therefore can be recycled in the polypropylene recycling stream. The inherent barrier properties of the polymeric film structures of the present invention along with the application versatility of the material allows for an extended shelf-life of commercially packaged food products, and thus the potential to contribute to the longterm goal of reduced waste.

### III. Oxygen Barrier Properties

For gathering the nanoindentation data on a monolayer sample A (regular PP), and monolayer B (comprising the polypropylene 2-layer stack), the testing is conducted with two different geometry tips: one conical, one “berkovich” or a 3-sided pyramid. Some shorter tests (5s-loading, 2s-hold, and 5s-unloading), as well as some longer tests (20s-loading, 30s-hold, 20s-unloading) are also conducted, each to a max load of 1 mN.

In the first step, samples are super-glued to magnetic specimen disks. Then, forty indentations are made, and averages and standard deviations are calculated. Numbers for moduli and hardness at different tip loadings and testing durations are gathered. It should be noted that the conical-tip indentation shows a higher measured hardness. This can be expected because it causes less deformation at lower loads when compared to the sharper berkovich tip.

From the observations, the polymeric film structures of the present invention show higher surface modulus and hardness when compared to the PP and in a statistically significant way.

While not wishing to be bound by theory, the crystallization kinetics of the regular PP (A) and 2-layer stack comprising modified PP (B) are significantly different such that the crystal size and density, and therefore, the microstructure formed during the extrusion of these materials are discernably different. Consequently, this results in different hardness and modulus measurements at the “nano scale” as evidenced from below data. The data also further substantiate the bulk tensile and flex properties obtained on specimens made from PP (A and A′) and XPP (B), which show material differences in modulus, stiffness, and flexural-strength properties between the two materials, A and B. For example, when a sandwich structure A/B/A′ is coextruded with the above materials, the crystallization kinetics—and therefore microstructure of the bulk regions-would have similar performance as shown below and a gradient in properties across the two A/B and B/A′ interface/interphase regions.

From transport phenomena standpoint—and in this case oxygen transmission through the bulk materials A and B and sandwich structure A/B/A—the transport data and barrier data directionally follow the crystallization kinetics and microstructure formed, post-extrusion, of these polymeric film structures.

Material A shows the lowest barrier, which translates to lower % of crystallinity, well-defined larger crystal domains, and lower crystal density.

Material B shows higher barrier owing likely to the nucleating agent, which facilitates rapid crystal formation, higher % crystallinity and higher crystal density and random crystal formation which are not well defined.

Once materials A and B are combined and co-extruded into an A/B/A′ structure, the same dynamic as above plays out, but a “material” difference is evident in the discontinuity and/or the gradient (collectively, “discontinuity”) of properties that occurs at the A/B and B/A′ interfaces. Without wishing to be bound by any theory, it is surmised that the discontinuity going from one type of microstructure to another distinct microstructure disrupts transport phenomena. In essence, this discontinuity causes a more tortuous path for the oxygen molecule moving from a bulk A polymer to an A/B interface/interphase and into the bulk B polymer and subsequently into the B/A′ interphase region and into the bulk A′ polymer. Thus, the A/B/A′ structure has a 2-3× higher barrier performance (oxygen barrier) versus a bulk B specimen.

Technology disclosed here in some embodiments is a fully-recyclable, sustainable functional replacement for EVOH in high-barrier and shelf-stable packaging in the form a mono-polymer polypropylene solution. In one embodiment, this barrier material provides OTR and MVTR protection to offer a replacement for the following multi-layer barrier structures that pose a challenge for recycling including:
Barrier HIPS/PVDC and PS/EVOH/PE
Barrier PET/EVOH and PET/EVOH/PE laminate
Barrier PP/EVOH/PP

This is important to keep food products safe throughout the shelf-life duration, packaging needs to be produced in such a way that it protects the product from oxygen and moisture to prevent oxidation and decay. The “protection” required to achieve a specified shelf-life is measured by the oxygen transmission rate (OTR) and the moisture vapor transmission rate (MVTR) or water vapor transmission rate (WVTR). Commodity plastic materials such as polypropylene, typically possess an inherent degree of OTR/MVTR, but require the use of specialty barrier materials or coatings to achieve the permeability protection required to meet extended shelf-life targets. Common barrier materials include EVOH, which are typically added to the material composition through a process called coextrusion, or PVDC, which is typically added as a coating.

As environmental requirements regarding the prevalence of waste from single-use plastic packaging have become more pressing, brands have made commitments to transition all packaging to fully recyclable, reusable, or compostable by 2025 and that date is fast approaching. The problem is existing barrier structures are not recyclable due to the mix of materials and the inability to separate those materials because of the process. An attempt to recycle these materials would contaminate the recycling stream, therefore packaging made from these materials is sent to the landfill. To combat this, brands have been in search of a solution that meets all barrier performance requirements, in the form of a solution that can be recycled as a mono-material solution to maximize the potential for re-use. The present invention provides a replacement for EVOH and PVDC barrier materials allowing packaging to maintain required barrier protection in the form of a fully-recyclable solution.

This material is compatible with thermoformed and form-fill-seal packaging process and drops-in to existing equipment and machinery without the need for significant equipment modifications or capital investment to overcome financial barriers to achieving material replacement resulting in:
Maintains packaging functionality of current PP, PET, and PS materials;
Drop-in material replacement on existing thermoforming and FFS equipment; and
No loss in cycle time or throughput

This is important for redesigning packaging in a way the prioritizes sustainability and recyclability, while still meeting other critical specifications including packaging function and specifications, process combability and cost, is no simple feat. Solutions need to not only be cost-effective from a price-per-pound perspective, but also must not require the need for significant capital investment to convert FFS lines from running PS to alternative materials such as PET.

Solutions proposed in the past have presented challenges from a processing perspective, and would require significant, and costly, modifications to existing equipment in order to achieve successful processing. This capital investment alone can run upwards of $1 to $1.5 million per line, and multi-national brands can own hundreds of lines, resulting in a significant financial hurdle to adopting the proposed alternative. The present invention allows for a drop-in into existing equipment and machinery, without the need for significant and costly modifications, making the barriers to adopting the present invention much lower. This helps overcome both the “processing” and part of the “cost” hurdles in the equation.

In addition, this mono-polymer polypropylene solution maintains PP density for increased efficiencies, reduced cost and reduced material consumption offering a:
12% yield improvement vs PS structures
30% yield improvement vs PET structures

This is important as the increased yield effects the output of formed parts. Increasing the yield by 12% or 30% means that brands bet 12/30% more parts from the same amount (pounds) of material, which translates to increased output and a lower cost per part. Looked at a different way, if a brand kept output the same, they would need to purchase less material to achieve the same output. Since material is purchased by the pound, this would result in a lower spend on raw materials. This combined with fact that our solutions do not require significant CAPEX, effectively helps brands overcome the “cost” hurdle in the equation.

Suitable applications include:
Yogurt multi-packs (refrigerated and shelf-stable)
Medium barrier snack packs
Baby food (retort and aseptic)
Beverages (shelf-stable FFS)
Component Meal Trays
Condiments (portion-control)
Jams, jellies and sauces (portion-control)
Shelf-stable dairy (including creamers, butter, and margarine)
Snack Packs
Applesauce Cups
Case-Ready Trays
Coffee and tea (pods)
Deli meats and cheeses
Fruit and Produce cups
On-the-go cups
Pet Food (wet)
RTH Meal Trays
Salad Dressing Cups
Soup Tubs
Oxygen barrier for food, pharma, and household/personal care

This invention relates to the following industries:
Food and Food service packaging
Medical Packaging
Automotive applications
   This invention relates to the following technology or products:
Barrier and non-barrier plastics sheet
Barrier and non-barrier plastics roll-stocks
Barrier and non-barrier plastics die cut material form.

In one embodiment, this invention relates to custom sheet extrusion company specializing in high efficiency, tight tolerance, thin gauge thermoplastic polyolefins and polystyrenics barrier and non-barrier extruded, laminated, and coextruded plastic sheet and roll stock optimized to improve operating efficiencies for thermoforming applications in the food packaging, medical packaging, cosmetics packaging and display, automotive and custom thermoforming industries.

The invention a high barrier polypropylene material in conjunction with high barrier polymeric compound solution, which is designed for but not limited to the food and food service packaging and medical packaging industry segment to replace functional barrier material such as Ethylene Vinyl Alcohol (EVOH), Nylon (all types), and other similar materials in a multilayer coextruded structures made using Polystyrene (PS and HIPS), Polyethylene Terephthalate (PET, APET, CPET, RPET), Polylactic Acid (PLA), traditional Polypropylene (PP, homopolymer and copolymer), Polyethylene (HDPE, LDPE, LLDPE), etc. to offer a material that is highly functional (performance), convenient, sustainable, economical in cost and compatible with existing lamination, printing, thermoforming and form-fill-seal process.

This invention relates to a high barrier coextruded XPP/APEX and processing for rigid applications. High Barrier coextruded XPP/APEX and processing for rigid applications is designed and formulated. In one or more embodiments, the polymeric body is selected from the group consisting of a packaging film, a film for packaging food, a film for packaging pharmaceutical or healthcare products, a lidding film, an agricultural film, an industrial film, a tubing, a pipe, a cap, a closure, a film for silage, a film for fumigation or mulch, a three dimensional body, a container, a bottle, a pouch, a tank, and a package for food, beverage or for an industrial, pharmaceutical or cosmetic product.

The invention of coextruded XPP/APEX and processing for rigid applications is designed for but not limited to the food and food service packaging and medical packaging industry segment to replace functional barrier material such as Ethylene Vinyl Alcohol (EVOH), Nylon (all types), and other similar materials in a multilayer coextruded structures made using Polystyrene (PS and HIPS), Polyethylene Terephthalate (PET, APET, CPET, RPET), Polylactic Acid (PLA), traditional Polypropylene (PP, homopolymer and copolymer), Polyethylene (HDPE, LDPE, LLDPE), etc. to offer a material that is highly functional (performance), convenient, sustainable, economical in cost and compatible with existing lamination, printing, thermoforming and form-fill-seal process to offer a material that is
Highly functional—offers oxygen transmission rate and moisture vapor transmission rate by 80% when coextruded with XPP material enhanced Barrier Polypropylene PP and up to 90% against polystyrene with similar and/or better barrier than traditional EVOH functional barrier material in a coextruded structure.
Convenient—with reference to processing the material on existing equipment designed for traditional Polypropylene or polystyrene with reduced shrinkage. High barrier XPP/APEX layer can be extruded on standard single stage metering screw with full flights.
Sustainable—a light-weight material supply chain with high recycling capability compared to other traditional thermoplastics barrier resins with high density,
Cost effective high barrier product for extended shelf life, and
Compatible with existing lamination, printing, thermoforming, and form-fill-seal process.

### APEX Barrier Polymeric Material—Resin RR1

By APEX material or APEX polymeric material is meant a barrier polymeric material that creates a layer-like morphology after extrusion as a monolayer film in a multilayer coextruded structure. The APEX polymeric material is generally biphasic or triphasic or multiphasic. Stated differently, in one embodiment, it comprises a blend of two polymeric materials that is generally immiscible, but also miscible in some cases, wherein at least one phase is dispersed in another phase, with an optional presence of a compatibilizer. The non-dispersed phase is the structural phase that provides mechanical integrity and barrier properties to some extent. The dispersed phase provides the barrier properties.

There are two main points of the present invention's high-barrier coextruded XPP/APEX films and their processing for rigid applications.

Functional barrier requirements and processability for secondary converters:
1) Functional barrier requirements—Prior to the invention and development of barrier-enhanced polypropylene, material engineers and formulators had no choice but to choose a high cost, high density barrier material such as EVOH or polyamide/nylon (PA, PA6, PA66) that is then used with traditional substrate material such as polystyrene and polypropylene either as a lamination or multi-layer coextrusion process. This can now be manufactured using a similar extrusion process to achieve a barrier that is similar or higher compared to traditional Nylon or EVOH barrier material layer substrates.
2) Processability—Polystyrene (PS) is an amorphous thermoplastic polymer that has high mechanical strength, lower shrinkage rate, and a wide processing window. It is considered as the standard material for commodity products and packaging application for its ease of processing be it with injection molding or extrusion/thermoforming/form fill seal processing. Polypropylene (PP) is a semi crystalline thermoplastic polymer that has good mechanical properties, high heat and chemical resistance but has much higher shrinkage rate with narrow processing window. With the focus on applications using extrusion, thermoforming, and form fill seal processing techniques, it is hard to beat and compete against PS as PP requires auxiliary heating and cooling and shrinks at a higher rate, but the present invention's high barrier monomaterial-Polypropylene is designed around the idea and thought to be processing similar to PS with low shrinkage rate. Extrusion and thermoforming/FFS trials proves and provides more factual data as to how it processed against traditional PS and PP.
   Exemplary Material—here XPP is Resin RB1
PP/XPP/EVOH/PP—3.5% barrier layer or 0.0014″ EVOH layer in a 0.040″ starting sheet thickness.
PP/XPP/APEX/PP—1.8% barrier layer or 0.00075″ APEX layer in a 0.040″ starting sheet thickness.

In one embodiment of the APEX material, in an extruded films of the blended biphasic composition, having different morphologies, when the cross-sections are viewed at/from a plane transverse to the direction of extrusion, it has a miscible blend morphology in which a first phase that comprises relatively small and discrete domains is present within the second phase, the non-dispersed phase. In some embodiment of the APEX materials, the cross-section shows a rodlike morphology of the first phase that comprises discrete domains that are relatively elongated (such as, for example, flattened rods or plank domains) within the second phase, that is the structural phase. In another embodiment, the film has a layer-like morphology in which the first phase is present within the non-dispersed or the second phase. In another embodiment, a coextruded film has a layered/multilayered morphology, in which a first phase is present as a discrete layer adjacent the second phase/discrete layer in the biphasic APEX material. Finally, in one embodiment, the film illustrates a co-continuous morphology, in which a first phase and the second phase are present, and no obvious matrix or dispersed phase can be differentiated (or each phase/both phases can be regarded as a matrix phase). Note that, although two phases are described herein for purposes of illustration, one or more embodiments may comprise three or more phases. That is, nothing disclosed herein should be viewed as limiting the embodiments to two phases. In the APEX material layer context, the term “barrier polymer” shall mean any polymer having a low permeability to one or more permeants of interest. In one or more embodiments, the permeant of interest is oxygen. In other embodiments, the permeant could be, for example, carbon dioxide, nitrogen, and other gases and vapors.

In the APEX material layer context, the term “structural polymer” shall mean any polymer that is provided primarily for a mechanical or structural property, such as density, hardness, tear resistance, impact resistance, sealability, printability, and machinability. A structural polymer may have good barrier properties; however, in an embodiment having a barrier polymer with a low permeability to a particular permeant of interest, the structural polymer will have a higher permeability with regard to the permeant of interest than the barrier polymer. Generally, and in one embodiment, the structural polymer is the non-dispersed phase in a blend of the bi-phasic material.

As used herein, the term “polymer blend” and similar terms shall mean a composition containing two or more polymers, which may or may not be miscible. Blends are not laminates, but one or more layers of a laminate may contain a blend.

A functionalized polyolefin is a polyolefin provided with functionality, such as polar functionality, through copolymerization or post polymerization grafting. Such functionality is typically brought by providing chemically functional, active, and/or reactive side groups to the polymer back bone, such as oxygen, halogen and/or nitrogen containing functional groups. As used herein, the term shall also mean that the functionalized polyolefin acts as a compatibilizer for the polymer blend in which it is incorporated.

As used herein, the term “compatibilizer” generally means any additive for polymer systems (e.g., polymer blends) that stabilizes the system by, for example, improving the adhesion between the two or more phases or constituents of the polymeric system.

The APEX material comprises from 30 to 70 weight percent of a structural polymer, from 30 to 70 weight percent of a barrier polymer and from about 3 to about 10 weight percent of functionalized polyolefin, which can act as a compatibilizer.

Stated differently, the structural polymer weight percent in the APEX material is any one number selected from the following, or a number included within a range defined by any two numbers from the following numbers including the endpoints of such a range, in terms of percent weight:

30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, and 70.

Similarly, the barrier polymer weight percent in the APEX material is any one number selected from the following, or a number included within a range defined by any two numbers from the following numbers including the endpoints of such a range, in terms of percent weight:

30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, and 70.

Similarly, the compatibilizer or functionalized polyolefin weight percent in the APEX material is any one number selected from the following, or a number included within a range defined by any two numbers from the following numbers including the endpoints of such a range, in terms of percent weight:

3, 4, 5, 6, 7, 8, 9, and 10.

### Structural Polymers of the APEX Material

In one or more particular embodiments of any of the foregoing, the structural polymer is selected from a group consisting of polyolefins, polyesters, polystyrene, polylactic acid, polyhydroxyalkanoate (PHA) and combinations thereof, and the barrier polymer is selected from a group consisting of copolymers of ethylene vinyl alcohol, polyvinyl alcohol, polyvinylidene chloride, polyamides, nitrile polymers and combinations thereof. More particularly, the structural polymer comprises a polyolefin and the barrier polymer comprises a copolymer of ethylene vinyl alcohol.

In a particular embodiment, the polyolefin is selected from a group consisting of polyethylene, polypropylene, copolymers of ethylene with one or more alpha-olefins or copolymers of ethylene with one or more vinyl esters, copolymers of polyethylene or polypropylene, or combinations thereof. In a particular embodiment, the polyolefin comprises a low-density polyethylene, a linear low-density polyethylene, a medium density polyethylene, a high-density polyethylene, an ethylene vinyl acetate, an ethyl methyl acrylate, an ethylene butyl acrylate, or a polypropylene homopolymer, bipolymer or terpolymer, or combinations thereof.

In a particular embodiment, the overall film can be uniaxially or biaxially stretched.

Polyolefins used herein in the APEX material context also generally include polymers (including biopolymers) formed from a simple olefin (with the general formula CₙH₂ₙ) as a monomer, and includes both homopolymers and copolymers, (e.g., bipolymers, terpolymers, etc.), and blends thereof. In addition, they include polymers of ethylene (i.e., polyethylene), which include LDPE, LLDPE, MDPE, HDPE, copolymers of ethylene with one or more alfa-olefins, copolymers of ethylene with a vinyl ester comonomer, and blends thereof. They also include polymers of propylene (i.e., polypropylene), copolymers (e.g., bipolymers, terpolymers, etc.) of propylene with one or more alfa-olefins, and blends of different polyolefins.

The structural polymer(s) may be one or more polyolefins, one or more ionomers, polycarbonates, polyesters (including polylactic acids and polyhydroxyalkanoate (PHA)) and/or styrenic polymers and/or styrenic copolymers, including any such biopolymers, bio-based polymers biodegradable or compostable polymers. Polyolefins have been found to be particularly suitable for use as the structural polymer(s). Suitable polyolefins may generally be any olefin homopolymer or any copolymer of an olefin and one or more comonomers. The polyolefins may be atactic, syndiotactic or isotactic. The olefin may be a mono olefin or a diolefin. Mono olefins include ethylene, propylene, 1-butene, 1-pentene, 1-hexene, 4-methyl-1-pentene and 1-octene, as well as cycloolefins, such as cyclopentene, cyclohexene, cyclooctene and norbornene. Diolefins include butadiene (such as 1,3-butadiene), 1,2-propadiene, 2-methyl-1,3-butadiene, 1,5-cyclooctadiene, norbornadiene, dicyclopentadiene, 1,3-heptadiene, 2,3-dimethylbutadiene, 2-ethyl-1,3-pentadiene, 1,3-hexadiene and 2,4-hexadiene. Most suitably, the olefin is an alpha-olefin. The comonomer if present is different from the olefin and is chosen such that it is suitable for copolymerization with the olefin. The comonomer may also be an olefin as set forth above. Comonomers may include ethylene, propylene, 1-butene, 4-methyl-1-pentene, 1-hexene, 1-octene, 1-decene, 1-dodecene, 1-tetradecene, 1-hexadecene and 1-octadecene. Further examples of suitable comonomers may include vinyl esters, vinyl acetates, vinyl acrylates, and acid copolymer monomers.

Non-limiting examples of polyolefins that may be used as the structural polymer(s) include polymers of ethylene, such as ultralow density polyethylene (ULDPE), low density polyethylene (LDPE), linear low-density polyethylene (LLDPE), medium density polyethylene (MDPE), high density polyethylene (HDPE), high melt strength high density polyethylene (HMS-HDPE), ultrahigh density polyethylene (UHDPE), and combinations thereof. Also suitable for use are copolymers of ethylene with one or more alpha-olefins and copolymers of ethylene with a vinyl ester or acid copolymers. Blends of the foregoing ethylene polymers and copolymers are also suitable. Examples may include ethylene vinyl acetate (EVA), ethylene butyl acrylate (EBA), ethyl methyl acrylate (EMA), and ethylene/acrylic acid (EAA) copolymers, ethylene/methacrylic acid (EMAA) copolymers, such as ethylene, methyl acrylate and glycidyl methacrylate, etc.

### Barrier Polymers for the APEX Material

The barrier polymer(s) in the barrier masterbatch may include one or more EVOH copolymers, one or more polyvinyl alcohol (PVOH), polyamides, polyvinylidene chloride (PVDC), fluoropolymers like polytetrafluoroethylene (PTFE) or polyvinylidene fluoride (PVDF), cyclic olefin copolymers (COC), one or more nitrile polymers, like polyacrylonitrile (PAN), and/or liquid crystal polymers (LCP).

EVOH is a copolymer of ethylene and vinyl alcohol and is formed by polymerizing ethylene and vinyl acetate to form ethylene vinyl acetate (EVA), which is then hydrolyzed. Typically, EVOH with lower ethylene content has higher barrier properties. A suitable EVOH for use in the barrier masterbatch has an ethylene content of at least 24 mole %, more suitably from 27 mole % to about 55 mole % ethylene, more suitably from 27 mole % to about 44 mole %.

Polyamides that may be used as barrier polymer(s) may be homopolymers and/or copolymers and may be aliphatic and/or aliphatic/aromatic. Exemplary and useful polyamides include poly(6-aminohexanoic acid) (nylon 6, also known as poly(caprolactam), poly(hexamethylene adipamide)(nylon 6,6) and polyamides produced through polycondensation of meta-xylylene diamine (MXDA) with adipic acid, such as poly(m-xylylene adipamide) (MXD6).

Nitrile polymers that may be used as barrier polymer(s) include acrylonitrile-methyl acrylate copolymers, acrylonitrile-styrene copolymers, acrylonitrile-indene copolymers; and homo and copolymers of methacrylonitrile. Commercially available nitrile polymers include the BAREX line of polymers available from Ineos Olefins and Polymers USA, which are acrylonitrile-methyl acrylate copolymers.

### Compatibilizer for the APEX Material

The functionalized polyolefin compatibilizer may be a copolymer of ethylene and/or propylene and one or more unsaturated polar monomers, which may include: C₁ to C₈ alkyl (meth)acrylates, such as methyl, ethyl, propyl, butyl, 2-ethylhexyl, isobutyl and cyclohexyl (meth)acrylates; unsaturated carboxylic acids, their salts and their anhydrides, such as acrylic acid, methacrylic acid, maleic anhydride, itaconic anhydride and citraconic anhydride; unsaturated epoxides, such as aliphatic glycidyl esters and ethers such as allyl glycidyl ether, vinyl glycidyl ether, glycidyl maleate and glycidyl itaconate, glycidyl acrylate and glycidyl methacrylate, and also alicyclic glycidyl esters and ethers; and vinyl esters of saturated carboxylic acids, such as vinyl acetate, vinyl propionate and vinyl butyrate. Examples of functionalized polyolefin compatibilizers formed by copolymerization include ethylene/acrylic acid (“EAA”) copolymers and ethylene/methacrylic acid (“EMAA”) copolymers. Commercially available functionalized polyolefins formed by copolymerization include: PRIMACOR resins available from the Dow Chemical Company, which are EAA copolymers; NUCREL resins available from E. I. du Pont de Nemours and Company, which are EMAA resins; and LOTADER 8900 available from the Arkema Group, which is a terpolymer of ethylene, methyl acrylate and glycidyl methacrylate.

The functionalized polyolefin compatibilizer may also be an acid or acid anhydride modified polyolefin obtained by modifying a polyolefin, such as a polyethylene or a polypropylene, with an unsaturated carboxylic acid, such as acrylic acid, methacrylic acid, maleic acid, maleic anhydride, fumaric acid or itaconic acid. Combinations of different types of chemically modified polyolefins may also be used. Particularly suitable is a polyethylene and/or a polypropylene that is/are graft-modified with a maleic acid or a maleic anhydride. An example of a commercially available acid anhydride modified polyolefin includes Orevac 18360, which is available from the Arkema Group. Orevac 18360 is a maleic anhydride modified LLDPE having a density of 0.914 g/cm3 and a melt temperature of 120° C. Another example of a commercially available acid modified polyolefin includes Orevac CA 100, which is available from the Arkema Group. Orevac CA 100 is a maleic anhydride modified polypropylene having a density of 0.905 g/cm³ and a melt temperature of 167° C. Still another example of a commercially available acid modified polyolefin includes Exxelor PO 1015, which is available from ExxonMobil Chemical. Exxelor PO 1015 is a maleic anhydride functionalized polypropylene copolymer.

APEX material was purchased from LyondellBasell Co. under the product name BAR with its various grades as identified in the examples below. A further description of the APEX material is provided in the U.S. patent publication US20200307056A1, in which such biphasic systems are discussed, and which is incorporated by reference herein.

Sheets and thermoformed packages were made in a multilayer extrusion that comprised an XPP layer, and a APEX material layer as described below. Barrier properties improve for the sheet and the package when the invention is comparted with the standard barrier layer of EVOH.

In one embodiment, the thickness of the APEX layer in a multilayer coextruded structure is maintained under 0.001″ which could theoretically reduce the amorphous region and use material's crystalline structure as shield against gas barrier. It is also speculated that the thermoforming process enhances the barrier properties of coextruded APEX package/material by orienting chains in the backbone.

In one embodiment, the thickness of the APEX layer is less than 15 microns. In another embodiment, the thickness of the APEX layer is selected from any one of the numbers below, including a number within a range defined by any two numbers below, including the endpoints of such a range, in terms of microns:

5, 6, 7, 8, 9, 10, 11, 12, 13, 14, and 15.

In one embodiment, the thickness of the APEX layer is less than 75 microns. In another embodiment, the thickness of the APEX layer is selected from any one of the numbers below, including a number within a range defined by any two numbers below, including the endpoints of such a range, in terms of microns:

5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, and 75.

Sustainability and economics have historically been at odds, but provides enhancements to key performance attributes allowing sustainability and cost savings to coexist. For example, in one embodiment, the films of the present invention provide enhanced stiffness, resulting in an improved flex modulus of 400,000-500,00 PSI compared 300,000 PSI for PS, 425,00 PSI for PET and 175,000-275,000 PSI for traditional polypropylene depending on the grade.

This results in a material that behaves similarly to PS and PET in thermoforming and form-fill-seal allowing for processing on existing equipment and tooling with minimal setting adjustments, equipment modifications and no loss in cycle-times or through-put. As a polypropylene-based structure, the reduced density also results in a 12% yield advantage vs PS and a 30% yield advantage vs PET, resulting in a more efficient use of resources and cost savings:
1,000,000 lbs PP=1,120,000 lbs PS
1,000,000 PP=1,300,000 lbs PET

This enhanced stiffness of the present invention also allows for down-gauging existing polypropylene structures. Down-gauging is a commonly used method in the extrusion-thermoforming and form-fill-seal industries in which the gauge or thickness of the roll-stock structure is decreased to reduce material consumption, improve sustainability, and control cost. Typically, there are limitations regarding how much the material structure can be down-gauged before seeing reduced performance or failure in the thermoformed part. However, the enhanced stiffness of the films of the present invention allows for increased down-gauging of existing polypropylene structures without compromise to part performance. Initial testing has shown a 10-15% weight reduction with a down-gauged structure of the present invention.

### Example Trial Set I

Extrusion trials were conducted with the layer structure given below. The APEX material comprised the BAR 2700 resin purchased from Lyondellflasell Chemical Co. Pudding cups were thermoformed from extruded sheet material comprising a layer of the APEX material.

TABLE I-A

Pudding Cup Case Study-Formed Cups

| | | | | OTR Result at 23° C.; 0% or | | |
|---|---|---|---|---|---|---|
| Sample | | | | Room RH conditions | | |
| No. | Material | Formulation | Type | cc/pkg · day | cc/m² · day | cc/100 in² · day |
| 1 | PP/XPP/EVOH/PP | EVOH 1.4 mils | Package | 0.49 | 49.00 | 3.16 |
| 2 | | or 3.5% | | 1.72 | 172.00 | 11.10 |
| Average | | | | 1.11 | 110.50 | 7.13 |
| 1 | PP/XPP/APEX | APEX | Package | 0.87 | 87.00 | 5.61 |
| 2 | I/PP | 0.75 mils or | | 0.92 | 92.00 | 5.94 |
| 3 | | 1.80% | | 0.80 | 80.00 | 5.16 |
| 5 | | | | 0.88 | 88.00 | 5.68 |
| 7 | | | | 0.91 | 91.00 | 5.87 |
| Average | | | | 0.96 | 89.50 | 5.77 |
| 4 | | | | 1.68 | 168.00 | 10.84 |
| 6 | | | | 2.42 | 242.00 | 15.61 |
| 8 | | | | 1.38 | 138.00 | 8.90 |

Pudding Cup Case Study-Sheet Sample

| Sample | | | | OTR Result at 23° C.; 0% or Room RH conditions | |
|---|---|---|---|---|---|
| # | Material | Formulation | Type | cc/m² · day | cc/100 in² · day |
| 1 | PP/XPP/EVOH/PP | EVOH 1.4 mils | Sheet | 31.00 | 2.00 |
| 2 | | or 3.5% | | 34.00 | 2.19 |
| Average | | | | 32.50 | 2.10 |
| 1 | PP/XPP/APEX | APEX | Sheet | 59.00 | 3.81 |
| 2 | I/PP | 0.75 mils or | | 27.00 | 1.74 |
| | | 1.80% | | | |

| | | |
|---|---|---|
| Average | 43.00 | 2.77 |

| | | | | | Sur- | | |
|---|---|---|---|---|---|---|---|
| Sample | | | | | face | | |
| # | Material | Formulation | Type | cc/pkg · day | Area | CC/m2 · day | cc/100 in2 · day |
| 1 | PP/XPP/APEX | APEX0.75 mils | Package | 0.900 | 0.010 | 90.000 | 5.806 |
| | I/PP | or 1.80% | | | | | |
| 2 | PP/XPP/PP | XPP 30% | | 0.830 | 0.006 | 138.333 | 8.925 |

Sheets extrusion trials were conducted and thermoformed into an array tray package as part of the forming trial. OTR results for APEX versus EVOH were found to be very comparable. The APEX I material comprised the BAR 2700 material from Lyondell-Basell. The APEX II material comprised the BAR 6700 grade also from Lyondell-Basell.

TABLE I-B
Sheet OTR Test Data

| | | APEX OTR- cc/100 |
|---|---|---|
| | APEX layer | inch² · day 23° C., |
| Trial | thickness/inches | 0% RH, 100% oxygen |
| #1: 0.020″ PP/APEX I/PP | 0.0010 | 0.0585 |
| #2: 0.020″ PP/APEX I/PP | 0.0013 | 0.2910 |
| #3: 0.020″ PP/APEX II/PP | 0.0010 | 0.2290 |
| #4: 0.020″ PP/APEX II/PP | 0.0013 | 0.2613 |
| #5 PP/XPP/EVOH/PP 0.020″ | 0.0008 | 0.0160 |
| PP/XPP/APEX I/PP 0.020″ | 0.0006 | 0.0151 |
| PP/XPP/APEX II/PP 0.020″ | 0.0008 | 0.1550 |

TABLE I-C
OTR Package results from the above sheet extrusion trial- #1 to #5.

| | | | OTR result | | |
|---|---|---|---|---|---|
| | | | cc/ | cc/m² · | cc/100 |
| Material | Formulation | Type | pkg · day | day | in² · day |
| PP/XPP/EVOH/PP | EVOH 0.8 mil or 4%\| XPP 42.5% | Package Array tray | 0.41 | 82 | 5.29 |
| PP/XPP/APEX/PP | APEX I 1 mil | Package Array tray | 1.28 | 256 | 9.68 |
| PP/XPP/APEX/PP | APEX I 1.3 mil | Package Array tray | 0.39 | 78 | 5.03 |
| PP/XPP/APEX/PP | APEX II 1 mil | Package Array tray | 0.59 | 118 | 7.61 |
| PP/XPP/APEX/PP | APEX II 1.3 mil | Package Array tray | 0.93 | 186 | 7.74 |

TABLE I-D
OTR results on 0.040″ extruded sheet and formed pudding cup.

| | | First Mocon | Second Mocon | MOCON STANDARD | |
|---|---|---|---|---|---|
| Part | Material Structure | Test Results | Test Results | Test Results | |
| Pudding | PP/XPP/EVOH/PP | na | 0.07 cc/m2 · day | na | |
| Sheet | PP/APEX I/XPP/PP | na | 6.09 cc/m2 · day | na | |
| Pudding | PP/XPP/EVOH/PP | 0.49 cc/pkg · day | 0.32 cc/pkg · day | 0.00491 | cc/pkg · day |
| cups | PP/APEX I/XPP/PP | 1.33 cc/pkg · day | 0.56 cc/pkg · day | 1.2 | cc/pkg · day |

### Example Trial Set II

### OTR Test Data for 29 Mol % EVOH Barrier Laver Versus APEX Material Barrier Laver

Formulations of the extruded sheets arranged in extruded layers are provided as Samples 1-10 in Table A1. Results of the oxygen transmission rate testing (OTR) of the sample sheets and packaged materials such as cups and trays, including the control samples with EVOH as barrier layer versus the invention samples that included the APEX material as the barrier layer are provided in Table A2 below. The APEX I material comprised the BAR 2700 material from LyondellBasell. In one embodiment, the present invention focused on medium barrier films where the EVOH layer (control) is 12.5 μm or under. It was also observed that the APEX layer of 0.0016″ for apple sauce cups was too thick which, it is speculated, created a larger amorphous region at molecular level and thus opening or reducing the overall barrier morphology or OTR barrier properties.

The extruded sheets and the thermoformed parts using the current invention produced comparable results as the control samples. It was surprisingly found that the invention allowed for a thinner gauge of the APEX barrier layer, which allows for thinner gauge overall structures, for example, with a layer of APEX at 10 μm or under. Post stretching/thermoforming, the OTR results variance between EVOH and APEX was observed to be under 5%.

TABLE A1
Formulations of the Extruded Sheets for Thermoformed Samples

| | | |
|---|---|---|
| Gauge tolerance = −/+ 0.001″ | | |
| Width tolerance = −/+ 0.125″ | GAUGE | LAYER |

| | | | |
|---|---|---|---|
| E | LAYERS | MIL | WEIGHT % |

Sample 1- APPLESAUCE CUPS 0.045″ ×
14″—EVOH 1.8 MIL

| | | | |
|---|---|---|---|
| A | 80/20 22N2A/MP 1175 | 14.6 | 32.44 |
| B | 50/50 22N2A/MP 1175 | 13 | 28.89 |
| D | PX6002 | 0.5 | 1.11 |
| E | EVOH BX6804B | 1.8 | 4 |
| D | PX6002 | 0.5 | 1.11 |
| C | 80/20 22N2A/MP 1175 | 14.6 | 32.44 |

| | | |
|---|---|---|
| TOTAL | 45 | 100 |

Sample 2- APPLESAUCE CUPS 0.045″ ×
14″—APEX I 1.8 MIL

| | | | |
|---|---|---|---|
| A | 80/20 22N2A/MP 1175 | 14.6 | 32.44 |
| B | 50/50 22N2A/MP 1175 | 13 | 28.89 |
| D | PX6002 | 0.5 | 1.11 |
| E | APEX I | 1.8 | 4 |
| D | PX6002 | 0.5 | 1.11 |
| C | 80/20 22N2A/MP 1175 | 14.6 | 32.44 |

| | | |
|---|---|---|
| TOTAL | 45 | 100 |

SAMPLE 3- PC CREAMER CUP/ARRAY TRAY
0.020″ × 14″ EVOH 0.5 MIL

| | | | |
|---|---|---|---|
| A | 80/20 22N2A/MP 1175 | 6.5 | 32.5 |
| B | 50/50 22N2A/MP 1175 | 6 | 30 |
| D | PX6002 | 0.5 | 2.5 |
| E | EVOH BX6804B | 0.5 | 2.5 |
| D | PX6002 | 0.5 | 2.5 |
| C | 80/20 22N2A/MP 1175 | 6 | 30 |

| | | |
|---|---|---|
| TOTAL | 20 | 100 |

SAMPLE 4- PC CREAMER CUP/ARRAY TRAY
0.020″ × 14″ APEX I 0.5 MIL

| | | | |
|---|---|---|---|
| A | 80/20 22N2A/MP 1175 | 6.5 | 32.5 |
| B | 50/50 22N2A/MP 1175 | 6 | 30 |
| D | PX6002 | 0.5 | 2.5 |
| E | APEX I | 0.5 | 2.5 |
| D | PX6002 | 0.5 | 2.5 |
| C | 80/20 22N2A/MP 1175 | 6 | 30 |

| | | |
|---|---|---|
| TOTAL | 20 | 100 |

SAMPLE 5- PC CREAMER CUP/ARRAY TRAY
0.020″ × 14″ EVOH 1 MIL

| | | | |
|---|---|---|---|
| A | 80/20 22N2A/MP 1175 | 6 | 30 |
| B | 50/50 22N2A/MP 1175 | 6 | 30 |
| D | PX6002 | 0.5 | 2.24 |
| E | EVOH BX6804B | 1 | 5 |
| D | PX6002 | 0.5 | 2.24 |
| C | 80/20 22N2A/MP 1175 | 6 | 30 |

| | | |
|---|---|---|
| TOTAL | 20 | 100 |

SAMPLE 6- PC CREAMER CUP/ARRAY TRAY
0.020″ × 14″ APEX I 1 MIL

| | | | |
|---|---|---|---|
| A | 80/20 22N2A/MP 1175 | 6 | 30 |
| B | 50/50 22N2A/MP 1175 | 6 | 30 |
| D | PX6002 | 0.5 | 2.24 |
| E | APEX I | 1 | 5 |
| D | PX6002 | 0.5 | 2.24 |
| C | 80/20 22N2A/MP 1175 | 6 | 30 |

| | | |
|---|---|---|
| TOTAL | 20 | 100 |

SAMPLE 7- CASE READY TRAY
0.025 × 30.625—EVOH 0.5 MIL

| | | | |
|---|---|---|---|
| A | 80/20 22N2A/MP 1175 | 8 | 32 |
| B | 50/50 22N2A/MP 1175 | 7.5 | 30 |
| D | PX6002 | 0.5 | 2 |
| E | EVOH BX6804B | 0.5 | 2 |
| D | PX6002 | 0.5 | 2 |
| C | 80/20 22N2A/MP 1175 | 8 | 32 |

| | | |
|---|---|---|
| TOTAL | 25 | 100 |

SAMPLE 8- CASE READY TRAY
0.025 × 30.625—APEX I 0.5 MIL

| | | | |
|---|---|---|---|
| A | 80/20 22N2A/MP 1175 | 8 | 32 |
| B | 50/50 22N2A/MP 1175 | 7.5 | 30 |
| D | PX6002 | 0.5 | 2 |
| E | APEX I | 0.5 | 2 |
| D | PX6002 | 0.5 | 2 |
| C | 80/20 22N2A/MP 1175 | 8 | 32 |

| | | |
|---|---|---|
| TOTAL | 25 | 100 |

SAMPLE 9- CASE READY TRAY
0.025 × 30.625—EVOH 1 MIL

| | | | |
|---|---|---|---|
| A | 80/20 22N2A/MP 1175 | 8 | 32 |
| B | 50/50 22N2A/MP 1175 | 7 | 28 |
| D | PX6002 | 0.5 | 2 |
| E | EVOH BX6804B | 1 | 4 |
| D | PX6002 | 0.5 | 2 |
| C | 80/20 22N2A/MP 1175 | 8 | 32 |

| | | |
|---|---|---|
| TOTAL | 25 | 100 |

SAMPLE 10- CASE READY TRAY
0.025 × 30.625—APEX I 1 MIL

| | | | |
|---|---|---|---|
| A | 80/20 22N2A/MP 1175 | 8 | 32 |
| B | 50/50 22N2A/MP 1175 | 7 | 28 |
| D | PX6002 | 0.5 | 2 |
| E | APEX I | 1 | 4 |
| D | PX6002 | 0.5 | 2 |
| C | 80/20 22N2A/MP 1175 | 8 | 32 |

| | | |
|---|---|---|
| TOTAL | 25 | 100 |

TABLE A2
OTR Results of the Control Samples and the Invention Samples
EVOH VS APEX I BARRIER LAYER TESTING

| | | | | | | | PACKAGE OTR | |
|---|---|---|---|---|---|---|---|---|
| | | | | | | | CC/PKG.DAY | |
| | | | | | | | 23° C./0% RH | |
| | | | | | | | OR ROOM | |
| | | | | BARRIER | Sheet OTR Results | | RH | |
| | | sheet | BARRIER | THICKNESS | 23° C./0% RH OR ROOM RH | | Avg. | Avg |
| Formu- | Thermoformed | thickness | Material | in | cc/m2 · day | cc/100 in2 · | cc/pkg · day | cc/pkg · day |
| lations | Packages | in mils | LAYER | inches | Avg | DAY | Test 1 | Test 2 |
| 1 | APPLESAUCE | 45 MIL SHEET | EVOH | 0.0016 | 0.6911 | 0.044587097 | 0.383 | 0.329 |
| 2 | APPLESAUCE | 45 MIL SHEET | APEX I | 0.0016 | 3.80125 | 0.245241935 | 0.761 | 0.425 |
| 3 | COFFEE | 20 MIL SHEET | EVOH | 0.0005 | 0.33165 | 0.021396774 | 0.294 | 0.334 |
| | CREAMER | | | | | | | |
| | CUP | | | | | | | |
| 3 | CONDIMENT | 20 MIL SHEET | EVOH | 0.0005 | | | 0.292 | 0.334 |
| | CUP | | | | | | | |
| 4 | COFFEE | 20 MIL SHEET | APEX I | 0.0005 | 0.2356 | 0.0152 | 0.273 | 0.337 |
| | CREAMER | | | | | | | |
| | CUP | | | | | | | |
| 4 | CONDIMENT | 20 MIL SHEET | APEX I | 0.0005 | | | 0.279 | 0.332 |
| | CUP | | | | | | | |
| 5 | COFFEE | 20 MIL SHEET | EVOH | 0.0010 | 45.1915 | 2.915580645 | 0.389 | 0.435 |
| | CREAMER | | | | | | | |
| | CUP | | | | | | | |
| 5 | CONDIMENT | 20 MIL SHEET | EVOH | 0.0010 | | | 0.509 | 0.472 |
| | CUP | | | | | | | |
| 6 | COFFEE | 20 MIL SHEET | APEX I | 0.0010 | 61.62295 | 3.975674194 | 0.430 | 0.444 |
| | CREAMER | | | | | | | |
| | CUP | | | | | | | |
| 6 | CONDIMENT | 20 MIL SHEET | APEX I | 0.0010 | | | 0.473 | 0.488 |
| | CUP | | | | | | | |
| 7 | CASE READY | 28 MIL SHEET | EVOH | 0.0005 | 0.3665 | 0.023645161 | 0.105 | na |
| | TRAY | | | | | | | |
| 8 | CASE READY | 28 MIL SHEET | APEX I | 0.0005 | 31.82465 | 2.053203226 | 0.223 | na |
| | TRAY | | | | | | | |
| 9 | CASE READY | 28 MIL SHEET | EVOH | 0.0010 | 0.2553 | 0.016470968 | 0.194 | na |
| | TRAY | | | | | | | |
| 10 | CASE READY | 28 MIL SHEET | APEX I | 0.0010 | 22.3405 | 1.441322581 | 1.064 | na |
| | TRAY | | | | | | | |

In the trial sets above, each of the polymeric material that is polypropylene, or modified PP, or other, can be supplemented in coextrusion with Additive S as defined previously, in the range of from about 2% to about 40%.

1. A co-extruded, multi-layer, polymeric film, comprising:
(i) at least one 2-layer stack L1+L2, wherein the first layer of the 2-layer stack is L1 and the second layer of the 2-layer stack is L2, wherein layers L1 and L2 individually comprise, by weight, resin RA1 from 0-100%, resin RB1 from 0-100%, and additive S from 1-15%, wherein the weight content of resin RB1 in layers L1 and L2 is not simultaneously 0%, wherein the two layers L1 and L2 in said 2-layer stack are planarly in contact with each other;
OR
(ii) at least one 3-layer stack L3+L4+L5, wherein the first layer of the 2-layer stack is L3 the second layer of the 2-layer stack is L4, and the third layer of the 3-layer stack is L5, wherein layers L3, L4, and L5 individually comprise, by weight, resin RA1 from 0-100%, resin RB1 from 0-100%, resin RR1 from 0-100% and additive S from 1-15%, wherein the weight content of resin RB1 and RR1 in layers L3, L4, and L5 is not simultaneously 0%, wherein the three layers L1, L2, and L3 in said 3-layer stack are planarly in contact with each other;
OR
(iiia) at least one 2-layer stack L1+L2, wherein the first layer of the 2-layer stack is L1 and the second layer of the 2-layer stack is L2, wherein layers L1 and L2 individually comprise, by weight, resin RA1 from 0-100%, resin RB1 from 0-100%, and additive S from 1-15%, wherein the weight content of resin RB1 in layers L1 and L2 is not simultaneously 0%, wherein the two layers L1 and L2 in said 2-layer stack are planarly in contact with each other,
and
(iiib) at least one 3-layer stack L3+L4+L5, wherein the first layer of the 2-layer stack is L3 the second layer of the 2-layer stack is L4, and the third layer of the 3-layer stack is L5, wherein layers L3, L4, and L5 individually comprise, by weight, resin RA1 from 0-100%, resin RB1 from 0-100%, resin RR1 from 0-100% and additive S from 1-15%, wherein the weight content of resin RB1 and RR1 in layers L3, L4, and L5 is not simultaneously 0%, wherein the three layers L1, L2, and L3 in said 3-layer stack are planarly in contact with each other;
wherein:
Resin RA1 comprises predominately polypropylene,
Resin RB1 comprises predominately polypropylene and 50 wt. % or less of a hydrocarbon resin; and
Resin RR1 comprises predominately the APEX material.

2. The co-extruded, multi-layer, polymeric film as recited in claim 1, further comprising at least one layer comprising:
(C) predominately polyolefin;
(D predominately polypropylene;
(E) predominately MODIFIED polypropylene comprising at least one nucleating agent;
(F) predominately polypropylene and 50 wt. % or less of a hydrocarbon resin;
(G) predominately polyethylene polymer or interpolymer;
(H) EVOH;
(I) predominately nylon;
(J) predominately polyester;
(K) resin RB1;
(M) resin RR1;
(N) additive S; or
(O) a combination of the above.

3. The co-extruded, multi-layer, polymeric film as recited in claim 1, wherein said layers L1, L2, L3, L4, and L5 form an interface or interphase at their adjacent or planar contact boundaries such that the interphase provides discontinuity in properties between the two layers to provide improvement in barrier properties of the co-extruded, multi-layer, polymeric film.

4. The co-extruded, multi-layer, polymeric film of claim 1, wherein the thickness of said co-extruded, multi-layer, polymeric film is a number below, or within a range defined by any two numbers below, including the endpoints of such a range, in the μm units:
5, 10, 20, 30, 50, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1100, 1125, 1150, 1175, 1200, 1225, 1250, 1275, 1300, 1325, 1350, 1375, 1400, 1425, 1450, 1475, 1500, 1525, 1600, 1700, 1800, 1900, 2000, 2500, 3000, 3500, 4000, 4500, 5000, 6000, 7000, 8000, 9000, 10000, 11000, 12000 and 13000.

5. The co-extruded, multi-layer, polymeric film of claim 1, comprising a number of layers selected from the range of 2 layers through 100 layers.

6. The co-extruded, multi-layer, polymeric film of claim 2, wherein the weight percent of said EVOH copolymer to that of said co-extruded, multi-layer, polymeric film is in the range of from about 0.1% to about 10%.

7. The co-extruded, multi-layer, polymeric film of claim 6, wherein the mole percent of ethylene in said EVOH copolymer is in the range of from about 10% to about 55%.

8. The co-extruded, multi-layer, polymeric film of claim 1, wherein the coextruded multi-layer polymeric film, the barrier layer, or the polymeric material that makes up the coextruded multi-layer polymeric film is characterized by at least one of the following properties as given below:
(iv) the deflection temperature under load (DTUL) is a number below, or within a range formed by any two numbers below, including the endpoints of such a range, in units expressed as ° C.:
30, 35, 40, 45, 50, 55, 60, 65, 70, 75, 80, 85, 90, 95, 100, 105, 110, 115, 120, 125, and 130;
(v) the tensile modulus is a number below, or within a range formed by any two numbers below, including the endpoints of such a range, in units expressed as MPa:
500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 900, 1950, 2000, 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450, 3500, 3550, 3600, 3650, 3700, 3750, 3800, 3850, 3900, 3950, 4000, 4050, 4100, 4150, 4200, 4250, 4300, 4350, 4400, 4450, 4500, 4550, 4600, 4650, 4700, 4750, 4800, 4850, 4900, 4950, and 5000;
(vi) the tensile strength at yield is a number below, or within a range formed by any two numbers below, including the endpoints of such a range, in units expressed as MPa:
20, 30, 40, 50, 60, 70, 80, 90, 100, 110, 120, 130, 140, 150, 160, 170, 180, 190, and 200;
(iv) the percent elongation at yield is a number below, or within a range formed by any two numbers below, including the endpoints of such a range, in the % units:
0.01, 0.03, 0.05, 0.07, 0.09, 0.1, 0.3, 0.5, 0.7, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, and 10.0;
(v) The flexural tangent modulus is a number below, or within a range formed by any two numbers below, including the endpoints of such a range, in units expressed as MPa:
500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 900, 1950, 2000, 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450, 3500, 3550, 3600, 3650, 3700, 3750, 3800, 3850, 3900, 3950, 4000, 4050, 4100, 4150, 4200, 4250, 4300, 4350, 4400, 4450, 4500, 4550, 4600, 4650, 4700, 4750, 4800, 4850, 4900, 4950, and 5000;
(vii) the Notched Izod impact strength at 23° C. is a number below, or within a range formed by any two numbers below, including the endpoints of such a range, in units expressed as J/m:
0.1, 0.2, 0.5, 0.7, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50;
(viii) the Gardner impact strength at 23° C. is a number below, or within a range formed by any two numbers below, including the endpoints of such a range, in units expressed as J/m:
0.01, 0.03, 0.05, 0.07, 0.09, 0.1, 0.3, 0.5, 0.7, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, and 10.0;
(ix) the melt flow rate is a number below, or within a range formed by any two numbers below, including the endpoints of such a range, in units expressed as g/10 min:
1, 1.2, 1.5, 2, 2.2, 2.5, 3, 3.2, 3.5, 4, 4.2, 4.5, 5, 5.5, 6, 6.5, 7, 7.5, 8, 8.5, 9, 9.5, 10, 15, 20, 25, 30, 35, 40, 45, 50, 55, 60, 65, 70, 75, 80, 85, 90, 95, and 100;
(x) the percent haze is a number below, or within a range formed by any two numbers below, including the endpoints of such a range:
0, 1, 2, 3, 4, 5, 6, 7, 8, 9, 10, 11, 12, 13, 14, 15, 16, 17, 18, 19, 20, 21, 22, 23 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, and 60;
(xi) the percent clarity is a number below, or within a range formed by any two numbers below, including the endpoints of such a range:
90, 91, 92, 93, 94, 95, 96, 97, 98, 99, and 100;
(xii) the water vapor transmission rate is a number below, or within a range formed by any two numbers below, including the endpoints of such a range in the units cm3/m2/day:
0, 0.0005, 0.001, 0.005, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, and 5; and
(xiii) the oxygen transmission rate is a number below, or within a range formed by any two numbers below, including the endpoints of such a range in the units of cm3/100 in2/day:
0, 0.1, 0.2, 0.3, 0.4, 0.5, 1, 1.5, 2, 2.5, 3, 3.5, 4, 4.5, 5, 10, 15, 20, 25, 30, 35, 40, 45, 50, 55, and 60.

9. The co-extruded, multi-layer, polymeric film as recited in claim 1, comprising:
(I) an outside layer comprising polyethylene;
(II) a core layer comprising EVOH; and
(III) an inside layer comprising polyethylene;
wherein at least one of the three layers above, comprises the 2-layer stack or the 3-layer stack.

10. The co-extruded, multi-layer, polymeric film as recited in claim 1, comprising three layers in the following order:
(I) a first layer comprising predominately polypropylene;
(II) a second layer comprising predominately MODIFIED PP polymer or Resin RB1 optionally comprising at least one nucleating agent; and
(III) a third layer comprising predominately polypropylene.

11. The co-extruded, multi-layer, polymeric film as recited in claim 1, wherein the co-extruded, multi-layer, polymeric film exhibits a DTUL of 30° C. or more and a flexural secant modulus of 500 MPa or more.

12. The co-extruded, multi-layer, polymeric film as recited in claim 2, wherein the thickness of the film ranges from about 5 μm to about 1600 μm.

13. The co-extruded, multi-layer, polymeric film as recited in claim 1, wherein the hydrocarbon resin comprises an aliphatic hydrocarbon resin, an aliphatic/aromatic hydrocarbon resin, an aromatic hydrocarbon resin, a polyterpene resin, a terpene-phenol resin, a rosin ester, a rosin acid, or a mixture thereof.

14. The co-extruded, multi-layer, polymeric film as recited in claim 13, wherein the hydrocarbon resin is partially hydrogenated or fully hydrogenated.

15. The co-extruded, multi-layer, polymeric film as recited in claim 14, wherein the hydrocarbon resin comprises a polycyclopentadiene.

16. The co-extruded, multi-layer, polymeric film as recited in claim 15, wherein the hydrocarbon resin has a weight average molecular weight of from about 400 g/mol to about 5,000 g/mol.

17. The co-extruded, multi-layer, polymeric film as recited in claim 16, wherein the hydrocarbon resin comprises an aromatic C₉ hydrogenated resin having a ring and ball softening point of 110° C. or more.

18. The co-extruded, multi-layer, polymeric film as recited in claim 1:
wherein at least one of the layers further comprises a nucleating agent selected from sodium benzoate, tale, glycerol alkoxide salts, cyclic carboxylic acid salts, bicyclic carboxylic acid salts, glycerolates, phosphines, phosphates, diols, hexahydrophtalic acid salts, amides, and sugar alcohols, or wherein the nucleating agent selected from sodium benzoate, tale, glycerol alkoxide salts, cyclic carboxylic acid salts, bicyclic carboxylic acid salts, glycerolates, phosphines, phosphates, diols, hexahydrophtalic acid salts, amides, sugar alcohols, mannitol or mannitol based compounds; sorbitol or sorbitol based compounds; nonitol or nonitol based compounds, 1,2,3-trideoxy-4,6:5,7-bis-0-((4-propylphenyl) methylene) nonitol;
2,4,8,10-tetra(tert-butyl)-6-hydroxy-12H-dibenzo[d,g][1,3,2]diox-aphosphocin 6-oxide; a salt of 2,4,8,10-tetra(tert-butyl)-6-hydroxy-12H-dibenzo[d,g][1,3,2]diox-aphosphocin 6-oxide; sodium salt of 2,4,8,10-tetra(tert-butyl)-6-hydroxy-12H-dibenzo[d,g][1,3,2]diox-aphosphocin 6-oxide;
hydroxy-bis[2,2′-methylenebis[4,6-di(tert-butyl)phenyl]phosphate; 2,2′-methylenebis(4,6-di-tertbutylphenyl)phosphate; a salt thereof; a sodium salt thereof; an aluminum salt thereof; a lithium salt thereof;
(1R)-1-[(4R,4aR,8aS)-2,6-bis(3,4-dimethylphenyl)-4,4a,8,8a-tetrahydro-[1,3]dioxino[5,4-d][1,3]dioxin-4-yl]ethane-1,2-diol; 1-[8-propyl-2,6-bis(4-propylphenyl)-4,4a,8,8a-tetrahydro[1,3]dioxino[5,4-d][1,3]dioxin-4-yl]ethane-1,2-diol;
N-[3,5-bis(2,2-dimethylpropanoylamino)phenyl]-2,2-dimethylpropanamide); a salt of (1S,2R)-cyclohexane-1,2-dicarboxylate with zinc octadecenoate; a calcium salt of (1S,2R)-cyclohexane-1,2-dicarboxylate with zinc octadecenoate; cis-endo-bicyclo[2,2,1]heptane-2,3-dicarboxylic acid disodium salt with 13-docosenamide; amorphous silicon dioxide;
bicycloheptane dicarboxylic acid; bicyclo[2.2.1]heptane dicarboxylate;
cyclohexanedicarboxylic acid; a calcium salt of cyclohexanedicarboxylic acid; a blend of cyclohexanedicarboxylic acid, the calcium salt of cyclohexanedicarboxylic acid, and zinc stearate; and a mixture of two or more nucleating agents thereof.

19. A co-extruded, multi-layer, polymeric film, comprising:
(I) an outside-layer stack, comprising a set of layers Z1, a set of layers Z2, or a set of layers Z1 and Z2;
(II) a core-layer stack, comprising the set of layers Z1, the set of layers Z2, or the set of layers Z1 and Z2; and
(III) an inside-layer stack, comprising the set of layers Z1, the set of layers Z2, or the combination of the set of layers Z1 and the set of layers Z2;
wherein at least one of the outside-layer stack, the core-layer stack, and the inside-layer stack comprises the set of layers Z2;
wherein the set of layers Z1 comprises at least one layer of said outside layer stack comprises polyethylene polymer or polyethylene interpolymer; and
wherein the set of layers Z2 comprises:
(i) at least one 2-layer stack L1+L2, wherein the first layer of the 2-layer stack is L1 and the second layer of the 2-layer stack is L2, wherein layers L1 and L2 individually comprise, by weight, resin RA1 from 0-100%, resin RB1 from 0-100%, and additive S from 1-15%, wherein the weight content of resin RB1 in layers L1 and L2 is not simultaneously 0%, wherein the two layers L1 and L2 in said 2-layer stack are planarly in contact with each other;
OR
(ii) at least one 3-layer stack L3+L4+L5, wherein the first layer of the 2-layer stack is L3 the second layer of the 2-layer stack is L4, and the third layer of the 3-layer stack is L5, wherein layers L3, L4, and L5 individually comprise, by weight, resin RA1 from 0-100%, resin RB1 from 0-100%, resin RR1 from 0-100% and additive S from 1-15%, wherein the weight content of resin RB1 and RR1 in layers L3, L4, and L5 is not simultaneously 0%, wherein the three layers L1, L2, and L3 in said 3-layer stack are planarly in contact with each other;
OR
(iiia) at least one 2-layer stack L1+L2, wherein the first layer of the 2-layer stack is L1 and the second layer of the 2-layer stack is L2, wherein layers L1 and L2 individually comprise, by weight, resin RA1 from 0-100%, resin RB1 from 0-100%, and additive S from 1-15%, wherein the weight content of resin RB1 in layers L1 and L2 is not simultaneously 0%, wherein the two layers L1 and L2 in said 2-layer stack are planarly in contact with each other,
and
(iiib) at least one 3-layer stack L3+L4+L5, wherein the first layer of the 2-layer stack is L3 the second layer of the 2-layer stack is L4, and the third layer of the 3-layer stack is L5, wherein layers L3, L4, and L5 individually comprise, by weight, resin RA1 from 0-100%, resin RB1 from 0-100%, resin RR1 from 0-100% and additive S from 1-15%, wherein the weight content of resin RB1 and RR1 in layers L3, L4, and L5 is not simultaneously 0%, wherein the three layers L1, L2, and L3 in said 3-layer stack are planarly in contact with each other;
wherein:
Resin RA1 comprises predominately polypropylene,
Resin RB1 comprises predominately polypropylene and 50 wt. % or less of a hydrocarbon resin; and
Resin RR1 comprises predominately the APEX material.

20. The co-extruded, multi-layer, polymeric film as recited in claim 19, wherein said co-extruded, multi-layer, polymeric film, further comprises at least one layer comprising:
(C) predominately polyolefin;
(D predominately polypropylene;
(E) predominately MODIFIED polypropylene comprising at least one nucleating agent;
(F) predominately polypropylene and 50 wt. % or less of a hydrocarbon resin;
(G) predominately polyethylene polymer or interpolymer;
(H) EVOH;
(I) predominately nylon;
(J) predominately polyester;
(K) resin RB1;
(M) resin RR1;
(N) additive S; or
(O) a combination of the above;
wherein said polyethylene interpolymer comprises:
(a) optionally a first ethylene/α-olefin copolymer fraction having a density in the range of 0.894 to 0.908 g/cm³; a melt index in the range of 0.2 to 1 dg/min; and
(b) optionally a second ethylene/α-olefin copolymer fraction having a density in the range of from about 0.910 to 0.924 g/cm³, a melt index in the range from 0.5 to 2 g/10 min, a zero shear viscosity ratio (ZSVR) in the range of from about 1.15 to 2.5; a molecular weight distribution, expressed as the ratio of the weight average molecular weight to number average molecular weight (Mw/Mn), in the range of 2.0 to 4.0.

21. A flexible sheet or a rigid sheet comprising the co-extruded, multi-layer, polymeric film as recited in claim 1.

22. A shaped polymeric article comprising the co-extruded, multi-layer, polymeric film of claim 1.

23. A shaped polymeric article comprising the flexible sheet or the rigid sheet as recited in claim 21.

24. The shaped polymeric article of claim 22, wherein the shaped polymeric article is a thermoformed shaped polymeric article.

25. The shaped polymeric article as recited in claim 23, wherein said shaped polymeric article is a packaging product for the food, medical, general retail industries, a package, a cup, a tub, a pail, a jar, a box, a container, a lid, a tray for food article, a tray not for food article, a blister, a clamshell, a bottle, a pouch.

26. The shaped polymeric article of claim 22, which is a container.

27. The shaped polymeric article of claim 26 for packaging food product.

28. The container as recited in claim 26, wherein said co-extruded, multi-layer, polymeric film comprises:
(I) an outside layer comprising polyethylene;
(II) a core layer comprising EVOH; and
(III) an inside layer comprising polyethylene;
wherein at least one of the three layers above, comprises said 2-layer stack L1+L2 or said 3-layer stack L3+L4+L5.

29. A process for preparing a co-extruded, multi-layer, polymeric film as recited in claim 1, comprising the steps of:
(I) providing the layers L1 and L2 or L3, L4, and L5,
wherein said L1, L2, L3, L4, and L5 form an interface or interphase at their adjacent boundaries such that the interphase provides discontinuity in properties between the two layers to provide improvement in barrier properties of the co-extruded, multi-layer, polymeric film.

30. A container for packaging food product prepared from a rigid or a flexible co-extruded, multi-layer, polymeric film prepared by the process of claim 29.

31. A laminated structure comprising the co-extruded, multi-layer, polymeric film as recited in claim 1.

32. The laminated structure as recited in claim 4, wherein the laminate structure thickness is in the range of 5 μm to 1600 μm.

33. The coextruded films of claim 1, wherein the thickness of the layer comprising the APEX material has a thickness in the range of 5 microns to 75 microns.

34. The coextruded films as recited in claim 33, wherein the thickness is in the range of 5 microns to 15 microns.

35. The coextruded films of claim 33, wherein the layer comprising the APEX material comprises from 30 to 70% one or more structural polymers, from 30-70% one or more barrier polymers, and optionally from 3-10% of a compatibilizer.

36. The coextruded films of claim 35, wherein the structural polymer predominately comprises polypropylene and the barrier polymer comprises EVOH and the compatibilizer is a functionalized polyolefin.

37. The process as recited in claim 29, further comprising the step of providing said co-extruded polymeric film for preparing flexible sheets, rigid sheets, or shaped polymeric articles that are generally prepared using polystyrene.

38. The co-extruded, multi-layer, polymeric film as recited in claim 1, wherein said polymeric film is at least partially recyclable.

39. The container as recited in claim 30, wherein the container is provided for preparing refrigerated and shelf-stable yogurt unpacks and multi-packs; medium barrier snack packs; packaging for retort and aseptic baby food; packaging for shelf stable and form-fill-seal beverages; packaging for component meal trays; packaging for condiments and portion-control condiments; packaging for jams, jellies, and sauces and portion-control jams, jellies, and sauces; packaging for shelf-stable dairy product, creamers, butter and margarine; snack packs; applesauce cups; case-ready trays; coffee and tea pods; packaging for deli meats and cheeses; fruit and produce cups; on-the-go cups; packaging for wet and dry pet food; RTH meal trays; salad dressing cups; and soup tubs.
